(19) United States
(12) Patent Application Publication
(10) Pub. No.: US 2024/0192310 A1
(43) Pub. Date: Jun. 13, 2024

(54) RADAR DEVICE AND INTERFERENCE COUNTERMEASURE DETECTION METHOD FOR RADAR DEVICE

(71) Applicant: Mitsubishi Electric Corporation, Tokyo (JP)

(72) Inventors: Yusuke KITSUKAWA, Tokyo (JP); Takahiro HORIGUCHI, Tokyo (JP); Noriyuki FUKUI, Tokyo (JP); Masashi MITSUMOTO, Tokyo (JP)

(73) Assignee: Mitsubishi Electric Corporation, Tokyo (JP)

(21) Appl. No.: 18/583,359

(22) Filed: Feb. 21, 2024

Related U.S. Application Data
(63) Continuation of application No. PCT/JP2022/036360, filed on Sep. 29, 2022.

(30) Foreign Application Priority Data
Oct. 15, 2021 (WO) PCT/JP2021/038158

(51) Int. Cl. G01S 7/02; G01S 7/35; G01S 13/58

(52) U.S. Cl. CPC G01S 7/0232; G01S 7/354; G01S 13/584

(57) ABSTRACT

A radar device includes a beat signal generating unit to receive a reception signal that repeats a corresponding chirp signal of a reflected transmission signal off an observation target, and generate a beat signal between a chirp signals of the transmission signal and the reception signal, an AD converting unit to convert the beat signal into digital data, a distance spectrum calculating unit to calculate a plurality of distance information spectra corresponding to each of beat data, an interference countermeasure determining unit to determine necessity of an interference countermeasure using the obtained state value, and output an interference countermeasure signal when the interference countermeasure is necessary, and a distance and speed information outputting unit to output a distance to the observation target and a relative speed with respect to the observation target from the plurality of distance information spectra the interference countermeasure is unnecessary.

### CROSS REFERENCE TO RELATED APPLICATIONS

This application is a Continuation of PCT International Application No. PCT/JP2022/036360 filed on Sep. 29, 2022, which claims priority under 35 U.S.C. 119(a) to PCT International Application No. PCT/JP2021/038158, filed in Japan on Oct. 15, 2021, all of which are hereby expressly incorporated by reference into the present application.

### TECHNICAL FIELD

The present disclosure relates to what is called FMCW radar device using fast chirp (hereinafter referred to as fast chirp FMCW) using a transmission signal that intermittently repeats a chirp signal whose frequency changes with the lapse of time a plurality of times.

### BACKGROUND ART

A frequency modulated continuous wave (FMCW) radar device is known as a radar device that detects a distance to an observation target and a relative speed with respect to the observation target.

Patent Literature 1 discloses a radar device that detects interference when a transmission wave from another radar device is received as a reception wave in this type of FMCW radar device.

The radar device disclosed in Patent Literature 1 includes an interference detecting unit that calculates an average value of reception power from reception signals corresponding to reception waves received by a reception antenna and determines that interference has occurred when a difference from an average value of reception power calculated last time is equal to or more than a threshold, or an interference detecting unit that determines that interference has occurred when an average value of reception power corresponding to a far distance is equal to or more than a threshold.

### CITATION LIST

### Patent Literatures

Patent Literature 1: JP 2007-225602 A

### SUMMARY OF INVENTION

### Technical Problem

In the radar device disclosed in Patent Literature 1, whether or not interference has occurred is determined on the basis of whether a difference between a calculated average value of reception power and a previously calculated average value of reception power is equal to or more than a threshold or an average value of reception power corresponding to a far distance is equal to or more than a threshold for a radar device of an FMCW method using a slow chirp, and this is an interference detection method that is difficult to be applied to a radar device of a fast chirp FMCW method.

The present disclosure has been made in view of the above points, and an object thereof is to obtain a fast chirp FMCW radar device capable of accurately determining necessity of an interference countermeasure.

### Solution to Problem

A radar device according to the present disclosure includes a beat signal generator to receive a reception signal that repeats a chirp signal corresponding to a chirp signal of a transmission signal due to a reception wave generated by reflecting, on an observation target, a transmission wave due to the transmission signal that repeats a chirp signal whose frequency changes with a lapse of time, and generate a beat signal having a frequency of a difference between respective frequencies of a chirp signal of the transmission signal and a chirp signal of the reception signal in a correspondence relationship; an AD converter to output beat data obtained by converting the beat signal generated by the beat signal generator into digital data; a distance spectrum calculator to calculate a plurality of distance information spectra corresponding to each of a plurality of pieces of beat data from the AD converter received during a signal acquisition period; an interference countermeasure determiner to obtain a state value of each of the plurality of distance information spectra from data in an interference determination processing range in the plurality of distance information spectra calculated by the distance spectrum calculator, determine necessity of an interference countermeasure from a number of inappropriate distance information spectra in the plurality of distance information spectra by comparing the obtained state value of each of the distance information spectra with an interference determination threshold to obtain appropriateness of each of the plurality of distance information spectra and output an interference countermeasure signal for a chirp signal in a transmission signal when the interference countermeasure is necessary; and a distance and speed information outputter to calculate and output a distance to the observation target and a relative speed with respect to the observation target from data in a detection target frequency range in the plurality of distance information spectra calculated by the distance spectrum calculator when the interference countermeasure determiner determines that the interference countermeasure is unnecessary.

### Advantageous Effects of Invention

According to the present disclosure, the presence or absence of interference is determined for each of repeated chirp signals, and necessity of an interference countermeasure is determined on the basis of the number of chirp signals determined to have interference, so that it is possible to determine the necessity of countermeasures against interference with high accuracy.

### BRIEF DESCRIPTION OF DRAWINGS

FIG. 1 is a configuration diagram illustrating a radar device according to a first embodiment.

FIG. 2 is a configuration diagram illustrating a signal processing unit of the radar device according to the first embodiment.

FIG. 3 is an explanatory diagram illustrating acquisition timings of a transmission signal, a reception signal, a beat signal, an interference signal, and digital data in the signal processing unit in a signal acquisition period in the radar device according to the first embodiment.

FIG. 4 is a diagram illustrating an interference determination processing range in an interference countermeasure determining unit of the signal processing unit of the radar device according to the first embodiment.

FIG. 5 is a diagram illustrating an example of a distance information spectrum in a case where there is no interference signal in the interference countermeasure determining unit of the signal processing unit of the radar device according to the first embodiment.

FIG. 6 is a diagram illustrating an example of a distance information spectrum in a case where there is an interference signal in the interference countermeasure determining unit of the signal processing unit of the radar device according to the first embodiment.

FIG. 7 is a flowchart illustrating an operation of the signal processing unit of the radar device according to the first embodiment.

FIG. 8 is a configuration diagram illustrating a signal processing unit of a radar device according to the second embodiment.

FIG. 9 is a diagram illustrating an interference determination processing range in an interference countermeasure determining unit of the signal processing unit of the radar device according to the second embodiment.

FIG. 10 is a diagram illustrating an example of a distance information spectrum in a case where there is no interference signal in the interference countermeasure determining unit of the signal processing unit of the radar device according to the second embodiment.

FIG. 11 is a diagram illustrating an example of a distance information spectrum in a case where there is an interference signal in the interference countermeasure determining unit of the signal processing unit of the radar device according to the second embodiment.

FIG. 12 is a flowchart illustrating an operation of the signal processing unit of the radar device according to the second embodiment.

FIG. 13 is a configuration diagram illustrating a signal processing unit of a radar device according to a third embodiment.

FIG. 14 is an explanatory diagram illustrating acquisition timings of a transmission signal, a reception signal, a beat signal, an interference signal, and digital data in the signal processing unit in a signal acquisition period in the radar device according to the third embodiment.

FIG. 15 is a diagram illustrating an interference determination processing range in an interference countermeasure determining unit of the signal processing unit of the radar device according to the third embodiment.

FIG. 16 is a diagram illustrating an example of a distance information spectrum in a case where there is no interference signal in the interference countermeasure determining unit of the signal processing unit of the radar device according to the third embodiment.

FIG. 17 is a diagram illustrating an example of a distance information spectrum in a case where there is an interference signal in the interference countermeasure determining unit of the signal processing unit of the radar device according to the third embodiment.

FIG. 18 is a flowchart illustrating an operation of the signal processing unit of the radar device according to the third embodiment.

FIG. 19 is a configuration diagram illustrating the signal processing unit of the radar device according to a fourth embodiment.

FIG. 20 is a flowchart illustrating an operation of the signal processing unit of the radar device according to the fourth embodiment.

FIG. 21 is a configuration diagram illustrating a signal processing unit of a radar device according to a fifth embodiment.

FIG. 22 is a flowchart illustrating an operation of the signal processing unit of the radar device according to the fifth embodiment.

FIG. 23 is a configuration diagram illustrating a signal processing unit of a radar device according to a sixth embodiment.

FIG. 24 is a flowchart illustrating an operation of the signal processing unit of the radar device according to the sixth embodiment.

FIG. 25 is a configuration diagram illustrating a signal processing unit of a radar device according to a seventh embodiment.

FIG. 26 is an explanatory diagram illustrating acquisition timings of a transmission signal, a reception signal, a beat signal, an interference signal, and digital data in the signal processing unit in a signal acquisition period in the radar device according to the seventh embodiment.

FIG. 27 is a diagram illustrating an interference determination processing range in the interference countermeasure determining unit of the signal processing unit of the radar device according to the seventh embodiment.

FIG. 28 is a flowchart illustrating an operation of the signal processing unit of the radar device according to the seventh embodiment.

FIG. 29 is a configuration diagram illustrating a signal processing unit of a radar device according to an eighth embodiment.

FIG. 30 is a flowchart illustrating an operation of the signal processing unit of the radar device according to the eighth embodiment.

FIG. 31 is a configuration diagram illustrating a signal processing unit of a radar device according to a ninth embodiment.

FIG. 32 is a flowchart illustrating an operation of the signal processing unit of the radar device according to the ninth embodiment.

FIG. 33 is a configuration diagram illustrating a signal processing unit of a radar device according to a tenth embodiment.

FIG. 34 is a flowchart illustrating operation of the signal processing unit of the radar device according to the tenth embodiment.

FIG. 35 is a flowchart illustrating an operation of another example of the signal processing unit of the radar device according to the tenth embodiment.

### DESCRIPTION OF EMBODIMENTS

### First Embodiment

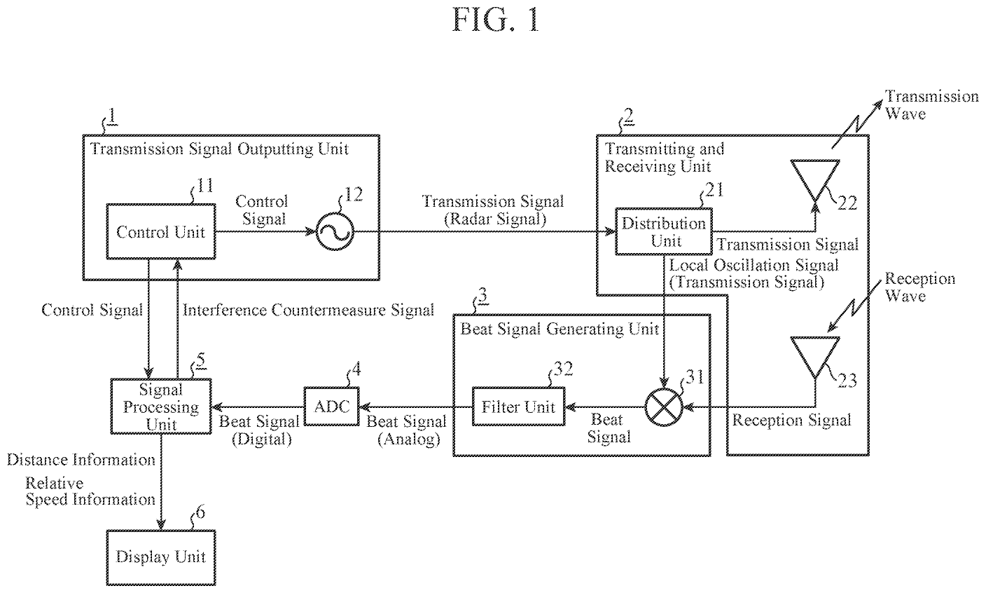

A fast chirp FMCW radar device according to a first embodiment will be described with reference to FIGS. 1 to 7.

When the radar device according to the first embodiment is mounted on a vehicle such as an automobile, the observation target corresponds to another automobile, a passerby, a guardrail, or the like.

As illustrated in FIG. 1, the radar device according to the first embodiment includes a transmission signal outputting unit 1, a transmitting and receiving unit 2, a beat signal generating unit 3, an AD converting unit (analog-to-digital converter (ADC)) 4, a signal processing unit 5, and a display unit 6.

The transmission signal outputting unit 1 outputs a transmission signal that repeats a chirp signal that is a frequency modulation signal whose frequency changes with the lapse of time.

In the first embodiment, a chirp signal intermittently and repeatedly output a plurality of times from the transmission signal outputting unit 1 during a signal acquisition period in which an interference countermeasure is determined is used for the determination of an interference countermeasure.

That is, among the transmission signals output from the transmission signal outputting unit 1, a plurality of chirp signals output during the signal acquisition period is used to determine the interference countermeasure.

In the first embodiment, the plurality of chirp signals used to determine the interference countermeasure is K chirp signals, and K is a natural number equal to or more than 2.

When an interference countermeasure signal from the signal processing unit 5 is input, the transmission signal outputting unit 1 performs a preset interference countermeasure.

The interference countermeasure is, for example, a countermeasure for changing any one or more of center frequencies, a transmission start timing, a frequency bandwidth, and a sweep time of the chirp signal in the transmission signal to be output.

The transmission signal outputting unit 1 includes a control unit 11 and a signal source 12.

The control unit 11 outputs a control signal indicating the center frequency, the transmission start timing, the frequency bandwidth, and the sweep time of the chirp signal to the signal source 12 and the signal processing unit 5.

When the interference countermeasure signal is input from the signal processing unit 5, the control unit 11 outputs the control signal changed on the basis of the interference countermeasure signal to the signal source 12 and the signal processing unit 5.

The control signal changed on the basis of the interference countermeasure signal is a control signal that changes any one or more of the center frequencies, the transmission start timing, the frequency bandwidth, and the sweep time of the chirp signal.

When a control signal is input from the control unit 11, the signal source 12 outputs a transmission signal that intermittently repeats a chirp signal as a radar signal to the transmitting and receiving unit 2 according to the control signal.

The transmission signal output from the signal source 12 is a signal that intermittently repeats a chirp signal that is a frequency modulation signal whose frequency changes with the lapse of time.

The transmitting and receiving unit 2 converts the transmission signal output from the transmission signal outputting unit 1 into a transmission wave, emits the converted transmission wave toward the observation target, receives a transmission wave reflected by the observation target as a reflected wave, converts the received reflected wave into a reception signal, and outputs the reception signal based on the reflected wave.

As is the transmission signal, the reception signal is a signal that intermittently repeats a chirp signal whose frequency changes with the lapse of time. The chirp signal constituting the transmission signal and the chirp signal constituting the reception signal have a correspondence relationship for each chirp signal.

The transmitting and receiving unit 2 outputs the transmission signal output from the transmission signal outputting unit 1 and the reception signal based on the received reflected wave to the beat signal generating unit 3.

The transmitting and receiving unit 2 includes a distribution unit 21, a transmission antenna 22, and a reception antenna 23.

The distribution unit 21 distributes the transmission signal output from the signal source 12 of the transmission signal outputting unit 1 into two transmission signals.

One of the distributed transmission signals is output to the transmission antenna 22, and the other transmission signal is output to the beat signal generating unit 3 as a local oscillation signal.

The transmission antenna 22 converts the input transmission signal into a transmission wave and radiates (emits) the transmission wave into space.

The transmission wave radiated from the transmission antenna 22 into space is reflected by the observation target, and the reception antenna 23 receives the reflected wave reflected by the observation target as a reception wave, converts the received reception wave into a reception signal, and outputs the reception signal to the beat signal generating unit 3.

The beat signal generating unit 3 receives inputs of the transmission signal output from the transmitting and receiving unit 2 and the reception signal output from the reception antenna 23, generates a beat signal having a frequency of a difference between the respective frequencies of the chirp signal of the transmission signal and the chirp signal of the reception signal, which are in the correspondence relationship, for each chirp signal, and outputs the generated beat signal to the AD converting unit 4.

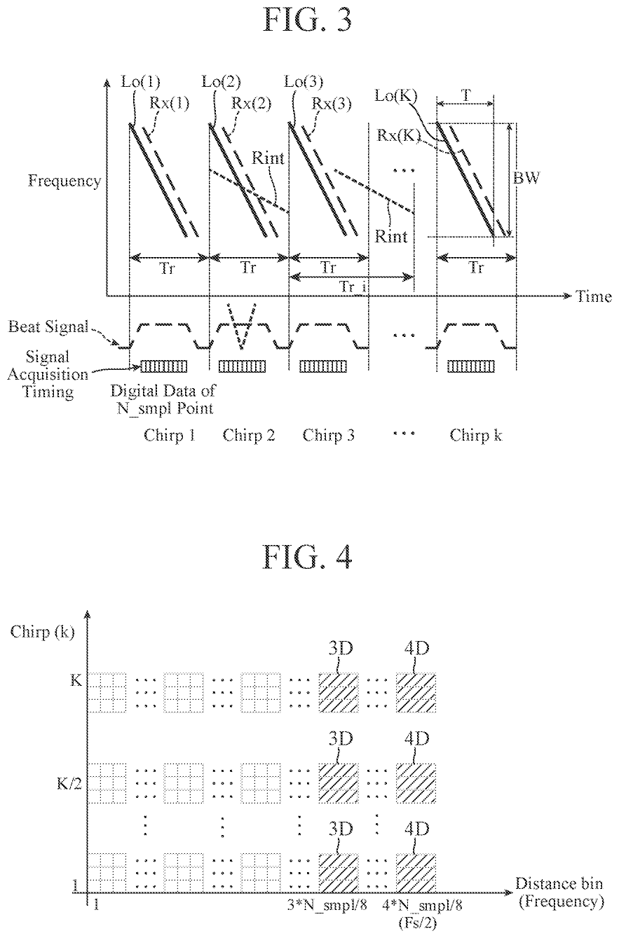

FIG. 3 illustrates a beat signal generated during the signal acquisition period in the beat signal generating unit 3.

During the signal acquisition period, as illustrated in FIG. 3, the beat signal generating unit 3 generates the beat signal in chirp 1 to chirp K each having a difference between each of a chirp signal Lo(1) to a chirp signal Lo(K) in the transmission signal output from the transmitting and receiving unit 2 and each of a chirp signal Rx(1) to a chirp signal Rx(K) in the reception signal output from the transmitting and receiving unit 2.

K is the number of chirp signals (hereinafter referred to as the number of chirps) that are intermittently repeated in the transmission signal and the reception signal during the signal acquisition period, and is a natural number equal to or more than 2.

Therefore, the number of chirps of the beat signal in the signal acquisition period is K, which is the same as the number of chirps of the transmission signal and the reception signal.

Note that, also in a period other than the signal acquisition period, the beat signal generating unit 3 generates a beat signal for each chirp signal by using the chirp signal of the transmission signal and the chirp signal in the reception signal, which are in the correspondence relationship, as in the signal acquisition period.

The beat signal generating unit 3 includes a frequency mixing unit 31 and a filter unit 32.

The frequency mixing unit 31 receives inputs of the transmission signal output from the distribution unit 21 and the reception signal output from the reception antenna 23, mixes the transmission signal and the reception signal, generates a beat signal having a frequency of a difference between the frequency of the chirp signal in the transmission signal and the frequency of the chirp signal in the reception signal for each chirp signal, and outputs the generated beat signal to the filter unit 32.

The filter unit 32 suppresses an unnecessary component such as spurious included in the beat signal for the beat signal output from the frequency mixing unit 31, and outputs the beat signal in which the unnecessary component is suppressed to the AD converting unit 4.

The filter unit 32 is, for example, a low pass filter (LPF) or the like that cuts off the beat signal output from the frequency mixing unit 31 by a cutoff frequency equal to or less than ½ of the sampling frequency fs of the AD converting unit 4 in consideration of aliasing of the AD converting unit 4.

The AD converting unit 4 converts the beat signal into digital data for each of the beat signals output from the beat signal generating unit 3, and outputs the converted digital data (hereinafter referred to as beat data) to the signal processing unit 5.

The signal processing unit 5 calculates each of the distance to the observation target and the relative speed with respect to the observation target using the beat data in the chirp 1 to the chirp K output from the AD converting unit 4 received in the signal acquisition period, detects interference from other radars, and determines the necessity of the interference countermeasure.

When the signal processing unit 5 determines that an interference countermeasure is necessary as a result of determining whether an interference countermeasure is necessary, the signal processing unit 5 outputs an interference countermeasure signal to the control unit.

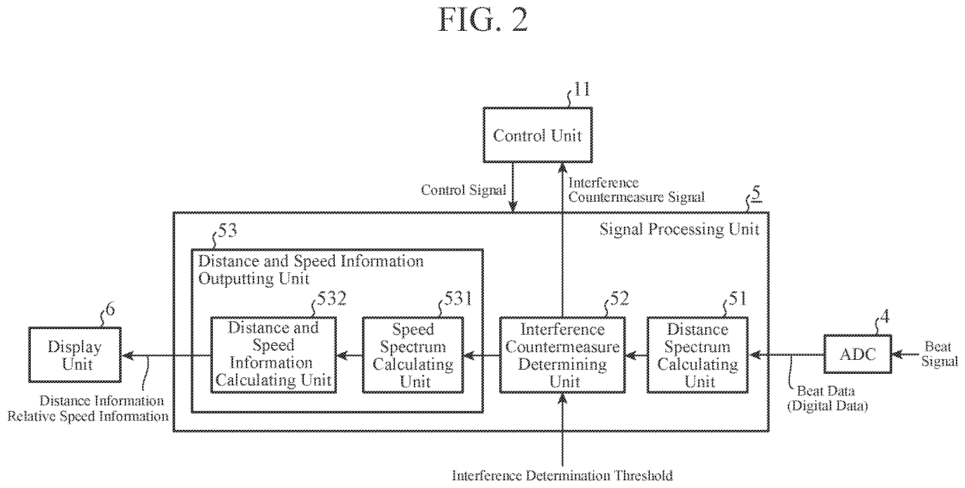

As illustrated in FIG. 2, the signal processing unit 5 includes a distance spectrum calculating unit 51, an interference countermeasure determining unit 52, and a distance and speed information outputting unit 53 including a speed spectrum calculating unit 531 and a distance and speed information calculating unit 532.

The distance spectrum calculating unit 51 refers to the control signal output from the control unit 11 and specifies the signal acquisition period in which the interference countermeasure is determined.

The specified signal acquisition period is a period during which the AD converting unit 4 generates (converts) digital data necessary for determination of an interference countermeasure, in other words, a period during which a chirp signal necessary for determination of the interference countermeasure in the transmission signal is output from the transmission signal outputting unit 1.

As illustrated in FIG. 3, the signal acquisition period substantially corresponds to the total time of repetition times Tr of the chirp signals Lo(1) to Lo(K) in the transmission signal from the transmitting and receiving unit 2.

The distance spectrum calculating unit 51 performs Fourier transform (FFT: fast Fourier transform) on the beat data in a distance direction using the beat data in the signal acquisition period from the AD converting unit 4, thereby calculating a distance information spectrum corresponding to the distance to the observation target.

Note that although the signal acquisition period from the AD converting unit 4 is specified by the distance spectrum calculating unit 51, the AD converting unit 4 may specify the signal acquisition period with reference to the control signal output from the control unit 11 and output beat data from the AD converting unit 4 to the distance spectrum calculating unit 51 during the specified signal acquisition period.

The distance spectrum calculating unit 51 acquires each piece of beat data in the chirp 1 to the chirp K during the signal acquisition period at the signal acquisition timing, performs Fourier transform of the acquired beat data of each chirp at the N_smpl point in the distance direction, and calculates a distance information spectrum that is a frequency spectrum in each of the chirp 1 to the chirp K.

When calculating one distance information spectrum, the distance spectrum calculating unit 51 acquires digital data of N_smpl points for beat data per chirp and performs Fourier transform.

That is, since the distance spectrum calculating unit 51 performs Fourier transform of the N_smpl point in the distance direction for the digital data of the N_smpl point in the beat data per chirp, on the beat data from the chirp 1 to the chirp K, the distance spectrum calculating unit 51 calculates K distance information spectra including the N_smpl points from the chirp 1 to the chirp K.

Therefore, there are multiple distance information spectra during the signal acquisition period, and the number of chirps of the distance information spectra is K, which is the same as the number of chirps of the beat signal.

As illustrated in FIG. 3, the signal acquisition timing is a timing at which each piece of beat data from the chirps 1 to the chirp K output from the AD converting unit 4 is acquired.

The signal acquisition timing is included in a period in which each of the chirp signals Lo(1) to Lo(K) in the transmission signal from the transmitting and receiving unit 2 is output.

The signal acquisition timing is substantially the same as the start time of each of the chirp signals Lo(1) to Lo(K).

Note that, in order to reduce the memory, the signal acquisition period may be divided for each chirp, and the beat data having substantially the same length as the sweep time T from the signal acquisition timing, that is, the beat data of the N_smpl point illustrated at the signal acquisition timing in FIG. 3 may be acquired.

The beat data of the chirp i obtained from the chirp signal Rx(i) in the reception signal output from the transmitting and receiving unit 2 is Fourier-transformed in the distance direction by the distance spectrum calculating unit 51, whereby the spectrum value of the beat data of the chirp i is integrated into the beat frequency Fsb_r expressed by the following equation (1).

Note that i represents any of 1 to K.

Fsb_r=2·BW·R/c·T (1)

Note that R is a distance from the transmission antenna 22 or the reception antenna 23 to the observation target, c is a light speed, T is a s-order sweep time of the chirp signal Lo(i) of the transmission signal output from the transmitting and receiving unit 2 as illustrated in FIG. 3, and BW is the frequency bandwidth of the chirp signal Lo(i) as illustrated in FIG. 3.

i represents any of 1 to K.

The sweep time T and the frequency bandwidth BW are set in such a way that the beat frequency Fsb_r at a maximum detection distance Rmax to the observation target is equal to or less than ½ of the sampling frequency fs in the AD converting unit 4 in consideration of the aliasing in the AD converting unit 4.

Therefore, a detection target frequency range corresponding to the detection distance range is set to a frequency of ½ of 0 to the sampling frequency fs, and data of ½ sample points from 1 to the N_smpl point is used to detect the distance from the transmission antenna 22 or the reception antenna 23 to the observation target.

The detection distance range is a range of a distance for detecting the observation target.

Note that the detection target frequency range is not limited to the frequency range from 0 to ½ of the sampling frequency fs, and may be a frequency range up to a frequency less than ½ of the sampling frequency fs, or may be other frequency ranges.

Similarly, the data used to detect the distance to the observation target may be less than ½ or other sample points among points 1 to N_smpl.

In the first embodiment, the distance spectrum calculating unit 51 outputs, to the interference countermeasure determining unit 52, distance information spectra from chirps 1 to K each including data of ½ sample points of points 1 to N_smpl corresponding to the sampling frequency that is the detection target frequency range.

The interference countermeasure determining unit 52 acquires data in the detection target frequency range of the plurality of distance information spectra output from the distance spectrum calculating unit 51.

Each of the plurality of distance information spectra acquired by the interference countermeasure determining unit 52 is data of ½ sample points of points 1 to N_smpl that are the detection target frequency range, but the interference countermeasure determining unit 52 may acquire data of all sample points for each of the plurality of distance information spectra.

In short, the interference countermeasure determining unit 52 is only necessary to acquire data in the detection target frequency range in the plurality of distance information spectra calculated by the distance spectrum calculating unit 51. In this case, the detection target frequency range is preferably data of the first half of the distance information spectrum corresponding to ½ or less of the sampling frequency fs in the AD converting unit 4.

The interference countermeasure determining unit 52 calculates a state value of each of the plurality of distance information spectra from the data in the interference determination processing range in the plurality of distance information spectra calculated by the distance spectrum calculating unit 51.

The interference countermeasure determining unit 52 compares the calculated state value of each of the distance information spectra with an interference determination threshold to obtain appropriateness of each of the plurality of distance information spectra, and determines necessity of the interference countermeasure from the number of inappropriate distance information spectra in the plurality of distance information spectra.

The interference countermeasure determining unit 52 outputs an interference countermeasure signal for the chirp signal in the transmission signal to the control unit 11 when it is determined that the interference countermeasure is necessary, that is, needed, and outputs a plurality of distance information spectra calculated by the distance spectrum calculating unit 51 to the distance and speed information outputting unit 53 when it is determined that the interference countermeasure is not necessary, that is, unnecessary.

The state value of the distance information spectrum is an average value FN of signal strengths of data in the interference determination processing range in the distance information spectrum.

The data in the interference determination processing range is a part of the data in the detection target frequency range used for signal processing.

For example, in the first embodiment, the interference determination processing range is set to the latter half that is a part of the detection target frequency range, that is, the range from the region 3D to the region 4D indicated by solid hatching in FIG. 4. That is, the data from 0 to ½ N_smpl point (fs/2) (corresponding to the detection target frequency range) in the distance information spectrum is further divided into four, and the latter half of the divided data, that is, the range of 3*N_smpl/8 to 4*N_smpl/8 is set.

In the latter half of the detection target frequency range defined as the interference determination processing range, the influence of floor noise due to the distance to the observation target is small as a result of simulation, which is advantageous for the interference determination processing.

Note that the interference determination processing range is not limited to the latter half of the detection target frequency range, and may be a part of the detection target frequency range.

In FIG. 4, the horizontal axis represents a distance bin, and the vertical axis represents a chirp number, and data of ½ sample points×the number of chirps K of the number N_smpl of the distance information spectra is illustrated. Parentheses in the horizontal axis indicates a frequency in the distance information spectrum, and the detection target frequency range is equal to or less than ½ (4*N_smpl/8) of the sampling frequency fs of the AD converting unit 4.

The interference determination threshold is a first determination threshold TH₁ that is a value obtained by multiplying an average value FN₀ of signal strengths of data in the interference determination processing range in the distance information spectrum obtained in a case where there are no reflected signal and no interference signal from the observation target before shipment or at the start of operation of the radar device by a coefficient α (α is a natural number).

At this time, the average value FN₀ of the signal strengths was 2.0×10⁻⁴.

Data in a case where there are no reflected signal and no interference signal from the observation target corresponds to floor noise of a receiver, and for example, there is a method of obtaining it by disposing a radio wave absorber in front of the transmission antenna 22 and the reception antenna 23 before shipment, or a method of obtaining only environmental noise input to the reception antenna 23 without outputting the transmission signal from the signal source 12.

The calculation of the average value FN₀ of the signal strengths for obtaining the first determination threshold TH₁ may use all or a part of data of the distance information spectrum.

The interference determination threshold may be stored in an internal memory of the signal processing unit 5 or may be provided to the signal processing unit 5 from the outside of the radar device.

In addition, as the average value FN₀ of the signal strengths for obtaining the first determination threshold TH₁, a state value of one set distance information spectrum among the plurality of obtained distance information spectra may be used. For example, the average values FN of the signal strengths corresponding to the number of chirps K obtained in FIG. 4 may be arranged in ascending order, and the i-th value, for example, the fifth value from the smallest value may be set as the average value FN₀ of the signal strengths for obtaining the first determination threshold TH₁.

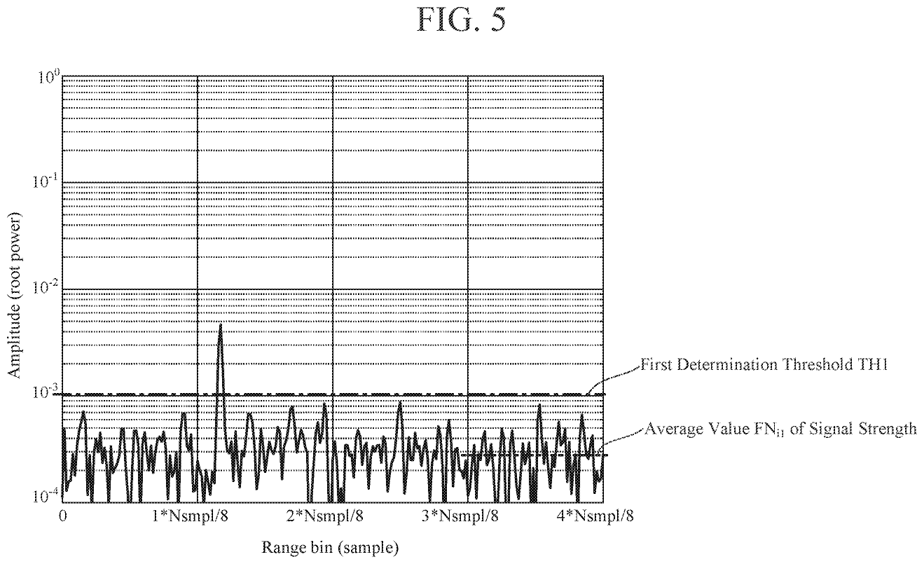

An average value FNᵢ₁ of the signal strengths of the data in the interference determination processing range (range of 3*N_smpl/8 to 4*N_smpl/8) in the distance information spectrum of a chirp i1 obtained when there is no interference signal is indicated by a broken line in FIG. 5 as an example. At this time, the average value FNᵢ₁ of the signal strengths is about 3.0×10⁻⁴.

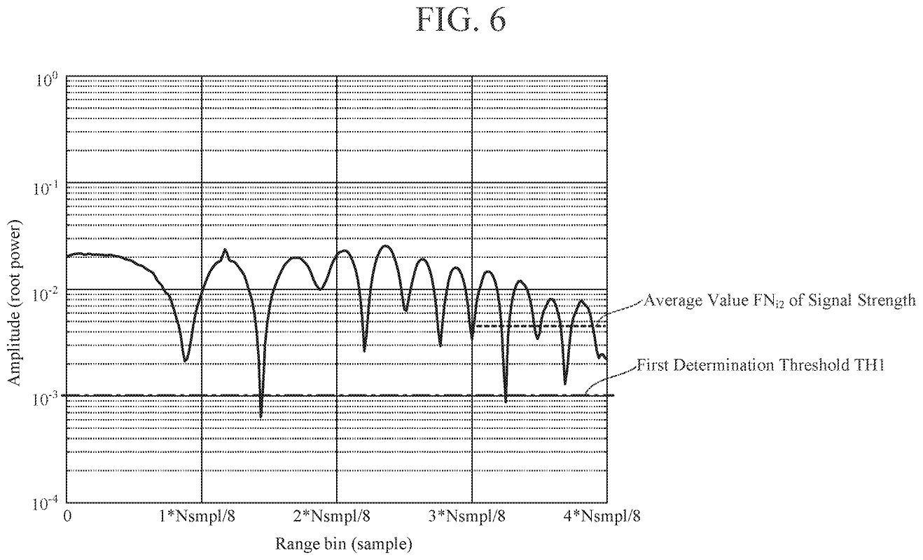

On the other hand, an average value FNᵢ₂ of the signal strengths of the data in the interference determination processing range (range of 3*N_smpl/8 to 4*N_smpl/8) in the distance information spectrum of the chirp i2 obtained when there is the interference signal is indicated by a broken line in FIG. 6 as an example.

In the distance information spectrum of the chirp i2 in a case where there is an interference signal, since the entire floor noise due to the interference signal is large in the reception signal, the average value FNᵢ₂ of the signal strengths is more than the average value FNᵢ₁ of the signal strengths, and the average value FNᵢ₂ of the signal strength is 5.0×10⁻³.

Therefore, as an example, the first determination threshold TH₁ is set to a value 1.0×10⁻³ (=2.0×10⁻⁴×5) obtained by multiplying the average value FN₀ of the signal strengths with no reflected signal and no interference signal from the observation target by a coefficient 5.

In FIGS. 5 and 6, the first determination threshold TH₁ is indicated by an alternate long and short dash line.

In FIGS. 5 and 6, the horizontal axis represents a distance bin, and the vertical axis represents a signal strength.

As is clear from FIGS. 5 and 6, the average value FNᵢ₁ of the signal strengths is less than the first determination threshold TH₁, and the average value FNᵢ₂ of the signal strengths is equal to or more than the first determination threshold TH₁.

Therefore, by obtaining the average value FN of the signal strengths of the data in the interference determination processing range in the distance information spectrum, it is possible to determine whether or not the distance information spectrum is appropriate with reference to the first determination threshold TH₁, that is, whether or not the interference signal is superimposed.

Accordingly, as to whether or not determination in the distance information spectrum by the interference countermeasure determining unit 52 is appropriate, when the average value FN of the signal strengths of the data in the interference determination processing range in the distance information spectrum is less than the first determination threshold TH₁, the distance information spectrum is determined as “appropriate”, and when the average value FN is equal to or more than the first determination threshold TH₁, the distance information spectrum is determined as “inappropriate”.

In the determination of the necessity of the interference countermeasure by the interference countermeasure determining unit 52, instead of determining the necessity of the interference countermeasure by whether or not the determination in one distance information spectrum is appropriate, when the number of chirps of inappropriate distance information spectra in the plurality of distance information spectra is less than the interference countermeasure threshold, the interference countermeasure is determined as “unnecessary”, and when the number of chirps of it is equal to or more than the interference countermeasure threshold, the interference countermeasure is determined as “necessary”.

The reason why the necessity of the interference countermeasure is determined by the number of chirps is that, for example, as illustrated in FIG. 3, suppose that an interference signal Rint from another radar device is received as a reception wave by the reception antenna 23 and input to the beat signal generating unit 3.

In many cases, the interference signal Rint has a sweep time T and a frequency bandwidth BW different from those of a chirp signal of a reception signal that is a received, reflected wave of a transmission wave based on a transmission signal emitted from the host radar device.

Further, a repetition time Tr_i of the interference signal Rint is often different from the repetition time Tr of the chirp signal of the reception signal.

In this case, the beat signal from the frequency mixing unit 31 is not constant, and is spread throughout as floor noise.

Further, when the repetition time Tr of the chirp signal of the reception signal is different from the repetition time Tr_i of the interference signal Rint, there is a case where the chirp does not occur in all chirps but occurs only in some chirps.

Therefore, when the necessity of the interference countermeasure is determined on the basis of whether the determination in one distance information spectrum is appropriate, it may be determined that the interference signal is not received although the interference signal is received, and there is a possibility that it is erroneously recognized.

In the first embodiment, the number of chirp signals of the transmission signal and the chirp signal of the reception signal in the signal acquisition period is K, the number of pieces of beat data having a frequency of a difference between the respective frequencies of the chirp signal of the transmission signal and the chirp signal of the reception signal, which are corresponded to each other is also K, and the number of distance information spectra by the beat data is also K.

For each of the K distance information spectra, the interference countermeasure determining unit 52 determines whether or not the distance information spectrum is appropriate on the basis of the first determination threshold TH₁, and calculates the number of chirps C1 of inappropriate distance information spectra.

The interference countermeasure determining unit 52 compares the calculated number of chirps C1 with a first interference countermeasure threshold M1, and performs necessity determination of the interference countermeasure so as to determine that the interference countermeasure is “unnecessary” when the number of chirps C1 is less than the first interference countermeasure threshold M1, and determine that the interference countermeasure is “necessary” when the number of chirps C1 is equal to or more than the first interference countermeasure threshold M1.

The first interference countermeasure threshold M1 is, for example, equal to or less than ½ of the number of chirps K on the assumption that a signal to noise ratio (SNR) at a distant observation target is low.

The first interference countermeasure threshold M1 may be stored in the internal memory of the signal processing unit 5 or may be provided to the signal processing unit 5 from the outside of the radar device.

In the distance and speed information outputting unit 53, the interference countermeasure determining unit 52 determines whether or not the interference countermeasure is not necessary, that is, determines that the interference countermeasure is unnecessary, and obtains data in the detection target frequency range in the plurality of distance information spectra calculated by the distance spectrum calculating unit 51 from the interference countermeasure determining unit 52.

Upon receiving the determination result that the interference countermeasure is unnecessary from the interference countermeasure determining unit 52, the distance and speed information outputting unit 53 may obtain data in the detection target frequency range in the plurality of distance information spectra calculated by the distance spectrum calculating unit 51 from the distance spectrum calculating unit 51.

The distance and speed information outputting unit 53 calculates the distance to the observation target and the relative speed with respect to the observation target from the received data in the detection target frequency range in the plurality of distance information spectra calculated by the distance spectrum calculating unit 51.

The distance and speed information outputting unit 53 includes the speed spectrum calculating unit 531 and the distance and speed information calculating unit 532.

The speed spectrum calculating unit 531 performs Fourier transform in a relative speed direction on the data in the detection target frequency range in the plurality of received distance information spectra calculated by the distance spectrum calculating unit 51 to calculate a distance and speed information spectrum.

That is, the speed spectrum calculating unit 531 calculates a speed information spectrum by performing Fourier transform of K points in the relative speed direction for each frequency spectrum in the data in the detection target frequency range in each distance information spectrum, for example, data of ½ sample points in N_smpl, and calculates a distance and speed information spectrum including a plurality of (N_smpl/2) speed information spectra in this example.

The speed spectrum calculating unit 531 Fourier-transforms ½ frequency spectra of N_smpl in the relative speed direction in the data in the detection target frequency range in the K distance information spectra, whereby the speed information spectrum value is integrated into a Doppler frequency Fsb_v expressed by the following equation (2).

Note that i represents any of 1 to K.

Fsb_v=2·fv/c (2)

Note that f is the center frequency of the chirp signal Lo(i) of the local oscillation signal that is the transmission signal, and v is the relative speed between the radar device and the observation target.

The speed spectrum calculating unit 531 outputs a distance and speed information spectrum including the calculated N_smpl/2 speed information spectra to the distance and speed information calculating unit 532.

The distance and speed information calculating unit 532 detects the peak value of the spectrum value in the distance and speed information spectrum calculated by the speed spectrum calculating unit 531, and calculates the distance to the observation target from the beat frequency Fsb_r related to the distance speed of the detected peak value and the relative speed with respect to the observation target from the Doppler frequency Fsb_v related to the distance speed of the detected peak value.

The detection of the peak value of the spectrum value in the distance and speed information spectrum by the distance and speed information calculating unit 532 and the calculation of each of the distance to the observation target and the relative speed with respect to the observation target by the distance and speed information calculating unit 532 are performed by a generally known technique, and thus detailed description thereof is omitted.

The signal processing unit 5 includes a central processing unit (CPU), a random access memory (RAM), and a read only memory (ROM), and by loading a program stored in the ROM into the RAM, and by the CPU executing various processes on the basis of the program loaded into the RAM, the above-described processes are executed. The signal processing unit 5 is driven by a general-purpose operating system (OS).

Each of the distance to the observation target and the relative speed with respect to the observation target obtained by the distance and speed information calculating unit 532 is displayed on the display unit 6.

Next, the operation of the radar device according to the first embodiment will be described.

Note that, in the following description, in order to avoid complication of the description, the number of times the chirp signal is intermittently repeated in the signal acquisition period will be described as K times, and the sampling point in the AD converting unit 4 will be described as an N-sampl point.

The transmission signal outputting unit 1 outputs, to the transmitting and receiving unit 2, a transmission signal that intermittently repeats a chirp signal whose frequency changes with the lapse of time.

The transmitting and receiving unit 2 that has received the transmission signal converts the transmission signal into a transmission wave by the transmission antenna 22 and emits the transmission wave toward the observation target.

Further, the transmission wave radiated from the transmission antenna 22 into space is reflected by the observation target, and the reception antenna 23 receives the reflected wave reflected by the observation target as a reception wave.

The transmitting and receiving unit 2 converts the reception wave received by the reception antenna 23 into a reception signal.

The reception signal output from the reception antenna 23 is a signal that intermittently repeats a chirp signal whose frequency changes with the lapse of time.

The transmitting and receiving unit 2 distributes the transmission signal received from the transmission signal outputting unit 1 by the distribution unit 21 and outputs the distributed transmission signal as a local oscillation signal to the beat signal generating unit 3, and outputs the reception signal from the reception antenna 23 to the beat signal generating unit 3.

The beat signal generating unit 3 causes the frequency mixing unit 31 to mix the chirp signal of the transmission signal output from the transmitting and receiving unit 2 and the chirp signal of the reception signal output from the reception antenna 23, generates a beat signal having a frequency of a difference between the respective frequencies of the chirp signal of the corresponding transmission signal and the chirp signal of the reception signal, and outputs the generated beat signal to the AD converting unit 4 via the filter unit 32.

The AD converting unit 4 converts the beat signal into digital data and outputs the converted beat data to the signal processing unit 5.

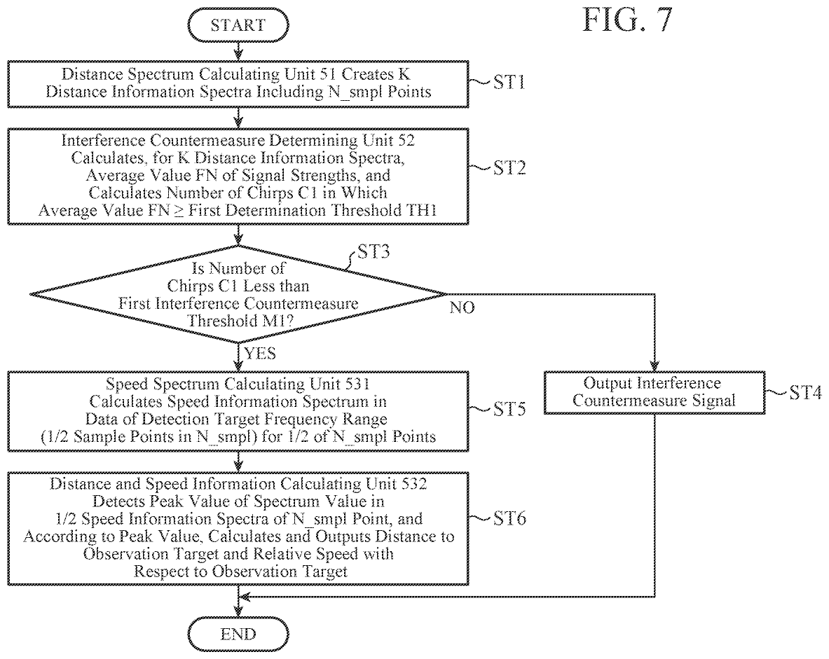

The operation of the signal processing unit 5 will be described with reference to the flowchart illustrated in FIG. 7.

FIG. 7 is a flowchart illustrating calculation processing of the distance to the observation target and the relative speed with respect to the observation target including interference determination in the signal processing unit 5 during the signal acquisition period.

Step ST1 is a step of calculating a distance information spectrum.

In step ST1, the distance spectrum calculating unit 51 specifies a signal acquisition period with reference to the control signal output from the control unit 11.

The distance spectrum calculating unit 51 performs Fourier transform of the N_smpl point of each piece of beat data in the distance direction using the beat data in the signal acquisition period from the AD converting unit 4, calculates K distance information spectra including the N_smpl points, and proceeds to step ST2.

Step ST2 is a step of calculating the number of chirps C1.

In step ST2, the interference countermeasure determining unit 52 acquires data in the detection target frequency range of the K distance information spectra obtained in step ST1.

The interference countermeasure determining unit 52 calculates, for each of the K distance information spectra, an average value FN of signal strengths that is a state value from the data in the interference determination processing range among the data in the detection target frequency range, and obtains an average value FN of signal strengths of the K distance information spectra.

The interference countermeasure determining unit 52 compares the average value FN of the signal strengths of the distance information spectrum with the first determination threshold TH₁ for each of the K distance information spectra, and obtains appropriateness with respect to the distance information spectrum.

The interference countermeasure determining unit 52 calculates the number of chirps C1 of inappropriate distance information spectra in which the average value FN of the signal strengths is equal to or more than the first determination threshold TH₁.

When the interference countermeasure determining unit 52 calculates the number of chirps C1 of the distance information spectrum, the process proceeds to step ST3.

Step ST3 is a step of performing necessity determination of an interference countermeasure.

In step ST3, the interference countermeasure determining unit 52 compares the number of chirps C1 calculated in step ST2 with the first interference countermeasure threshold M1, and performs necessity determination of the interference countermeasure so as to determine that the interference countermeasure is “unnecessary” when the number of chirps C1 is less than the first interference countermeasure threshold M1, and determine that the interference countermeasure is “necessary” when the number of chirps C1 is equal to or more than the first interference countermeasure threshold M1.

For example, as illustrated in FIG. 3, it is assumed that an interference signal Rint from another radar device is input to the beat signal generating unit 3. In this case, as illustrated in FIG. 3, when the interference signal Rint exists in the same chirp as the chirp signal Lo(i) in the transmission signal and the chirp signal Rx(i) in the reception signal, the beat signal from the frequency mixing unit 31 is not constant, and is spread throughout as floor noise due to the interference signal.

As a result, as illustrated in FIG. 6, the average value FNᵢ₂ of the signal strengths of the data in the interference determination processing range in the distance information spectrum becomes equal to or more than the first determination threshold TH₁.

Further, in a case where the interference signal Rint is input to the beat signal generating unit 3, the number of chirps C1 in which the chirp signal Lo(i), the chirp signal Rx(i), and the interference signal Rint are present in the same chirp is equal to or more than the first interference countermeasure threshold M1.

Therefore, when the interference signal Rint is input to the beat signal generating unit 3, the number of chirps C1 calculated in step ST2 becomes equal to or more than the first interference countermeasure threshold M1, and the interference signal Rint is recognized.

On the other hand, in a case where there is no interference signal from another radar device, the beat signal from the frequency mixing unit 31 becomes constant and depends only on the floor noise of the reception signal, and as illustrated in FIG. 5, the average value FNᵢ₁ of the signal strengths of the data in the interference determination processing range in the distance information spectrum becomes less than the first determination threshold TH₁, the number of chirps C1 calculated in step ST2 becomes less than the first interference countermeasure threshold M1, and the interference signal is not recognized.

Note that, in order to simplify the description, FIG. 3 illustrates an example in which there is one observation target and there is one interference from another radar device.

However, this is merely an example, and in a case where there are two or more observation targets, in a case where two or more interference signals are input to the frequency mixing unit 31 via the reception antenna 23, and in a case where the interference signal is electromagnetic noise input to the AD converting unit 4, the interference countermeasure determining unit 52 can similarly determine whether or not the distance information spectrum is appropriate and whether or not the interference countermeasure is necessary.

As described above, when the interference countermeasure determining unit 52 determines that the interference countermeasure is necessary in step ST3, the process proceeds to step ST4, and the signal processing unit 5 outputs an interference countermeasure signal to the control unit 11 of the transmission signal outputting unit 1 and the process ends.

On the other hand, when the interference countermeasure determining unit 52 determines that the interference countermeasure is unnecessary, the process proceeds to step ST5.

Step ST5 is a step of calculating a distance speed spectrum.

In step ST5, the speed spectrum calculating unit 531 calculates a speed information spectrum by performing Fourier transform at K points in the relative speed direction with respect to data in the detection target frequency range in each of the K distance information spectra calculated by the distance spectrum calculating unit 51, for example, each frequency spectrum in data of ½ sample points in N_smpl, and calculates a plurality of distance and speed information spectra including, in this example, ½ speed information spectra at N_smpl points, and the process proceeds to step ST6.

Step ST6 is a step of calculating and outputting the distance to the observation target and the relative speed with respect to the observation target.

In step ST6, the distance and speed information calculating unit 532 detects a peak value of a spectrum value in a distance and speed information spectrum including ½ speed information spectra of the N_smpl point calculated in step ST5.

The distance to the observation target is calculated from the beat frequency Fsb_r related to the distance speed of the peak value detected by the distance and speed information calculating unit 532.

The relative speed with respect to the observation target is calculated from the Doppler frequency Fsb_v related to the distance speed of the peak value detected by the distance and speed information calculating unit 532.

The distance to the observation target and the relative speed with respect to the observation target calculated by the distance and speed information calculating unit 532 are output to the display unit 6, and the process ends.

As described above, the radar device according to the first embodiment includes the distance spectrum calculating unit 51 that calculates a plurality of distance information spectra corresponding to each of a plurality of pieces of beat data obtained by converting, into digital data, a beat signal having a frequency of a difference between a frequency of a plurality of times of chirp signals received during a signal acquisition period in a transmission signal that repeats a chirp signal whose frequency changes with the lapse of time, and a frequency of a plurality of times of chirp signals in a reception signal that is in a correspondence relationship with the plurality of times of chirp signals in a transmission signal received during the signal acquisition period, the interference countermeasure determining unit 52 that obtains the state value of each of the plurality of distance information spectra from data in an interference determination processing range in the plurality of distance information spectra, compares the obtained state value with an interference determination threshold to obtain appropriateness in each of the plurality of distance information spectra, determines necessity of interference countermeasures from the number of inappropriate distance information spectra of the plurality of distance information spectra, and outputs the interference countermeasure signal for the chirp signal in the transmission signal when the interference countermeasure is necessary, so that it is possible to determine necessity of highly accurate interference countermeasure in the radar device of the fast chirp FMCW method using a plurality of chirps.

Furthermore, the radar device according to the first embodiment can suppress addition of a memory for determining necessity of an interference countermeasure, and can suppress deterioration in accuracy of determining whether or not an interference countermeasure is necessary.

### Second Embodiment

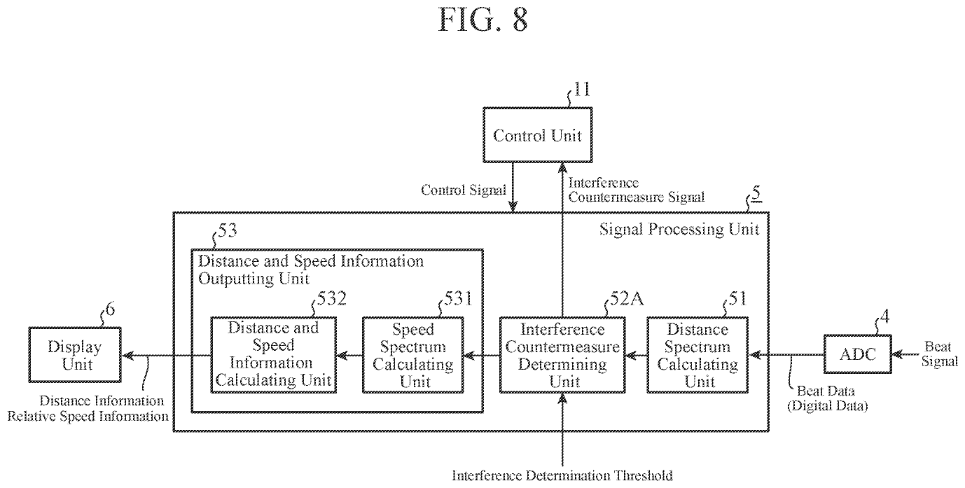

A fast chirp FMCW radar device according to a second embodiment will be described with reference to FIGS. 8 to 12.

In the radar device according to the second embodiment, only an interference countermeasure determining unit 52A of the signal processing unit 5 is different from the interference countermeasure determining unit 52 of the signal processing unit 5 in the radar device according to the first embodiment, and the other points are the same or similar.

In FIGS. 8 to 12, the same reference numerals as those attached in FIGS. 1 to 7 denote the same or corresponding parts.

In the radar device according to the first embodiment, the state value of the distance information spectrum obtained by the interference countermeasure determining unit 52 is set as the average value FN of the signal strengths of the data in the interference determination processing range in the distance information spectrum.

On the other hand, in the radar device according to the second embodiment, the state value of the distance information spectrum obtained by the interference countermeasure determining unit 52A is set as the signal strength ratio P/FN between the average value FN of the signal strengths of the data in the interference determination processing range in the distance information spectrum and the peak value P of the signal strength of the data in the detection target frequency range in the distance information spectrum with respect to the average value FN of the signal strengths, and the interference determination threshold is set as the first determination threshold TH₁ and the second determination threshold TH₂.

That is, the interference countermeasure determining unit 52A of the signal processing unit 5 in the radar device according to the second embodiment calculates the average value FN of respective signal strengths of the plurality of distance information spectra and the peak value P of the signal strength of the data in the detection target frequency range in each of the plurality of distance information spectra calculated by the distance spectrum calculating unit 51 from the data in the interference determination processing range in the plurality of distance information spectra calculated by the distance spectrum calculating unit 51.

The interference countermeasure determining unit 52A compares the average value FN of the signal strengths with the first determination threshold TH₁, and compares the signal strength ratio P/FN with the second determination threshold TH₂ to determine whether or not the distance information spectrum is appropriate, that is, whether the interference signal is superimposed.

When the average value FN of the signal strengths is equal to or more than the first determination threshold TH₁ and the signal strength ratio P/FN is equal to or less than the second determination threshold TH₂, the interference countermeasure determining unit 52A determines that the distance information spectrum is “inappropriate”.

The interference countermeasure determining unit 52A compares the number of chirps C1 with the distance information spectrum being “inappropriate” with the first interference countermeasure threshold M1, and performs necessity determination of the interference countermeasure so as to determine that the interference countermeasure is “unnecessary” when the number of chirps C1 is less than the first interference countermeasure threshold M1, and determine that the interference countermeasure is “necessary” when the number of chirps C1 is equal to or more than the first interference countermeasure threshold M1.

As described above, by using the signal strength ratio P/FN based on the peak value P in the detection target frequency range in the distance information spectrum for the necessity of the interference countermeasure, for example, even in a case where the peak value P of the signal strength increases due to the observation target being at a short distance, and the average value FN of the signal strengths in the detection target frequency range increases due to a phase jitter of the signal source 12, it is possible to suppress deterioration of the accuracy of the necessity determination of the interference countermeasure.

As is the interference countermeasure determining unit 52 in the radar device according to the first embodiment, the interference countermeasure determining unit 52A may determine that the distance information spectrum in which the average value FN of the signal strengths is less than the first determination threshold TH₁ is “appropriate”, and may perform determination such that the signal strength ratio P/FN is compared with the second determination threshold TH₂ with respect to the distance information spectrum determined as “inappropriate” in which the average value FN of the signal strengths is equal to or more than the first determination threshold TH₁, and the distance information spectrum is changed to “appropriate” when the signal strength ratio P/FN exceeds the second determination threshold TH₂.

Hereinafter, the radar device according to the second embodiment will be described focusing on the interference countermeasure determining unit 52A different from the interference countermeasure determining unit 52 in the radar device according to the first embodiment.

Description of the same configuration as that of the radar device according to the first embodiment will be omitted as much as possible.

The interference countermeasure determining unit 52A acquires the data in the detection target frequency range of the plurality of distance information spectra output from the distance spectrum calculating unit 51.

The interference countermeasure determining unit 52A calculates the average value FN of respective signal strengths of the plurality of distance information spectra and the peak value P of the signal strength of the data in the detection target frequency range in each of the plurality of distance information spectra calculated by the distance spectrum calculating unit 51 from the data in the interference determination processing range in the plurality of distance information spectra calculated by the distance spectrum calculating unit 51.

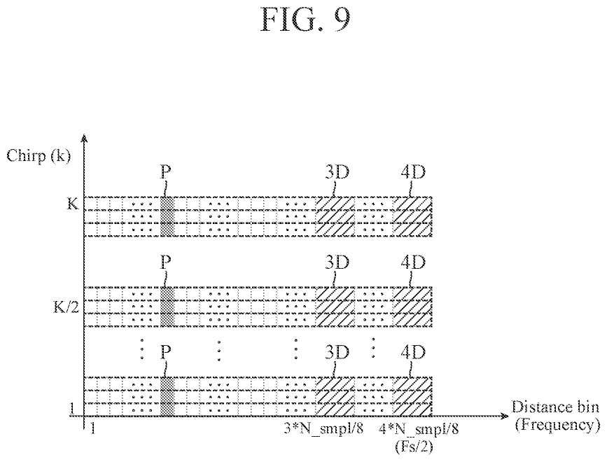

The interference determination processing range is the same as the interference determination processing range in the radar device according to the first embodiment, and is the latter half that is a part of the detection target frequency range, which is a range from 3D to a region 4D indicated by solid hatching in FIG. 9.

Further, the peak value P of the signal strength is indicated by shaded parts in FIG. 9 as an example.

The interference countermeasure determining unit 52A compares the average value FN of the signal strengths with the first determination threshold TH₁, and compares the signal strength ratio P/FN with the second determination threshold TH₂.

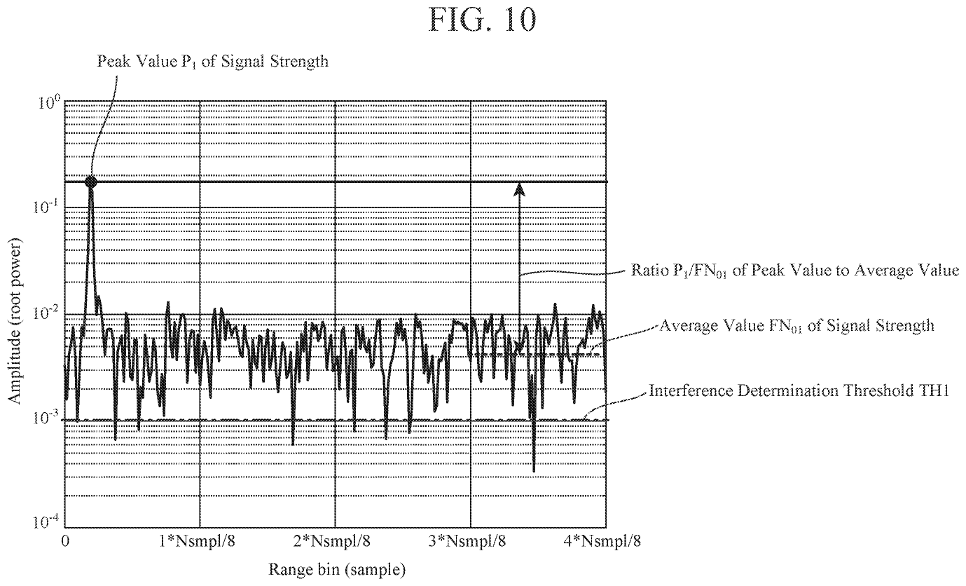

A distance information spectrum of a chirp i in a case where the observation target is at a short distance and there is no interference signal is illustrated in FIG. 10, and in FIG. 10, as an example, an average value FN₀₁ of the signal strengths of the data in the interference determination processing range is indicated by a broken line, the peak value P of the signal strength of the data in the detection target frequency range is indicated by a black circle, the first determination threshold TH₁ is indicated by a one-dot chain line, and the difference between the peak value P of the signal strength and the average value FN₀₁ of the signal strengths is indicated by a double-headed arrow.

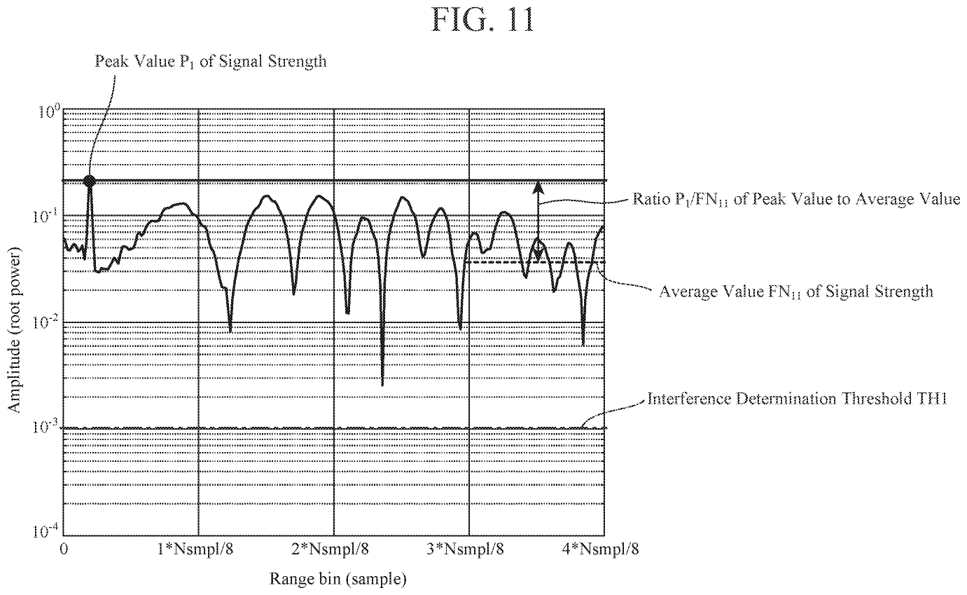

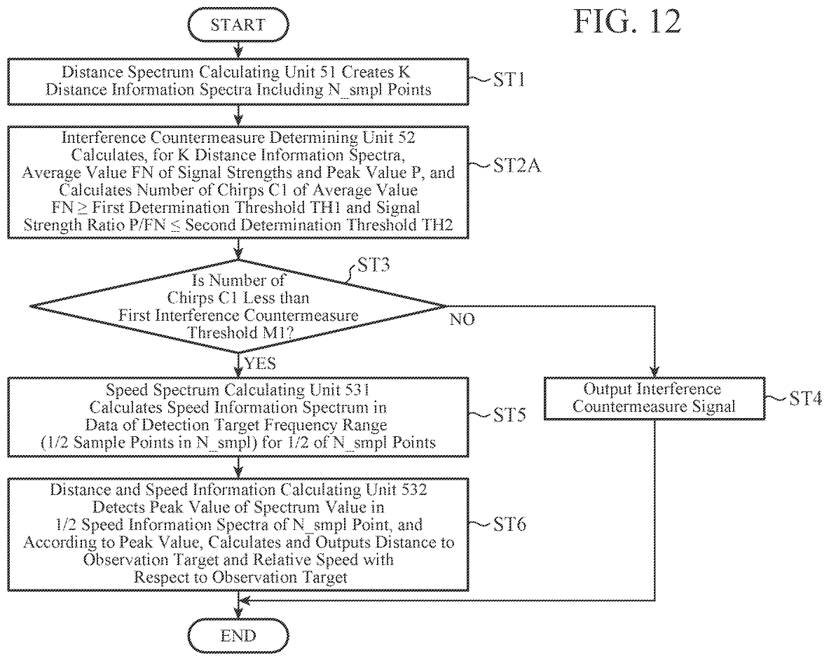

On the other hand, a distance information spectrum of a chirp i in a case where the observation target is at a short distance and there is an interference signal is illustrated in FIG. 11, and in FIG. 11, as an example, an average value FN₁₁ of the signal strengths of the data in the interference determination processing range is indicated by a broken line, the peak value P of the signal strength of the data in the detection target frequency range is indicated by a black circle, the first determination threshold TH₁ is indicated by a one-dot chain line, and the difference between the peak value P of the signal strength and the average value FN₁₁ of the signal strengths is indicated by a double-headed arrow.

The first determination threshold TH₁ is the same value as the first determination threshold TH₁ used in the radar device according to the first embodiment.

In FIGS. 10 and 11, the horizontal axis represents the distance bin, and the vertical axis represents the signal strength.

As is clear from FIG. 10, in a case where there is an observation target at a short distance and the signal strength is high, the average value FN₀₁ of the signal strengths may be large due to the phase jitter of the signal source 12, and the average value FN₀₁ of the signal strengths may be equal to or more than the first determination threshold TH₁. At this time, a peak occurs in the signal strength depending on the observation target, but the peak value P of the signal strength with respect to the average value FN₀₁ of the signal strength is large, and the signal strength ratio P/FN₀₁ is a large value. The peak value P of the signal strength with respect to the average value FN₀₁ of the signal strength is about 30 times, and the signal strength ratio P/FN₀₁≈30.

As is clear from FIG. 11, since the entire floor noise due to the interference signal is large, the average value FN₁₁ of the signal strength is further more than the average value FN₀₁ of the signal strength, and the average value FNᵢ₁ of the signal strength is closer to the peak value P of the signal strength than the average value FN₀₁ of the signal strength.

The difference between the average value FN₁₁ of the signal strength and the peak value P of the signal strength is small, and the signal strength ratio P/FN₁₁ is a small value. The peak value P of the signal strength with respect to the average value FNᵢ₁ of the signal strength is about 2.5 times, and the signal strength ratio P/FN₀₁≈2.5.

Therefore, the second determination threshold TH₂ is set to 5 as an example.

Therefore, in a case where there is an observation target at a short distance and the signal strength is high, in a case where there is no interference signal and in a case where there is an interference signal, the average value FN₀₁ of the signal strength and the average value FNᵢ₁ of the signal strength are equal to or more than the first determination threshold TH₁, but the signal strength ratio P/FN₀₁ in a case where there is no interference signal is larger than the second determination threshold TH₂, and the signal strength ratio P/FN₀₁ in a case where there is an interference signal is equal to or less than the second determination threshold TH₂.

Although the average value FN of the signal strength is equal to or more than the first determination threshold TH₁, it is possible to determine whether or not interference occurs in the chirp of the target by comparing and determining the signal strength ratio P/FN with reference to the second determination threshold TH₂. That is, it is possible to determine whether or not the distance information spectrum is appropriate.

For each of the K distance information spectra, the interference countermeasure determining unit 52A determines whether or not the distance information spectrum is appropriate on the basis of the first determination threshold TH₁ and the second determination threshold TH₂, and calculates the number of chirps C1 of inappropriate distance information spectra.

That is, the interference countermeasure determining unit 52A obtains the number of chirps C1 of the distance information spectrum in which the average value FN of the signal strengths is equal to or more than the first determination threshold TH₁ and the signal strength ratio P/FN is equal to or less than the second determination threshold TH₂ among the K distance information spectra.

The interference countermeasure determining unit 52A compares the number of chirps C1 with the distance information spectrum being “inappropriate” with the first interference countermeasure threshold M1, and performs necessity determination of the interference countermeasure so as to determine that the interference countermeasure is “unnecessary” when the number of chirps C1 is less than the first interference countermeasure threshold M1, and determine that the interference countermeasure is “necessary” when the number of chirps C1 is equal to or more than the first interference countermeasure threshold M1.

The interference countermeasure determining unit 52A outputs an interference countermeasure signal for the transmission signal to the control unit 11 when it is determined that the interference countermeasure is necessary, that is, needed, and outputs a plurality of distance information spectra calculated by the distance spectrum calculating unit 51 to the distance and speed information outputting unit 53 when it is determined that the interference countermeasure is not necessary, that is, unnecessary.

Next, the operation of the radar device according to the second embodiment will be described.

The operation is the same as the operation of the radar device according to the first embodiment until beat data of K chirps is output from the AD converting unit 4 to the signal processing unit 5, and thus the description thereof will be omitted.

An operation of the signal processing unit 5 to which beat data of K chirps is input will be described with reference to a flowchart illustrated in FIG. 12.

FIG. 12 is a flowchart illustrating calculation processing of the distance to the observation target and the relative speed with respect to the observation target including interference determination in the signal processing unit 5.

Step ST1 of calculating the distance information spectrum is the same as step ST1 of the radar device according to the first embodiment.

Step ST2A is a step of calculating the number of chirps C1, and is a step corresponding to step ST2 of the radar device according to the first embodiment.

In step ST2A, the interference countermeasure determining unit 52A acquires data in the detection target frequency range of the K distance information spectra obtained in step ST1.

For each of the K distance information spectra, the interference countermeasure determining unit 52A calculates the average value FN of the signal strengths, which are one of the state values, from the data in the interference determination processing range among the data in the detection target frequency range, and obtains an average value FN of the signal strengths of the K distance information spectra.

For each of the K distance information spectra, the interference countermeasure determining unit 52A detects the peak value P of the data in the detection target frequency range, calculates the signal strength ratio P/FN, which is one of the state values, and obtains the signal strength ratios P/FN of the K distance information spectra.

The interference countermeasure determining unit 52A compares the average value FN of the signal strength of the distance information spectrum with the first determination threshold TH₁, and the signal strength ratio P/FN with the second determination threshold TH₂ with respect to each of the K distance information spectra, and obtains appropriateness with respect to the distance information spectrum.

The interference countermeasure determining unit 52A calculates the number of chirps C1 of inappropriate distance information spectrum in which the average value FN of the signal strengths is equal to or more than the first determination threshold TH₁ and the signal strength ratio P/FN is equal to or less than the second determination threshold TH₂.

When the interference countermeasure determining unit 52A calculates the number of chirps C1 of the distance information spectrum, the process proceeds to step ST3.

The operation after step ST3 is the same as the operation after step ST3 of the radar device according to the first embodiment, and when the interference countermeasure determining unit 52A determines that the interference countermeasure is necessary in step ST3, the process proceeds to step ST4, and the signal processing unit 5 outputs an interference countermeasure signal to the control unit 11 of the transmission signal outputting unit 1 and the process ends.

Further, when the interference countermeasure determining unit 52A determines in step ST3 that the interference countermeasure is unnecessary, the process proceeds to steps ST5 and ST6, and the distance to the observation target and the relative speed with respect to the observation target calculated by the distance and speed information calculating unit 532 are output to the display unit 6, and the process ends.

As described above, the radar device according to the second embodiment has an effect similar to that of the radar device according to the first embodiment, and even in a case where the peak value P of the signal strength increases due to the observation target being at a short distance, it is possible to determine the necessity of highly accurate interference countermeasures in the radar device of the fast chirp FMCW method using a plurality of chirps.

### Third Embodiment

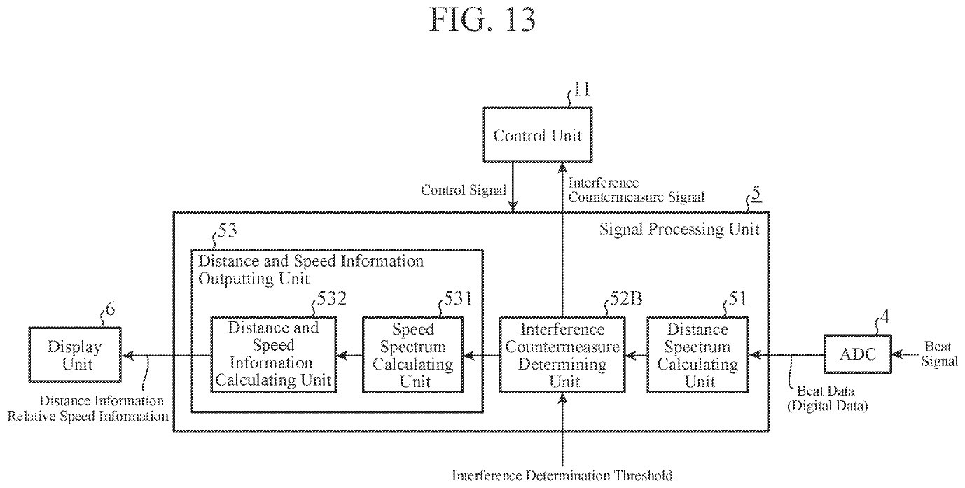

A fast chirp FMCW radar device according to a third embodiment will be described with reference to FIGS. 13 to 18.

In the radar device according to the third embodiment, only an interference countermeasure determining unit 52B of the signal processing unit 5 is different from the interference countermeasure determining unit 52 of the signal processing unit 5 in the radar device according to the first embodiment, and the other points are the same or similar.

In FIGS. 13 to 18, the same reference numerals as those attached in FIGS. 1 to 7 denote the same or corresponding parts.

In the radar device according to the first embodiment, the state value of the distance information spectrum obtained by the interference countermeasure determining unit 52 is set as the average value FN of the signal strengths of the data in the interference determination processing range in the distance information spectrum.

On the other hand, in the radar device according to the third embodiment, the state value of the distance information spectrum obtained by the interference countermeasure determining unit 52B is set as the signal strength ratio P/FN of the peak value P of the signal strength of the data in the detection target frequency range in the distance information spectrum to the average value FN of the signal strengths of the data in the interference determination processing range in the distance information spectrum, and the interference determination threshold is set as a third determination threshold TH₃.

The third determination threshold TH₃ may be the same value as the second determination threshold TH₂.

That is, the interference countermeasure determining unit 52B of the signal processing unit 5 in the radar device according to the third embodiment acquires the data in the detection target frequency range of the plurality of distance information spectra output from the distance spectrum calculating unit 51.

The interference countermeasure determining unit 52B calculates the average value FN of respective signal strengths of the plurality of distance information spectra and the peak value P of the signal strength of the data in the detection target frequency range in each of the plurality of distance information spectra calculated by the distance spectrum calculating unit 51 from the data in the interference determination processing range in the plurality of distance information spectra calculated by the distance spectrum calculating unit 51.

By comparing the signal strength ratio P/FN with the third determination threshold TH₃, the interference countermeasure determining unit 52B obtains the distance D at which there is a peak value with which the signal strength ratio P/FN in the distance information spectrum is equal to or more than the third determination threshold TH₃ and the number of distance information spectra having a peak value with which the signal strength ratio P/FN is equal to or more than the third determination threshold TH₃ at the distance D, that is, the number of chirps C1.

The interference countermeasure determining unit 52B compares the number of chirps C1 in which there is a peak value with which the signal strength ratio P/FN at the distance D is equal to or more than the third determination threshold TH₃ with a second interference countermeasure threshold M2, and performs necessity determination of the interference countermeasure so as to determine that the interference countermeasure is “unnecessary” when the number of chirps C1 is out of the range of the second interference countermeasure threshold M2, and determine that the interference countermeasure is “necessary” when the number of chirps C1 is within the range of the second interference countermeasure threshold M2.

As described above, by using the number of chirps C1 in which there is a peak value with which the signal strength ratio P/FN at the distance D is equal to or more than the third determination threshold TH₃ for the necessity of the interference countermeasure, it is possible to accurately determine whether or not the interference signal is superimposed when the slope at which the frequency of the interference signal changes is the same as the slope at which the frequency of the chirp signal of the reception signal changes.

The radar device according to the first embodiment is suitable in a case where the interference signal is different from the chirp signal of the reception signal in the sweep time T and the frequency bandwidth BW, that is, in a case where the slope at which the frequency changes is different, and the radar device according to the third embodiment is suitable in a case where the interference signal is the same as the chirp signal of the reception signal in the sweep time T and the frequency bandwidth BW, that is, in a case where the slope at which the frequency changes is the same.

Both the interference countermeasure determining unit 52 and the interference countermeasure determining unit 52B may be mounted on the radar device as the interference countermeasure determining unit, and both may be used to be switched.

Hereinafter, the radar device according to the third embodiment will be described focusing on an interference countermeasure determining unit 52B different from the interference countermeasure determining unit 52 in the radar device according to the first embodiment.

Description of the same configuration as that of the radar device according to the first embodiment will be omitted as much as possible.

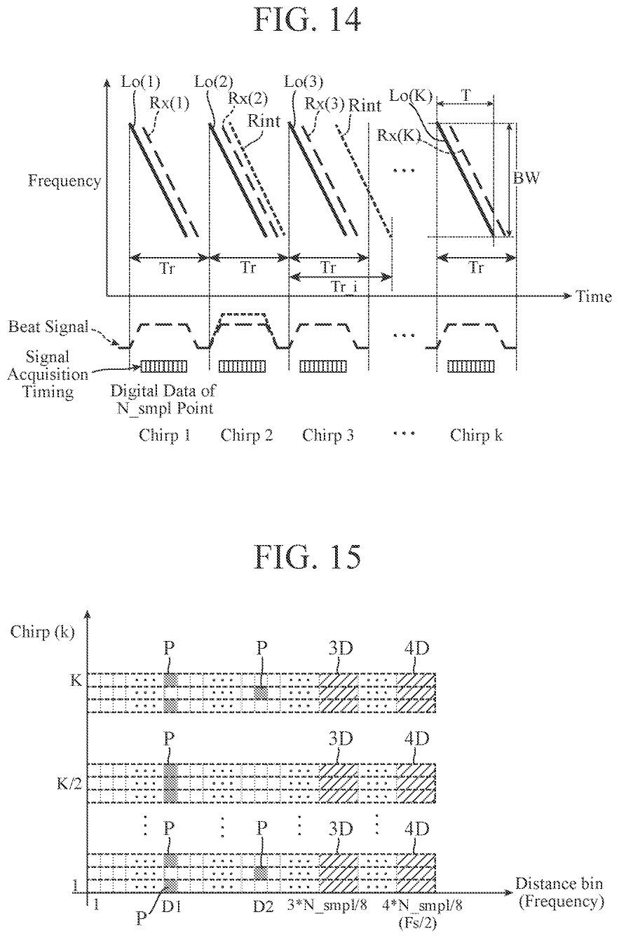

As illustrated in FIG. 14, it is assumed that the interference signal Rint from another radar device having the same sweep time T and frequency bandwidth BW but different repetition time Tr_i from the repetition time Tr is received by the reception antenna 23 as a reception wave with respect to each of the chirp signal Lo(1) to the chirp signal Lo(K) in the transmission signal output from the transmitting and receiving unit 2 and the chirp signal Rx(1) to the chirp signal Rx(K) in the reception signal output from the transmitting and receiving unit 2.

When the sweep time T and the frequency bandwidth BW of the interference signal Rint are the same, a beat signal having a frequency of a difference between the frequency of the interference signal Rint and the frequency of the chirp signal in the transmission signal is generated by the frequency mixing unit 31.

On the other hand, since the repetition time Tr_i of the interference signal Rint is different from the repetition time Tr of the chirp signal in the transmission signal, the beat signal by the interference signal Rint does not occur in all chirps, and the beat signal by the interference signal Rint occurs only in some chirps.

Note that FIG. 14 illustrates an example in which the sweep time T and the frequency bandwidth BW of the chirp signal in the reception signal are the same as the sweep time T and the frequency bandwidth BW of the interference signal in order to simplify the description, but even in a case where the slope of the frequency of the chirp signal in the reception signal (the ratio of the sweep time T and the frequency bandwidth BW) and the slope of the frequency of the interference signal are the same, a peak due to the interference signal occurs and hence the interference countermeasure determining unit 52 can determine whether or not the distance information spectrum is appropriate and whether or not the interference countermeasure is necessary.

Further, in order to simplify the description, FIG. 14 illustrates an example in which there is one observation target and there is one interference from the other radar device.

However, this is merely an example, and also in a case where there are two or more observation targets and in a case where two or more interference signals are input to the frequency mixing unit 31 via the reception antenna 23, the interference countermeasure determining unit 52B can similarly determine whether or not the distance information spectrum is appropriate and whether or not the interference countermeasure is necessary for the interference signals having the same slope at which the frequency changes and having different repetition times.

The interference countermeasure determining unit 52B acquires the data in the detection target frequency range of the plurality of distance information spectra output from the distance spectrum calculating unit 51.

The interference countermeasure determining unit 52B calculates the average value FN of respective signal strengths of the plurality of distance information spectra, the peak value P of the signal strength of the data in the detection target frequency range in each of the plurality of distance information spectra calculated by the distance spectrum calculating unit 51, and the distance D at the peak value P of the signal strength from the data in the interference determination processing range in the plurality of distance information spectra calculated by the distance spectrum calculating unit 51.

The interference determination processing range is the same as the interference determination processing range in the radar device according to the first embodiment, and is the latter half that is a part of the detection target frequency range, which is the range from the region 3D to the region 4D indicated by solid hatching in FIG. 15.

Further, as an example, the peak value P of the signal strength is indicated by shaded parts in FIG. 15, and distances to the peak value P are indicated as D1 and D2.

The peak value P existing at the distance D1 appears in (K−2) chirps as an example, and the peak value P existing at the distance D2 appears in two chirps as an example.

The peak value P existing at the distance D1 indicates a peak value due to reception of a reflected wave from the observation target.

The peak value P existing at the distance D2 indicates a peak value due to reception of a transmission wave from the other radar device having the same sweep time T and frequency bandwidth BW but different repetition time Tr_i from the repetition time Tr.

The interference countermeasure determining unit 52B compares the signal strength ratio P/FN with the third determination threshold TH₃ to obtain the peak value in the detection target frequency range of the distance information spectrum and the distance D where the peak value exists.

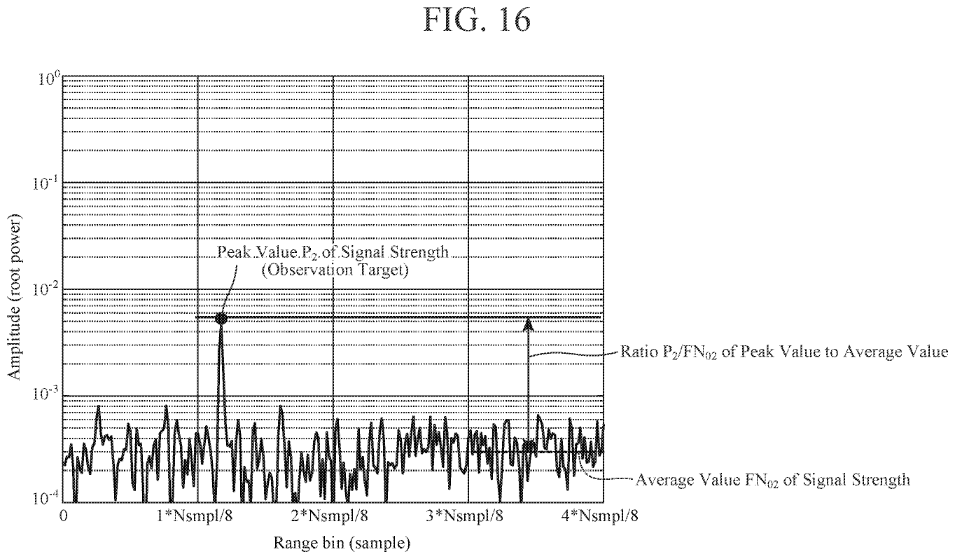

FIG. 16 illustrates a distance information spectrum of the chirp i when the transmission wave from the other radar device is not received and there is no interference signal. In FIG. 16, as an example, an average value FN₀₂ of the signal strength of the data in the interference determination processing range is indicated by a broken line, the peak value P of the signal strength of the data in the detection target frequency range is indicated by a black circle, and the difference between the peak value P of the signal strength and the average value FN₀₂ of the signal strength is indicated by a double-headed arrow.

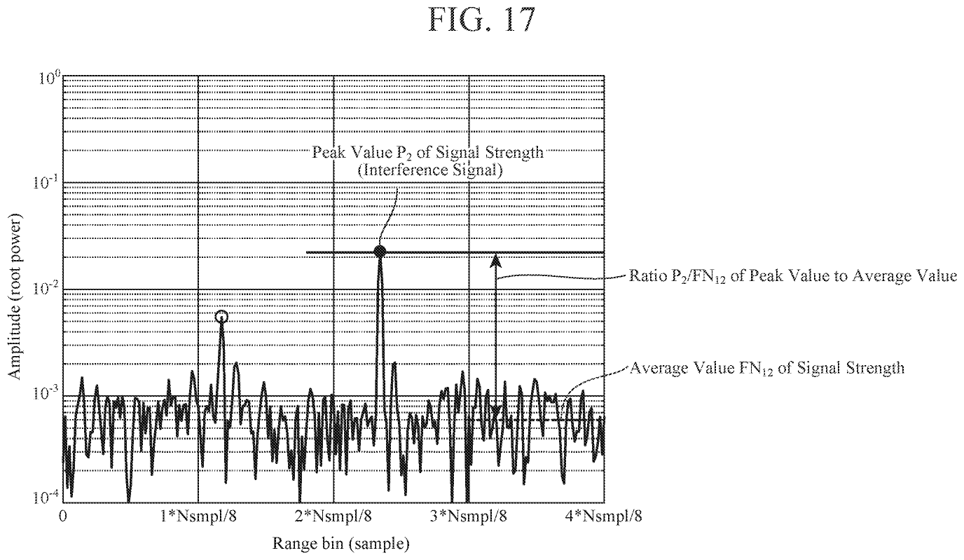

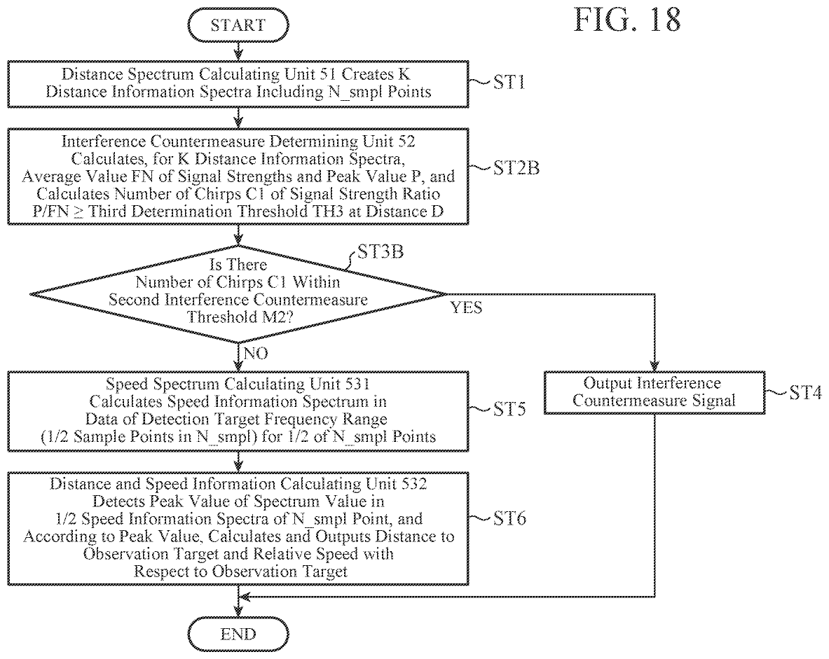

On the other hand, FIG. 17 illustrates a distance information spectrum of the chirp i in a case where a transmission wave from the other radar device is received and there is an interference signal. In FIG. 17, as an example, the average value FN₁₂ of the signal strength of the data in the interference determination processing range is indicated by a broken line, the peak value P of the signal strength of the data in the detection target frequency range is indicated by a black circle, and the difference between the peak value P of the signal strength and the average value FN₀₂ of the signal strength is indicated by a double-headed arrow.

In FIGS. 16 and 17, the horizontal axis represents the distance bin, and the vertical axis represents the signal strength.

In a case where there is no interference signal by the other radar device, as illustrated in FIG. 16, there is only a peak value due to reception of a reflected wave from the observation target.

However, in a case where there is an interference signal by the other radar device, as illustrated in FIG. 17, there is a peak value (indicated by a black circle in FIG. 17) due to reception of a transmission wave from the other radar device in addition to a peak value (indicated by a white circle in FIG. 17) due to reception of a reflected wave from the observation target.

Normally, since the propagation distance of the transmission wave from the other radar device is shorter than the propagation distance of the reflected wave from the observation target, the peak value (black circle in FIG. 17) due to reception of the transmission wave from the other radar device is larger than the peak value (white circle in FIG. 17) due to reception of the reflected wave from the observation target.

Therefore, when the signal strength ratio P/FN is equal to or more than the third determination threshold TH₃, the peak value can be calculated regardless of the presence or absence of an interference signal by the other radar device, and in a case where there is an interference signal by the other radar device, the peak value appearing in the distance information spectrum appears at a distance due to reception of the transmission wave from the other radar device.

Further, the influence of the reception of the transmission wave from the other radar device does not appear in the distance information spectra of all the chirps, but the influence of the reception of the transmission wave from the other radar device appears only in the distance information spectra of some chirps.

Therefore, when the number of chirps in which the peak value appears at the distance D2 is within the range of the second interference countermeasure threshold M2, it can be determined that there is an interference signal due to reception of the transmission wave from the other radar device.

In the example illustrated in FIG. 15, the peak value P existing at the distance D1 appears in (K−2) chirps, and the peak value P existing at the distance D2 appears in two chirps.

For example, when the second interference countermeasure threshold M2 is in the range of 1 to 10, since the peak value P existing at the distance D2 appears in the two chirps, it can be determined that the transmission wave from the other radar device is received.

Therefore, the interference countermeasure determining unit 52B compares the signal strength ratio P/FN with the third determination threshold TH₃ in each distance information spectrum, and performs the necessity determination of the interference countermeasure so as to determine that the interference countermeasure is “necessary” when the number of distance information spectra in which the signal strength ratio P/FN is equal to or more than the third determination threshold TH₃ at the same distance D, that is, the number of chirps C1 is within the range of the second interference countermeasure threshold M2.

Further, in the same distance D, when the number of chirps at which the signal strength ratio P/FN is equal to or more than the third determination threshold TH₃ is out of the range of the second interference countermeasure threshold M2, that is, when the number of chirps is zero, it can be determined that no transmission wave from the other radar device has been received at the distance D, and when the number of chirps exceeds 10, it can be determined that a peak value due to reception of a reflected wave from the observation target appears at the distance D.

Therefore, if there is the number of chirps C1 at which the signal strength ratio P/FN is equal to or higher than the third determination threshold TH₃, within the range of the second interference countermeasure threshold M2, at the same distance D, the interference countermeasure determining unit 52B determines that the interference countermeasure is “necessary” and outputs an interference countermeasure signal for the transmission signal to the control unit 11.

If there is no number of chirps C1 at which the signal strength ratio P/FN is equal to or higher than the third determination threshold TH₃, within the range of the second interference countermeasure threshold M2, at the same distance D, the interference countermeasure determining unit 52B determines that no transmission wave from the other radar device has been received, determines that the interference countermeasure is “unnecessary”, and outputs the plurality of distance information spectra calculated by the distance spectrum calculating unit 51 to the distance and speed information outputting unit 53.

As described above, by using the signal strength ratio P/FN based on the average value FN of the signal strengths of the data in the interference determination processing range in the distance information spectrum and the peak value P in the detection target frequency range in the distance information spectrum, and determining that the interference countermeasure is necessary when the number of chirps C1 at which the signal strength ratio P/FN at the same distance D is equal to or more than the third determination threshold TH₃ falls within the range of the second interference countermeasure threshold M2, it is possible to suppress the deterioration of accuracy of the necessity determination of the interference countermeasure even if the interference signal due to a transmission wave is input to the frequency mixing unit 31 via the reception antenna 23 from the other radar device having the same sweep time T and frequency bandwidth BW but different repetition time Tr_i from the repetition time Tr of the transmission signal.

Next, the operation of the radar device according to the third embodiment will be described.

The operation is the same as the operation of the radar device according to the first embodiment until beat data of K chirps is output from the AD converting unit 4 to the signal processing unit 5, and thus the description thereof will be omitted.

An operation of the signal processing unit 5 to which beat data of K chirps is input will be described with reference to a flowchart illustrated in FIG. 18.

FIG. 18 is a flowchart illustrating calculation processing of the distance to the observation target and the relative speed with respect to the observation target including interference determination in the signal processing unit 5.

Step ST1 of calculating the distance information spectrum is the same as step ST1 of the radar device according to the first embodiment.

Step ST2B is a step of calculating the number of chirps C1, and is a step corresponding to step ST2 of the radar device according to the first embodiment.

In step ST2B, the interference countermeasure determining unit 52B acquires data in the detection target frequency range of the K distance information spectra obtained in step ST1.

For each of the K distance information spectra, the interference countermeasure determining unit 52B detects the peak value of the data in the detection target frequency range, calculates the signal strength ratio P/FN, which is one of the state values, and obtains the signal strength ratios P/FN of the K distance information spectra.

The interference countermeasure determining unit 52B associates the signal strength ratio P/FN of the K distance information spectra with the distance D.

The interference countermeasure determining unit 52B calculates the number of chirps C1 associated with the distance D and having the signal strength ratio P/FN equal to or more than the third determination threshold TH₃.

When the interference countermeasure determining unit 52B calculates the number of chirps C1 associated with the distance D, the process proceeds to step ST3B.

Step ST3B is a step of performing the necessity determination of the interference countermeasure, and is a step corresponding to step ST3 of the radar device according to the first embodiment.

In step ST3B, the interference countermeasure determining unit 52B compares the number of chirps C1 associated with the distance D calculated in step ST2B by the interference countermeasure determining unit 52 with the second interference countermeasure threshold M2, and performs necessity determination of the interference countermeasure so as to determine that the interference countermeasure is necessary if the number of chirps C1 is within the range of the second interference countermeasure threshold M2, and determine that the interference countermeasure is “unnecessary” if there is no chirp C1 within the range of the second interference countermeasure threshold M2.

When the interference countermeasure determining unit 52 determines that the interference countermeasure is necessary in step ST3B, the process proceeds to step ST4, and the signal processing unit 5 outputs an interference countermeasure signal to the control unit 11 of the transmission signal outputting unit 1 and the process ends.

On the other hand, when the interference countermeasure determining unit 52B determines that the interference countermeasure is unnecessary, the process proceeds to step ST5.

The operations in and after step ST5 are the same as the operations in and after step ST5 of the radar device according to the first embodiment, and the distance to the observation target and the relative speed with respect to the observation target calculated by the distance and speed information calculating unit 532 are output to the display unit 6 and the process ends.

As described above, in the radar device according to the third embodiment, since the interference countermeasure determining unit 52B determines whether or not an interference countermeasure is necessary depending on whether or not the number of chirps C1 in which the signal strength ratio P/FN at the same distance is equal to or more than the third determination threshold TH₃ exists within the range of the second interference countermeasure threshold M2, even if an interference signal due to a transmission wave is input to the frequency mixing unit 31 via the reception antenna 23 from another radar device having the same sweep time T and frequency bandwidth BW but different repetition time Tr_i from the repetition time Tr of the transmission signal, it is possible to determine necessity of an interference countermeasure with high accuracy in the radar device of the fast chirp FMCW system using a plurality of chirps.

### Fourth Embodiment

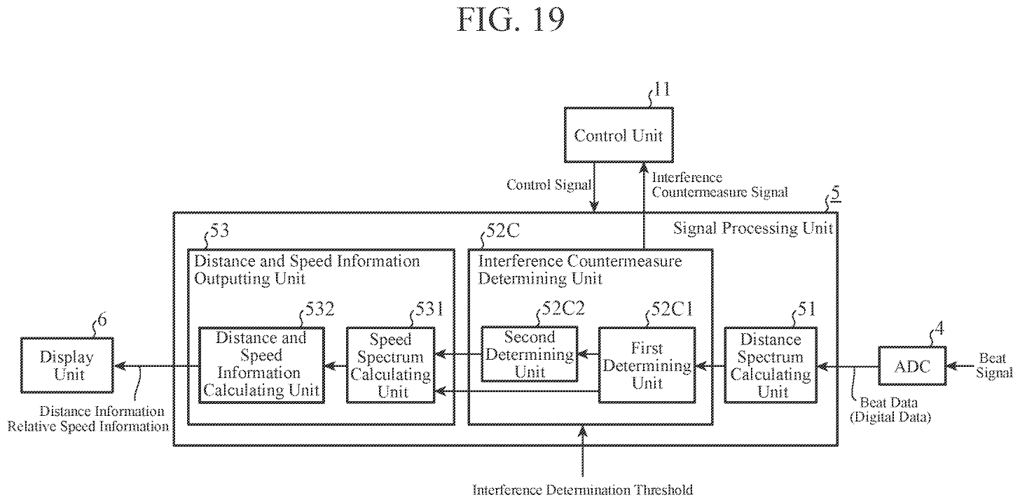

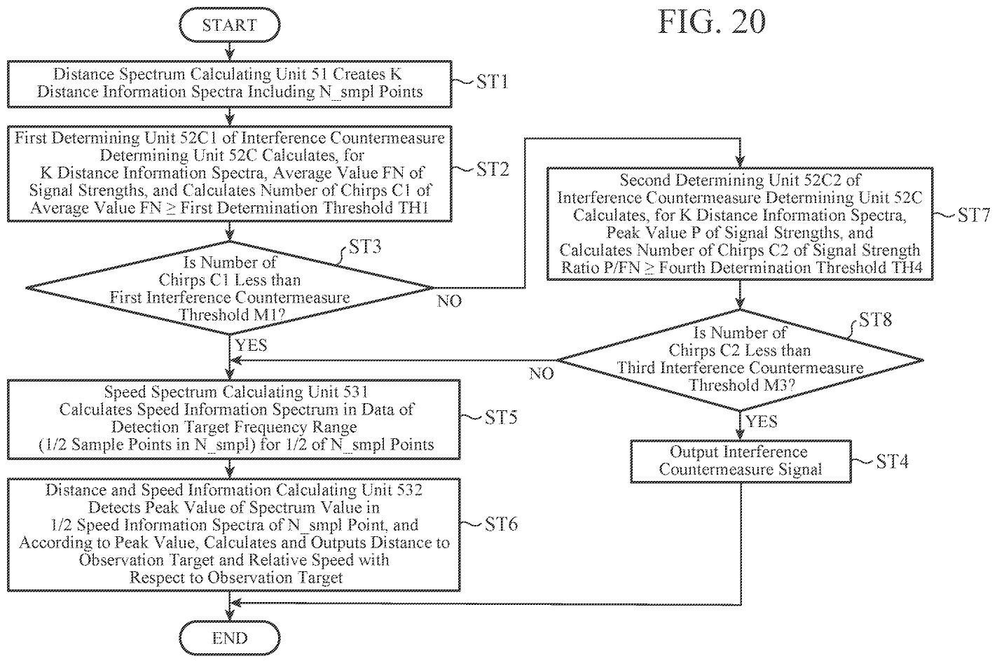

A fast chirp FMCW radar device according to a fourth embodiment will be described with reference to FIGS. 19 and 20.

In the radar device according to the fourth embodiment, only an interference countermeasure determining unit 52C of the signal processing unit 5 is different from the interference countermeasure determining unit 52 of the signal processing unit 5 in the radar device according to the first embodiment, and the other points are the same or similar.

In FIGS. 19 and 20, the same reference numerals as those attached in FIGS. 1 to 7 denote the same or corresponding parts.

The radar device according to the first embodiment sets the state value of the distance information spectrum obtained by the interference countermeasure determining unit 52 as the average value FN of the signal strengths of the data in the interference determination processing range in the distance information spectrum, and determines necessity of the interference countermeasure from the number of distance information spectra in which the average value FN of the signal strengths is equal to or more than the first determination threshold.

On the other hand, the radar device according to the fourth embodiment sets the state value of the distance information spectrum obtained by the interference countermeasure determining unit 52C as the average value FN of the signal strengths of the data in the interference determination processing range in the distance information spectrum and the signal strength ratio P/FN between the peak value P of the signal strength of the data in the detection target frequency range in the distance information spectrum and the average value FN of the signal strengths, and performs first determination of necessity of the interference countermeasure on the basis of the number of distance information spectra in which the average value FN of the signal strengths is equal to or more than the first determination threshold TH₁ and second determination of necessity of the interference countermeasure on the basis of the number of distance information spectra in which the signal strength ratio P/FN is equal to or more than the fourth determination threshold TH₄ when it is determined that the interference countermeasure is necessary by the first determination.

The interference countermeasure determining unit 52C includes a first determining unit 52C1 and a second determining unit 52C2.

The first determining unit 52C1 is a determining unit equivalent to the interference countermeasure determining unit 52 of the radar device according to the first embodiment.

The first determination threshold TH₁ and the first interference countermeasure threshold M1 are the same values as the first determination threshold TH₁ and the first interference countermeasure threshold M1 used in the radar device according to the first embodiment.

The first determining unit 52C1 acquires the data in the detection target frequency range of the plurality of distance information spectra output from the distance spectrum calculating unit 51.

The first determining unit 52C1 calculates the average value FN of the signal strengths, which is one of the state values of each of the plurality of distance information spectra, from the data in the interference determination processing range in the plurality of distance information spectra calculated by the distance spectrum calculating unit 51.

The first determining unit 52C1 compares the calculated average value FN of respective signal strengths of the distance information spectra with the first determination threshold TH₁, which is one of the interference determination thresholds, to obtain appropriateness in each of the plurality of distance information spectra, and determines whether or not an interference countermeasure is necessary from the number of inappropriate distance information spectra in the plurality of distance information spectra.

As to whether or not determination in the distance information spectrum by the first determining unit 52C1 is appropriate, when the average value FN of the signal strengths of the data in the interference determination processing range in the distance information spectrum is less than the first determination threshold TH₁, the distance information spectrum is determined as “appropriate”, and when the average value FN is equal to or more than the first determination threshold TH₁, the distance information spectrum is determined as “inappropriate”.

In the determination of necessity of the interference countermeasure by the first determining unit 52C1, when the number of chirps C1 of inappropriate distance information spectra in the plurality of distance information spectra is less than the first interference countermeasure threshold M1, the interference countermeasure is determined as “unnecessary”, and when the number of chirps C1 is equal to or more than the first interference countermeasure threshold M1, the interference countermeasure is determined as “necessary”.

When determining that the interference countermeasure is necessary, that is, needed, the first determining unit 52C1 outputs the plurality of distance information spectra calculated by the distance spectrum calculating unit 51 and the average value FN of the calculated signal strengths to the second determining unit 52C2.

When the first determining unit 52C1 determines that the interference countermeasure is not necessary, that is, unnecessary, the first determining unit outputs the plurality of distance information spectra calculated by the distance spectrum calculating unit 51 to the distance and speed information outputting unit 53.

When the first determining unit 52C1 determines that the interference countermeasure is necessary, the second determining unit 52C2 acquires the plurality of distance information spectra calculated by the distance spectrum calculating unit 51 and the average value FN of the signal strength calculated by the first determining unit 52C1 from the first determining unit 52C1.

The second determining unit 52C2 calculates the peak value P of the signal strength of the data in the detection target frequency range in each of the plurality of distance information spectra calculated by the distance spectrum calculating unit 51.

The second determining unit 52C2 compares the signal strength ratio P/FN with the fourth determination threshold TH₄ in each distance information spectrum, and calculates the number of distance information spectra in which the signal strength ratio P/FN is equal to or more than the fourth determination threshold TH₄, that is, the number of chirps C2.

The second determining unit 52C2 compares the number of chirps C2 with the third interference countermeasure threshold M3, and performs necessity determination of the interference countermeasure so as to determine that the interference countermeasure is necessary when the number of chirps C2 is equal to or less than the third interference countermeasure threshold M3, and determine that the interference countermeasure is not necessary when the number of chirps C2 is larger than the third interference countermeasure threshold M3.

The second determining unit 52C2 outputs an interference countermeasure signal for the transmission signal to the control unit 11 when it is determined that the interference countermeasure is necessary, that is, needed, and outputs a plurality of distance information spectra calculated by the distance spectrum calculating unit 51 to the distance and speed information outputting unit 53 when it is determined that the interference countermeasure is not necessary, that is, unnecessary.

As described above, since the interference countermeasure determining unit 52C includes the first determining unit 52C1 and the second determining unit 52C2, and the second determining unit 52C2 further determines the necessity of the interference countermeasure with respect to the interference countermeasure determined to be necessary by the first determining unit 52C1, it is possible to avoid unnecessary interference countermeasure processing under the conditions where the SNR of the observation target is high and the observation target can be detected by Fourier transform in the relative speed direction by the distance and speed information outputting unit 53.

Next, the operation of the radar device according to the fourth embodiment will be described.

The operation is the same as the operation of the radar device according to the first embodiment until beat data of K chirps is output from the AD converting unit 4 to the signal processing unit 5, and thus the description thereof will be omitted.

An operation of the signal processing unit 5 to which beat data of K chirps is input will be described with reference to a flowchart illustrated in FIG. 20.

FIG. 20 is a flowchart illustrating calculation processing of the distance to the observation target and the relative speed with respect to the observation target including interference determination in the signal processing unit 5.

Step ST1 of calculating the distance information spectrum, step ST2 of calculating the number of chirps C1, and step ST3 of performing the necessity determination of the first interference countermeasure are the same as steps ST1, ST2, and ST3 of the radar device according to the first embodiment.

The processing in step ST2 is performed by the first determining unit 52C1 of the interference countermeasure determining unit 52C.

In step ST3, when the first determining unit 52C1 of the interference countermeasure determining unit 52C determines that the interference countermeasure is necessary, the process proceeds to step ST7, and when it is determined that the interference countermeasure is not necessary, the process proceeds to step ST5.

Step ST7 is a step of calculating the number of chirps C2.

In step ST7, when the first determining unit 52C1 determines that the interference countermeasure is necessary, the second determining unit 52C2 acquires K distance information spectra calculated by the distance spectrum calculating unit 51 and the average value FN of the signal strength calculated by the first determining unit 52C1 from the first determining unit 52C1.

The second determining unit 52C2 calculates the peak value P of the signal strength of the data in the detection target frequency range in each of the K distance information spectra calculated by the distance spectrum calculating unit 51, and obtains the signal strength ratio P/FN of the K distance information spectra.

The second determining unit 52C2 compares the signal strength ratio P/FN with the fourth determination threshold TH4 for each of the K distance information spectra to obtain appropriateness with respect to the distance information spectrum.

The second determining unit 52C2 calculates the number of chirps C2 of inappropriate distance information spectra in which the signal strength ratio P/FN is equal to or more than the fourth determination threshold TH4.

When the second determining unit 52C2 calculates the number of chirps C2 of the distance information spectrum, the process proceeds to step ST8.

Step ST8 is a step of performing necessity determination of the second interference countermeasure.

In step ST8, the second determining unit 52C2 compares the number of chirps C2 calculated in step ST7 with the third interference countermeasure threshold M3, and performs necessity determination of the interference countermeasure so as to determine that the interference countermeasure is “necessary” when the number of chirps C2 is less than the third interference countermeasure threshold M3, and determine that the interference countermeasure is “unnecessary” when the number of chirps C2 is equal to or more than the third interference countermeasure threshold M3.

In step ST8, when the second determining unit 52C2 determines that the interference countermeasure is necessary, the process proceeds to step ST4, and the signal processing unit 5 outputs the interference countermeasure signal to the control unit 11 of the transmission signal outputting unit 1 and the process ends.

On the other hand, when the second determining unit 52C2 determines that no interference countermeasure is taken, the process proceeds to step ST5.

The operations in and after step ST5 are the same as the operations in and after step ST5 of the radar device according to the first embodiment, and the distance to the observation target and the relative speed with respect to the observation target calculated by the distance and speed information calculating unit 532 are output to the display unit 6 and the process ends.

As described above, the radar device according to the fourth embodiment has the same effects as those of the radar device according to the first embodiment, and can avoid unnecessary interference countermeasure processing under conditions where the SNR of the observation target is high and the observation target can be detected by Fourier transform in the relative speed direction.

### Fifth Embodiment

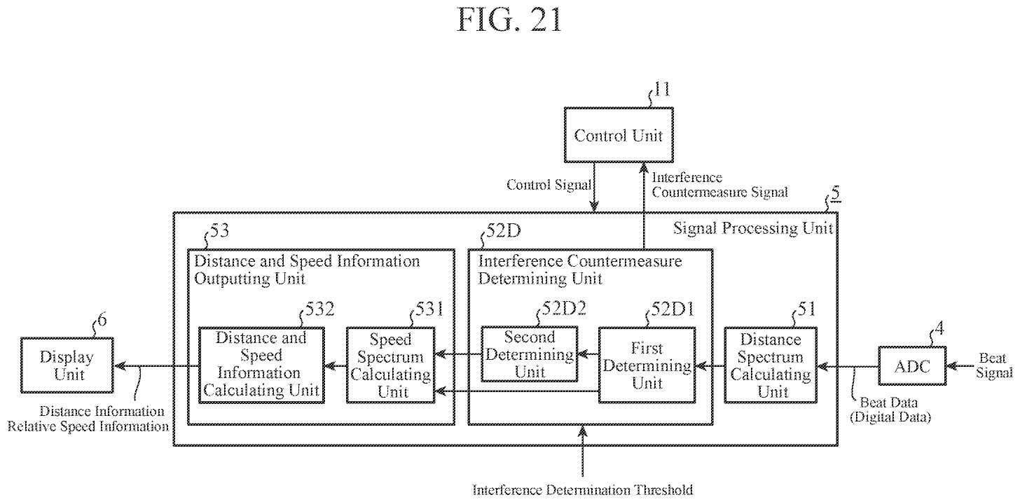

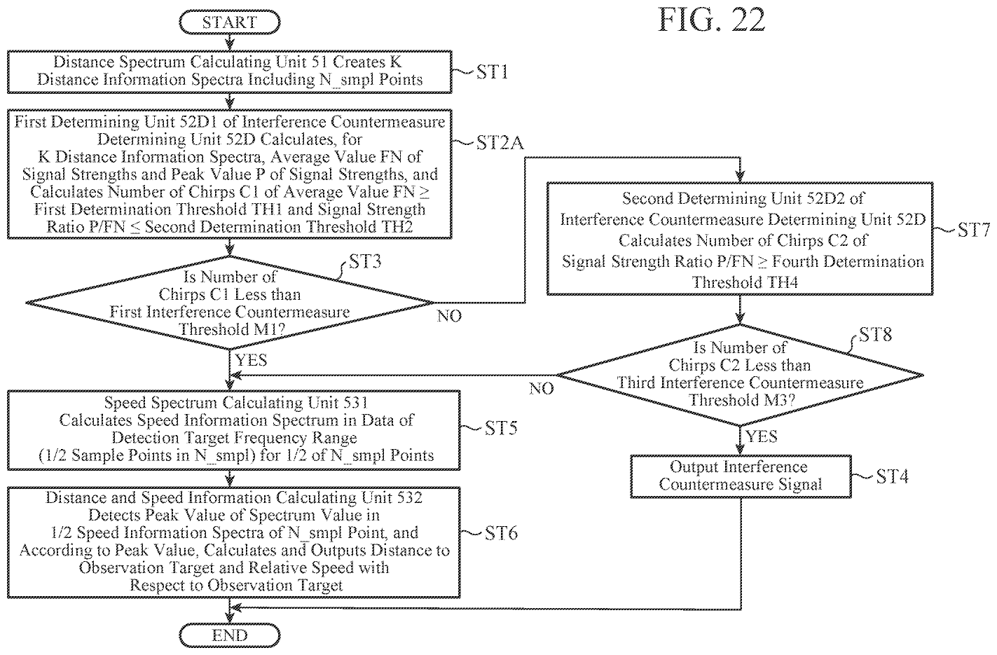

A fast chirp FMCW radar device according to a fifth embodiment will be described with reference to FIGS. 21 and 22.

In the radar device according to the fifth embodiment, only an interference countermeasure determining unit 52D of the signal processing unit 5 is different from the interference countermeasure determining unit 52A of the signal processing unit 5 in the radar device according to the second embodiment, and the other points are the same or similar.

In FIGS. 21 and 22, the same reference numerals as those attached in FIGS. 8 to 12 denote the same or corresponding parts.

In the radar device according to the second embodiment, the interference countermeasure determining unit 52A determines whether or not an interference countermeasure is necessary on the basis of the number of distance information spectra in which the average value FN of the signal strengths is equal to or more than the first determination threshold TH₁ and the signal strength ratio P/FN is equal to or less than the second determination threshold TH₂.

On the other hand, in the radar device according to the fifth embodiment, the interference countermeasure determining unit 52D performs the first determination of necessity of the interference countermeasure on the basis of the number of distance information spectra in which the average value FN of the signal strengths is equal to or more than the first determination threshold TH₁ and the signal strength ratio P/FN is equal to or less than the second determination threshold TH₂, and the second determination of necessity of the interference countermeasure on the basis of the number of distance information spectra in which the signal strength ratio P/FN is equal to or more than the fourth determination threshold TH₄ when it is determined that the interference countermeasure is necessary on the basis of the first determination.

The interference countermeasure determining unit 52D includes a first determining unit 52D1 and a second determining unit 52D2.

The first determining unit 52D1 is a determining unit equivalent to the interference countermeasure determining unit 52A of the radar device according to the second embodiment.

The second determining unit 52D2 is a determining unit equivalent to the second determining unit 52C2 of the radar device according to the fourth embodiment.

The first determination threshold TH₁, the second determination threshold TH₂, and the first interference countermeasure threshold M1 are the same values as the first determination threshold TH₁, the second determination threshold TH₂, and the first interference countermeasure threshold M1 used in the radar device according to the second embodiment.

The fourth determination threshold TH₄ and the third interference countermeasure threshold M3 are the same values as the fourth determination threshold TH₄ and the third interference countermeasure threshold M3 used in the radar device according to the fourth embodiment.

The first determining unit 52D1 acquires the data in the detection target frequency range of the plurality of distance information spectra output from the distance spectrum calculating unit 51.

The first determining unit 52D1 calculates the average value FN of respective signal strengths of the plurality of distance information spectra and the peak value P of the signal strength of the data in the detection target frequency range in each of the plurality of distance information spectra calculated by the distance spectrum calculating unit 51 from the data in the interference determination processing range in the plurality of distance information spectra calculated by the distance spectrum calculating unit 51.

The first determining unit 52D1 compares the average value FN of the signal strengths with the first determination threshold TH₁, and compares the signal strength ratio P/FN with the second determination threshold TH₂.

For each of the K distance information spectra, the first determining unit 52D1 determines whether or not the distance information spectrum is appropriate on the basis of the first determination threshold TH₁ and the second determination threshold TH₂, and calculates the number of chirps C1 of inappropriate distance information spectra.

The first determining unit 52D1 obtains the number of chirps C1 of the distance information spectrum in which the average value FN of the signal strength is equal to or more than the first determination threshold TH₁ and the signal strength ratio P/FN is equal to or less than the second determination threshold TH₂ among the K distance information spectra.

The first determining unit 52D1 compares the calculated number of chirps C1 with the distance information spectrum being “unnecessary” with the first interference countermeasure threshold M1, and performs necessity determination of the interference countermeasure so as to determine that the interference countermeasure is “unnecessary” when the number of chirps C1 is less than the first interference countermeasure threshold M1, and determine that the interference countermeasure is “necessary” when the number of chirps C1 is equal to or more than the first interference countermeasure threshold M1.

The first determining unit 52D1 outputs the calculated signal strength ratio P/FN to the second determining unit 52D2 when determining that the interference countermeasure is necessary, that is, needed, and outputs the plurality of distance information spectra calculated by the distance spectrum calculating unit 51 to the distance and speed information outputting unit 53 when determining that the interference countermeasure is not necessary, that is, unnecessary.

When the first determining unit 52D1 determines that the interference countermeasure is necessary, the second determining unit 52D2 acquires the signal strength ratio P/FN calculated by the first determining unit 52D1.

The second determining unit 52D2 compares the signal strength ratio P/FN with the fourth determination threshold TH₄ in each distance information spectrum, and calculates the number of distance information spectra in which the signal strength ratio P/FN is equal to or more than the fourth determination threshold TH₄, that is, the number of chirps C2.

The second determining unit 52D2 compares the number of chirps C2 with the third interference countermeasure threshold M3, and performs necessity determination of the interference countermeasure so as to determine that the interference countermeasure is necessary when the number of chirps C2 is equal to or less than the third interference countermeasure threshold M3, and determine that the interference countermeasure is not necessary when the number of chirps C2 is larger than the third interference countermeasure threshold M3.

The second determining unit 52D2 outputs an interference countermeasure signal for the transmission signal to the control unit 11 when it is determined that the interference countermeasure is necessary, that is, needed, and outputs a plurality of distance information spectra calculated by the distance spectrum calculating unit 51 to the distance and speed information outputting unit 53 when it is determined that the interference countermeasure is not necessary, that is, unnecessary.

As described above, since the interference countermeasure determining unit 52D includes the first determining unit 52D1 and the second determining unit 52D2, and the second determining unit 52D2 further determines the necessity of the interference countermeasure with respect to the interference countermeasure determined to be necessary by the first determining unit 52D1, it is possible to avoid unnecessary interference countermeasure processing under the conditions where the SNR of the observation target is high and the observation target can be detected by Fourier transform in the relative speed direction by the distance and speed information outputting unit 53.

Next, the operation of the radar device according to the fifth embodiment will be described.

The operation is the same as the operation of the radar device according to the first embodiment until beat data of K chirps is output from the AD converting unit 4 to the signal processing unit 5, and thus the description thereof will be omitted.

An operation of the signal processing unit 5 to which beat data of K chirps is input will be described with reference to a flowchart illustrated in FIG. 22.

FIG. 22 is a flowchart illustrating calculation processing of the distance to the observation target and the relative speed with respect to the observation target including interference determination in the signal processing unit 5.

Step ST1 of calculating the distance information spectrum, step ST2A of calculating the number of chirps C1, and step ST3 of performing the necessity determination of the first interference countermeasure are the same as steps ST1, ST2A, and ST3 of the radar device according to the second embodiment.

The processing in step ST2A is performed by the first determining unit 52D1 of the interference countermeasure determining unit 52D.

In step ST3, when the first determining unit 52D1 of the interference countermeasure determining unit 52D determines that the interference countermeasure is necessary, the process proceeds to step ST7, and when it is determined that the interference countermeasure is not necessary, the process proceeds to step ST5.

Step ST7 is a step of calculating the number of chirps C2, and as does the second determining unit 52C2 in step ST7 of the radar device according to the fourth embodiment, when the first determining unit 52D1 determines that the interference countermeasure is necessary, the second determining unit 52D2 calculates the number of chirps C2 of inappropriate distance information spectra in which the signal strength ratio P/FN acquired from the first determining unit 52D1 is equal to or more than the fourth determination threshold TH4.

When the second determining unit 52D2 calculates the number of chirps C2 of the distance information spectrum, the process proceeds to step ST8, and as does the second determining unit 52C2 in step ST8 of the radar device according to the fourth embodiment, the second determining unit 52D2 performs processing, and when it is determined that the interference countermeasure is necessary, the process proceeds to step ST4, the signal processing unit 5 outputs the interference countermeasure signal to the control unit 11 of the transmission signal outputting unit 1, and the process ends.

On the other hand, when the second determining unit 52D2 determines that the interference countermeasure is not necessary, the process proceeds to step ST5.

The operations in and after step ST5 are the same as the operations in and after step ST5 of the radar device according to the first embodiment, and the distance to the observation target and the relative speed with respect to the observation target calculated by the distance and speed information calculating unit 532 are output to the display unit 6 and the process ends.

As described above, the radar device according to the fifth embodiment has the same effects as those of the radar device according to the second embodiment, and can avoid unnecessary interference countermeasure processing under conditions where the SNR of the observation target is high and the observation target can be detected by Fourier transform in the relative speed direction.

### Sixth Embodiment

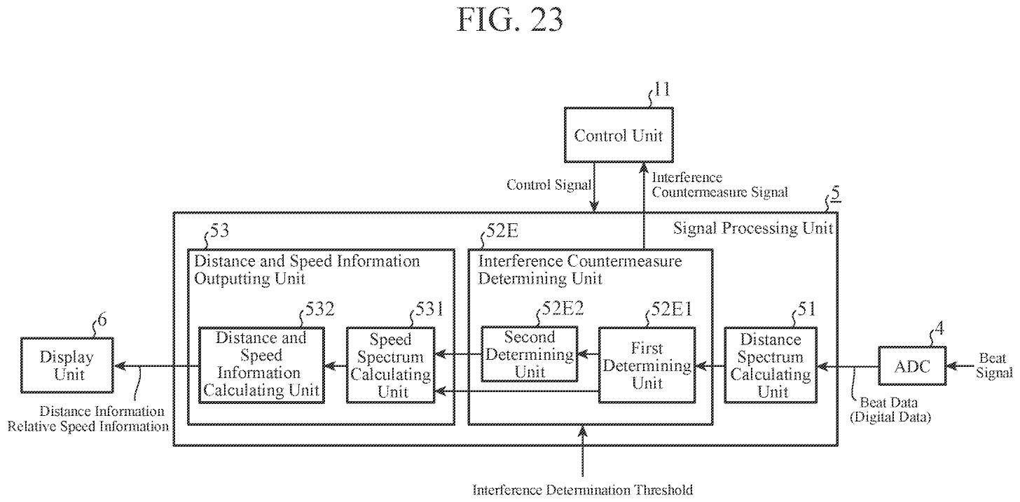

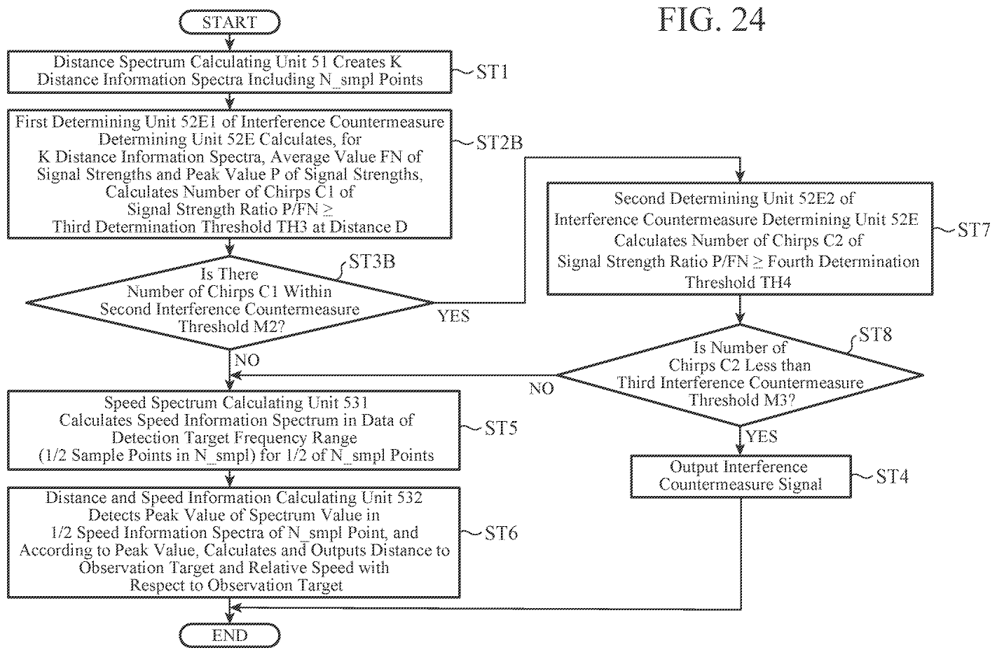

A fast chirp FMCW radar device according to a sixth embodiment will be described with reference to FIGS. 23 and 24.

In the radar device according to the sixth embodiment, only an interference countermeasure determining unit 52E of the signal processing unit 5 is different from the interference countermeasure determining unit 52B of the signal processing unit 5 in the radar device according to the third embodiment, and the other points are the same or similar.

In FIGS. 23 and 24, the same reference numerals as those attached in FIGS. 13 to 18 denote the same or corresponding parts.

In the radar device according to the third embodiment, the interference countermeasure determining unit 52B determines whether or not an interference countermeasure is necessary on the basis of the number of distance information spectra having a peak value with which the signal strength ratio P/FN at the distance D is equal to or more than the third determination threshold TH₃.

On the other hand, in the radar device according to the sixth embodiment, the interference countermeasure determining unit 52E performs the first determination of necessity of the interference countermeasure on the basis of the number of distance information spectra having a peak value with which the signal strength ratio P/FN at the distance D is equal to or more than the third determination threshold TH₃, and the second determination of necessity of the interference countermeasure on the basis of the number of distance information spectra in which the signal strength ratio P/FN is equal to or more than the fourth determination threshold TH₄ after determination of necessity of the interference countermeasure by the first determination.

The interference countermeasure determining unit 52E includes a first determining unit 52E1 and a second determining unit 52E2.

The first determining unit 52E1 is a determining unit equivalent to the interference countermeasure determining unit 52B of the radar device according to the third embodiment.

The second determining unit 52E2 is a determining unit equivalent to the second determining unit 52C2 of the radar device according to the fourth embodiment.

The third determination threshold TH₃ and the second interference countermeasure threshold M2 are the same values as the third determination threshold TH₃ and the second interference countermeasure threshold M2 used in the radar device according to the third embodiment.

The fourth determination threshold TH₄ and the third interference countermeasure threshold M3 are the same values as the fourth determination threshold TH₄ and the third interference countermeasure threshold M3 used in the radar device according to the fourth embodiment.

The first determining unit 52E1 acquires the data in the detection target frequency range of the plurality of distance information spectra output from the distance spectrum calculating unit 51.

The first determining unit 52E1 calculates the average value FN of respective signal strengths of the plurality of distance information spectra and the peak value P of the signal strength of the data in the detection target frequency range in each of the plurality of distance information spectra calculated by the distance spectrum calculating unit 51 from the data in the interference determination processing range in the plurality of distance information spectra calculated by the distance spectrum calculating unit 51.

By comparing the signal strength ratio P/FN with the third determination threshold TH₃, the first determining unit 52E1 obtains the distance D at which there is a peak value with which the signal strength ratio P/FN in the distance information spectrum is equal to or more than the third determination threshold TH₃ and the number of distance information spectra having a peak value with which the signal strength ratio P/FN is equal to or more than the third determination threshold TH₃ at the distance D, that is, the number of chirps C1.

The first determining unit 52E1 compares the number of chirps C1 in which there is a peak value with which the signal strength ratio P/FN at the distance D is equal to or more than the third determination threshold TH₃ with the second interference countermeasure threshold M2, and performs necessity determination of the interference countermeasure so as to determine that the interference countermeasure is “unnecessary” when the number of chirps C1 is out of the range of the second interference countermeasure threshold M2, and determine that the interference countermeasure is “necessary” when the number of chirps C1 is within the range of the second interference countermeasure threshold M2.

The first determining unit 52E1 outputs the calculated signal strength ratio P/FN to the second determining unit 52E2 when determining that the interference countermeasure is necessary, that is, needed, and outputs the plurality of distance information spectra calculated by the distance spectrum calculating unit 51 to the distance and speed information outputting unit 53 when determining that the interference countermeasure is not necessary, that is, unnecessary.

When the first determining unit 52E1 determines that the interference countermeasure is necessary, the second determining unit 52E2 acquires the signal strength ratio P/FN calculated by the first determining unit 52E1.

The second determining unit 52E2 compares the signal strength ratio P/FN with the fourth determination threshold TH₄ in each distance information spectrum, and calculates the number of distance information spectra in which the signal strength ratio P/FN is equal to or more than the fourth determination threshold TH₄, that is, the number of chirps C2.

The second determining unit 52E2 compares the number of chirps C2 with the third interference countermeasure threshold M3, and performs necessity determination of the interference countermeasure so as to determine that the interference countermeasure is necessary when the number of chirps C2 is equal to or less than the third interference countermeasure threshold M3, and determine that the interference countermeasure is not necessary when the number of chirps C2 is larger than the third interference countermeasure threshold M3.

The second determining unit 52E2 outputs an interference countermeasure signal for the transmission signal to the control unit 11 when it is determined that the interference countermeasure is necessary, that is, needed, and outputs a plurality of distance information spectra calculated by the distance spectrum calculating unit 51 to the distance and speed information outputting unit 53 when it is determined that the interference countermeasure is not necessary, that is, unnecessary.

As described above, since the interference countermeasure determining unit 52E includes the first determining unit 52E1 and the second determining unit 52E2, and the second determining unit 52E2 further determines the necessity of the interference countermeasure with respect to the interference countermeasure determined to be necessary by the first determining unit 52E1, it is possible to avoid unnecessary interference countermeasure processing under the conditions where the SNR of the observation target is high and the observation target can be detected by Fourier transform in the relative speed direction by the distance and speed information outputting unit 53.

Next, the operation of the radar device according to the sixth embodiment will be described.

The operation is the same as the operation of the radar device according to the first embodiment until beat data of K chirps is output from the AD converting unit 4 to the signal processing unit 5, and thus the description thereof will be omitted.

An operation of the signal processing unit 5 to which beat data of K chirps is input will be described with reference to a flowchart illustrated in FIG. 24.

FIG. 24 is a flowchart illustrating calculation processing of the distance to the observation target and the relative speed with respect to the observation target including interference determination in the signal processing unit 5.

Step ST1 of calculating the distance information spectrum, step ST2B of calculating the number of chirps C1, and step ST3B of performing the necessity determination of the first interference countermeasure are the same as steps ST1, ST2B, and ST3B of the radar device according to the third embodiment.

The processing in steps ST2B and ST3B is performed by the first determining unit 52E1 of the interference countermeasure determining unit 52E.

In step ST3B, when the first determining unit 52E1 of the interference countermeasure determining unit 52E determines that the interference countermeasure is necessary, the process proceeds to step ST7, and when it is determined that the interference countermeasure is not necessary, the process proceeds to step ST5.

Step ST7 is a step of calculating the number of chirps C2, and as does the second determining unit 52C2 in step ST7 of the radar device according to the fourth embodiment, when the first determining unit 52E1 determines that the interference countermeasure is necessary, the second determining unit 52E2 calculates the number of chirps C2 of inappropriate distance information spectra in which the signal strength ratio P/FN acquired from the first determining unit 52E1 is equal to or more than the fourth determination threshold TH4.

When the second determining unit 52E2 calculates the number of chirps C2 of the distance information spectrum, the process proceeds to step ST8, and as does the second determining unit 52C2 in step ST8 of the radar device according to the fourth embodiment, the second determining unit 52E2 performs processing, and when it is determined that the interference countermeasure is necessary, the process proceeds to step ST4, the signal processing unit 5 outputs the interference countermeasure signal to the control unit 11 of the transmission signal outputting unit 1, and the process ends.

On the other hand, when the second determining unit 52E2 determines that no interference countermeasure is taken, the process proceeds to step ST5.

The operations in and after step ST5 are the same as the operations in and after step ST5 of the radar device according to the first embodiment, and the distance to the observation target and the relative speed with respect to the observation target calculated by the distance and speed information calculating unit 532 are output to the display unit 6 and the process ends.

As described above, the radar device according to the sixth embodiment has the same effects as those of the radar device according to the third embodiment, and can avoid unnecessary interference countermeasure processing under conditions where the SNR of the observation target is high and the observation target can be detected by Fourier transform in the relative speed direction.

### Seventh Embodiment

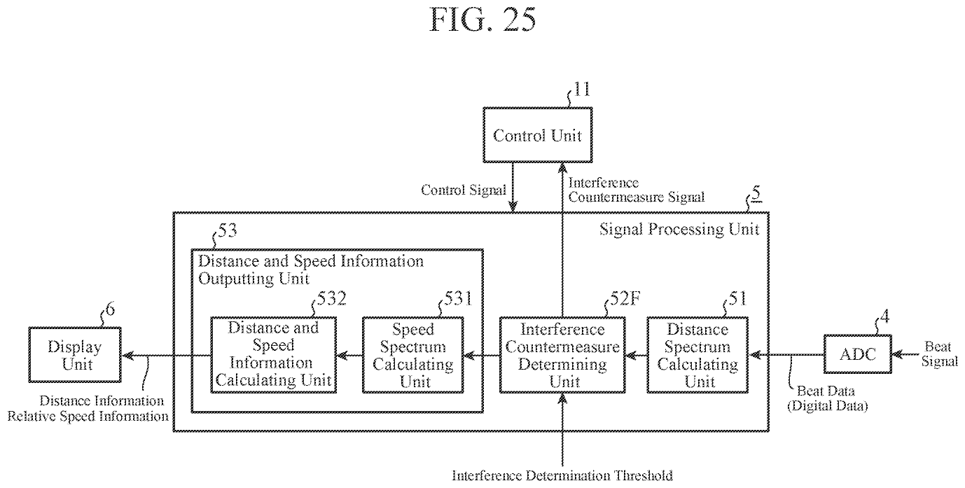

A fast chirp FMCW radar device according to a seventh embodiment will be described with reference to FIGS. 25 to 28.

In the radar device according to the seventh embodiment, only an interference countermeasure determining unit 52F of the signal processing unit 5 is different from the interference countermeasure determining unit 52B of the signal processing unit 5 in the radar device according to the third embodiment, and the other points are the same or similar.

In FIGS. 25 to 28, the same reference numerals as those attached in FIGS. 1 to 7 and FIGS. 13 to 18 denote the same or corresponding parts.

In the radar device according to the third embodiment, the state value of the distance information spectrum obtained by the interference countermeasure determining unit 52B is set as the signal strength ratio P/FN of the peak value P of the signal strength of the data in the detection target frequency range in the distance information spectrum to the average value FN of the signal strengths of the data in the interference determination processing range in the distance information spectrum.

On the other hand, in the radar device according to the seventh embodiment, the state value of the distance information spectrum obtained by the interference countermeasure determining unit 52F is set as a plurality of signal strength ratios, and the interference determination threshold is set as a fifth determination threshold TH₅.

The plurality of signal strength ratios is signal strength ratios P/FN and P2/FN of a plurality of peak values P and P2 of the signal strength of the data in the detection target frequency range in the distance information spectrum to the average value FN of the signal strengths of the data in the interference determination processing range in the distance information spectrum.

The fifth determination threshold TH₅ may be the same value as the third determination threshold TH₃ or the second determination threshold TH₂.

In the radar device according to the seventh embodiment, the plurality of peak values of the signal strength is set as the peak value P and the second peak P2 having the signal strength smaller than the peak value P, and the plurality of signal strength ratios is set as the signal strength ratio P/FN at the peak value P and the signal strength ratio P2/FN at the second peak P2.

Note that the state value is not limited to the two signal strength ratios, and a signal strength ratio at the third and subsequent peak values may be added.

In order to simplify the description, a radar device using two signal strength ratios P/FN and P2/FN as state values will be described as the radar device according to the seventh embodiment.

The radar device according to the seventh embodiment can determine necessity of highly accurate interference countermeasures with respect to the second observation target even in a case where there are two observation targets, there is one interference from another radar device, one observation target (hereinafter referred to as a first observation target) is at a shorter distance than the propagation distance of the other radar device, and another observation target (hereinafter referred to as a second observation target) is located farther than the propagation distance of the other radar device.

That is, when the first observation target is at a short distance with respect to the propagation distance of the other radar device, the peak value due to reception of the transmission wave from the other radar device is smaller than the peak value due to reception of the reflected wave from the first observation target.

Therefore, by using the signal strength ratio P/FN at the peak value P as the state value, as in the radar device according to the third embodiment, there is no erroneous determination on the necessity of the interference countermeasure with respect to the first observation target, and it is possible to determine the necessity of the highly accurate interference countermeasure with respect to the first observation target.

On the other hand, since the propagation distance of the transmission wave from the other radar device is shorter than the propagation distance of the reflected wave from the second observation target, the peak value due to reception of the transmission wave from the other radar device is larger than the peak value due to reception of the reflected wave from the second observation target, and is the second peak value.

As a result, the reception signal based on the reflected wave from the second observation target is affected by the interference signal due to the transmission wave from the other radar device.

Since the radar device according to the seventh embodiment uses the signal strength ratio P2/FN at the second peak P2 as the state value and also determines whether or not an interference countermeasure is necessary based on the second peak value, it is possible to detect the second peak value based on the interference signal due to the transmission wave from the other radar device, and thus there is no erroneous determination on the necessity of an interference countermeasure with respect to the second observation target, so that it is possible to determine the necessity of an interference countermeasure with high accuracy with respect to the second observation target.

In short, the interference countermeasure determining unit 52F of the signal processing unit 5 in the radar device according to the seventh embodiment acquires the data in the detection target frequency range of the plurality of distance information spectra output from the distance spectrum calculating unit 51.

The interference countermeasure determining unit 52F calculates the average value FN of respective signal strengths of the plurality of distance information spectra, the peak value P of the signal strength of the data in the detection target frequency range in each of the plurality of distance information spectra calculated by the distance spectrum calculating unit 51, and the second peak value P2 of the signal strength of the data in the detection target frequency range in each of the plurality of distance information spectra calculated by the distance spectrum calculating unit 51 from the data in the interference determination processing range in the plurality of distance information spectra calculated by the distance spectrum calculating unit 51.

The interference countermeasure determining unit 52F compares the signal strength ratio P/FN at the peak value P with the fifth determination threshold TH₅ and compares the signal strength ratio P2/FN at the second peak value with the fifth determination threshold TH₅ to obtain the distance D at which there is a peak value with which the signal strength ratio P/FN in the distance information spectrum is equal to or more than the fifth determination threshold TH₅ and the number of distance information spectra in which a peak value with which the signal strength ratio P/FN is equal to or more than the fifth determination threshold TH₅ exists at the distance D, and the distance D at which there is a peak value with which the signal strength ratio P2/FN in the distance information spectrum is the fifth determination threshold TH₅ and the number of distance information spectra in which a peak value with which the signal strength ratio P2/FN is equal to or more than the fifth determination threshold TH₅ exists at the distance D.

The number of distance information spectra in which a peak value with which the signal strength ratio P/FN is equal to or more than the fifth determination threshold TH₅ exists at the distance D and the number of distance information spectra in which a peak value with which the signal strength ratio P2/FN is equal to or more than the fifth determination threshold TH₅ exists at the distance D are the number of chirps C3.

Note that, although the same D is used for the distance D in the distance D at which there is a peak value with which the signal strength ratio P/FN in the distance information spectrum is equal to or more than the fifth determination threshold TH₅ and the distance D at which there is a peak value with which the signal strength ratio P2/FN in the distance information spectrum is the fifth determination threshold TH₅, the distances D are used to indicate a general distance and do not necessarily coincide with each other.

That is, the distance D at which the peak value P exists due to reception of the reflected wave from the first observation target and the distance D at which the peak value P2 exists due to reception of the transmission wave from the other radar device are generally different.

Therefore, there are a case where the number of chirps C3 is the number of distance information spectra in which a peak value with which the signal strength ratio P/FN is equal to or more than the fifth determination threshold TH₅ exists at the distance D, and a case where the number of chirps C3 is the number of distance information spectra in which a peak value with which the signal strength ratio P2/FN is equal to or more than the fifth determination threshold TH₅ exists at the distance D. It is not necessarily to express the total number of both

That is, the number of chirps C3 is in view of the number of chirps, which is the number of distance information spectra in which a peak value with which the signal strength ratio P/FN is equal to or more than the fifth determination threshold TH₅ exists at the distance D, and the number of chirps, which is the number of distance information spectra in which a peak value with which the signal strength ratio P2/FN is equal to or more than the fifth determination threshold TH₅ exists at the distance D.

In the following description, D of the distance D is a display for indicating a general distance as described above.

The interference countermeasure determining unit 52F compares the number of chirps C3 representing the number of distance information spectra in which the peak value P with which the signal strength ratio P/FN at the distance D is equal to or more than the fifth determination threshold TH₅ exists and the number of distance information spectra in which the peak value P2 with which the signal strength ratio P2/FN is equal to or more than the fifth determination threshold TH₅ exists at the distance D with a fourth interference countermeasure threshold M4. The interference countermeasure determining unit 52F performs necessity determination of the interference countermeasure so as to determine that the interference countermeasure is “unnecessary” when the number of chirps C3 is out of the range of the fourth interference countermeasure threshold M4, and determine that the interference countermeasure is determined to be “necessary” when the number of chirps C3 is within the range of the fourth interference countermeasure threshold M4.

The fourth interference countermeasure threshold M4 may be the same value as the second interference countermeasure threshold M2.

As described above, by using the number of chirp C3 representing the number of distance information spectra in which a peak value with which the signal strength ratio P/FN at the distance D is equal to or more than the fifth determination threshold TH₅ exists and the number of distance information spectra in which a peak value with which the signal strength ratio P2/FN is equal to or more than the fifth determination threshold TH₅ exists at the distance D for the necessity of the interference countermeasure, when the slope at which the frequency of the interference signal changes is the same as the slope at which the frequency of the chirp signal of the reception signal changes, and the first observation target in the two observation targets is located at a short distance from the radar device, it is possible to accurately determine whether the interference signal is superimposed on the first observation target as well as on the second observation target.

The radar device according to the third embodiment is suitable in a case where the interference signal has the same sweep time T and frequency bandwidth BW as those of the chirp signal of the reception signal, that is, in a case where the slope at which the frequency changes is the same and there is one observation target, and the radar device according to the seventh embodiment is suitable in a case where the interference signal has the same sweep time T and frequency bandwidth BW as those of the chirp signal of the reception signal, that is, in a case where the slope at which the frequency changes is the same and there are two observation targets and one of them is present at a short distance to the radar device.

Note that, even in a case where there are multiple, three or more, observation targets and one of the observation targets is present at a short distance to the radar device, the idea in the radar device according to the seventh embodiment can be applied.

Hereinafter, the radar device according to the seventh embodiment will be described focusing on an interference countermeasure determining unit 52F different from the interference countermeasure determining unit 52B in the radar device according to the third embodiment.

Description of the same configurations as those of the radar device according to the third embodiment and the radar device according to the first embodiment will be omitted as much as possible.

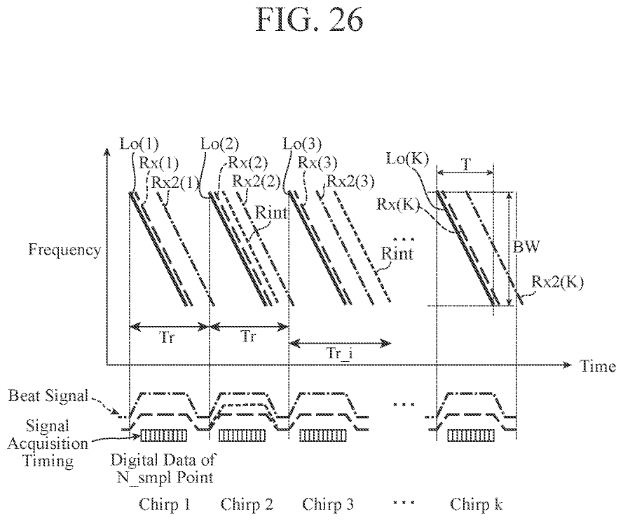

Now, as illustrated in FIG. 26, it is assumed that the interference signal Rint from another radar device having the same sweep time T and frequency bandwidth BW but different repetition time Tr_i from the repetition time Tr is received as a reception wave by the reception antenna 23 with respect to each of the chirp signals Lo(1) to Lo(K) in the transmission signal output from the transmitting and receiving unit 2, each of the chirp signals Rx(1) to Rx(K) in the reception signal of the first observation target output from the transmitting and receiving unit 2, and each of the chirp signals Rx2(1) to Rx2(K) in the reception signal of the second observation target.

When the sweep time T and the frequency bandwidth BW of the interference signal Rint are the same, a beat signal having a frequency of a difference between the frequency of the interference signal Rint and the frequency of the chirp signal in the transmission signal is generated by the frequency mixing unit 31.

On the other hand, since the repetition time Tr_i of the interference signal Rint is different from the repetition time Tr of the chirp signal in the transmission signal, the beat signal by the interference signal Rint does not occur in all chirps, and the beat signal by the interference signal Rint occurs only in some chirps.

Note that FIG. 26 illustrates an example in which the sweep time T and the frequency bandwidth BW of the chirp signal in the reception signal are the same as the sweep time T and the frequency bandwidth BW of the interference signal in order to simplify the description, but even in a case where the slope of the frequency of the chirp signal in the reception signal (the ratio of the sweep time T and the frequency bandwidth BW) and the slope of the frequency of the interference signal are the same, a peak due to the interference signal occurs and hence the interference countermeasure determining unit 52 can determine whether or not the distance information spectrum is appropriate and whether or not the interference countermeasure is necessary.

Further, in order to simplify the description, FIG. 26 illustrates an example in which there are two observation targets and there is one interference from the other radar device.

However, this is merely an example, and in a case where there are three or more observation targets, the interference countermeasure determining unit 52F can determine whether or not the distance information spectrum is appropriate and whether or not the interference countermeasure is necessary by using the third and subsequent peak values for determination.

The interference countermeasure determining unit 52F acquires the data in the detection target frequency range of the plurality of distance information spectra output from the distance spectrum calculating unit 51.

The interference countermeasure determining unit 52F calculates the average value FN of respective signal strengths of the plurality of distance information spectra, the peak value P of the signal strength of the data in the detection target frequency range in each of the plurality of distance information spectra calculated by the distance spectrum calculating unit 51, the distance D at the peak value P of the signal strength, the second peak value P2 of the signal strength of the data in the detection target frequency range in each of the plurality of distance information spectra calculated by the distance spectrum calculating unit 51, and the distance D at the second peak value P2 of the signal strength from the data in the interference determination processing range in the plurality of distance information spectra calculated by the distance spectrum calculating unit 51.

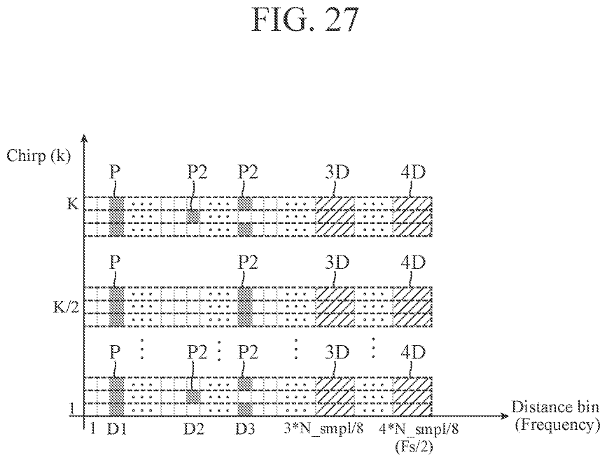

The interference determination processing range is the same as the interference determination processing range in the radar device according to the third embodiment and the interference determination processing range in the radar device according to the first embodiment, and is the latter half that is a part of the detection target frequency range, that is, the range from the region 3D to the region 4D indicated by solid hatching in FIG. 27.

Further, the peak value P of the signal strength and the second peak value P2 of the signal strength are indicated by shaded parts in FIG. 27 as an example, and the distance between the peak value P and the second peak value P2 is indicated as D1 to D3.

The peak value P existing at the distance D1 appears in K chirps as an example, the second peak value P2 existing at the distance D2 appears in two chirps as an example, and the second peak value P2 existing at the distance D3 appears in (K−2) chirps as an example.

The peak value P existing at the distance D1 indicates a peak value due to reception of a reflected wave from the first observation target located at a short distance with respect to the radar device.

The second peak value P2 existing at the distance D2 indicates the peak value due to reception of a transmission wave from the other radar device having the same sweep time T and frequency bandwidth BW but different repetition time Tr_i from the repetition time Tr.

The second peak value P2 existing at the distance D3 indicates the second peak value due to reception of the reflected wave from the second observation target having a longer propagation distance of the reflected wave to the radar device than the propagation distance of the transmission wave from the other radar device to the radar device.

The interference countermeasure determining unit 52F compares the signal strength ratio P/FN with the fifth determination threshold TH₅ to obtain the peak value P in the detection target frequency range of the distance information spectrum and the distance D where the peak value P exists. In this example, the distance D is the distance D1 illustrated in FIG. 27.

The interference countermeasure determining unit 52F compares the signal strength ratio P2/FN with the fifth determination threshold TH₅ to obtain the second peak value P2 in the detection target frequency range of the distance information spectrum and the distance D where the second peak value P2 exists. In this example, the distance D is the distances D2 and D3 illustrated in FIG. 27.

In a case where the transmission wave from the other radar device is not received and there is no interference signal, only the peak value P due to reception of the reflected wave from the first observation target and the peak value P2 due to reception of the reflected wave from the second observation target are calculated by the interference countermeasure determining unit 52F.

However, in a case where there is an interference signal by the other radar device, in addition to the peak value P and the peak value P2 due to reception of the respective reflected waves from the first observation target and the second observation target, the peak value P2 due to reception of the transmission wave from the other radar device is calculated by the interference countermeasure determining unit 52F.

The peak value P due to reception of the reflected wave from the first observation target at a short distance to the radar device is larger than the peak value P2 due to reception of the transmission wave from the other radar device.

On the other hand, the peak value P2 due to reception of the transmission wave from the other radar device having a shorter propagation distance of the transmission wave to the radar device than the propagation distance of the reflected wave from the second observation target to the radar device is larger than the peak value due to reception of the reflected wave from the second observation target, and is the second peak P2.

Therefore, when the signal strength ratio P2/FN is equal to or more than the fifth determination threshold TH₅, the second peak value can be calculated even in a case where there is an observation target at a short distance, and in a case where there is an interference signal by the other radar device, the second peak value appearing in the distance information spectrum appears at a distance due to reception of the transmission wave from the other radar device.

In a case where neither of the two observation targets is at a short distance with respect to the radar device, that is, in a case where the propagation distances of the reflected waves from the two observation targets to the radar device are longer than the propagation distance of the transmission wave from the other radar device to the radar device, the peak value due to reception of the transmission wave from the other radar device becomes larger than the peak value due to reception of the reflected wave from each of the two observation targets, and appears as the first peak value P in the distance due to reception of the transmission wave from the other radar device.

Further, the influence of reception of the transmission wave from the other radar device does not appear in the distance information spectra of all the chirps, but the influence of reception of the transmission wave from the other radar device appears in the distance information spectra of some chirps.

Therefore, when the number of chirps C3 in which the second peak value appears is within the range of the fourth interference countermeasure threshold M4, it can be determined that there is an interference signal due to reception of the transmission wave from the other radar device.

In the example illustrated in FIG. 27, the peak value P existing at the distance D1 appears in K chirps, the second peak value P2 existing at the distance D2 appears in two chirps, and the second peak value P2 existing at the distance D3 appears in (K−2) chirps.

For example, when the fourth interference countermeasure threshold M4 is in the range of 1 to 10, the peak value P existing at the distance D2 appears in two chirps, so that it can be determined that the transmission wave from the other radar device is received.

Therefore, the interference countermeasure determining unit 52F performs necessity determination of the interference countermeasure so as to determine that the interference countermeasure is “necessary” when the number of distance information spectra of which the signal strength ratio P/FN is compared with the fifth determination threshold TH₅ in each distance information spectrum and the signal strength ratio P/FN is equal to or more than the fifth determination threshold TH₅ at the same distance D1, and the number of distance information spectra of which the signal strength ratio P2/FN is compared with the fifth determination threshold TH₅ in each distance information spectrum and the signal strength ratio P2/FN is equal to or more than the fifth determination threshold TH₅ at the same distance D2, that is, the number of chirps C3 is within the range of the fourth interference countermeasure threshold M4.

Further, at the same distance D, when the number of chirps C3 representing the number of chirps in which the signal strength ratio P/FN is equal to or more than the fifth determination threshold TH₅ and the number of chirps in which the signal strength ratio P2/FN is equal to or more than the fifth determination threshold TH₅ are out of the range of the fourth interference countermeasure threshold M4, that is, when the number of chirps C3 is zero, it can be determined that no transmission wave from the other radar device has been received at the distance D, and when the number of chirps C3 exceeds 10, it can be determined that a peak value due to reception of the reflected wave from the observation target appears at the distance D.

That is, in a case where the transmission wave from the other radar device is not received, for example, in the example illustrated in FIG. 27, if the peak value P existing at the distance D1 appears in the K chirps, the second peak value P2 existing at the distance D3 appears in the (K−2) chirps, and the peak value P and the second peak value P2 do not exist at other distances D, it can be determined that the peak value P due to reception of the reflected wave from the first observation target appears at the distance D1, the peak value P2 due to reception of the reflected wave from the second observation target appears at the distance D3, and the transmission wave from the other radar device is not received.

Therefore, if there is the number of chirps C3 representing the number of chirps in which the signal strength ratio P/FN is equal to or more than the fifth determination threshold TH₅ and the number of chirps in which the signal strength ratio P2/FN is equal to or more than the fifth determination threshold TH₅ within the range of the fourth interference countermeasure threshold M4 at the same distance D, the interference countermeasure determining unit 52F determines that the interference countermeasure is “necessary” and outputs an interference countermeasure signal for the transmission signal to the control unit 11.

When there is no number of chirps C3 representing the number of chirps in which the signal strength ratio P/FN is equal to or more than the fifth determination threshold TH₅ at the same distance D and the number of chirps in which the signal strength ratio P2/FN is equal to or more than the fifth determination threshold TH₅ at the same distance D within the range of the fourth interference countermeasure threshold M4, the interference countermeasure determining unit 52F determines that no transmission wave from the other radar device has been received, determines that the interference countermeasure is “unnecessary”, and outputs a plurality of distance information spectra calculated by the distance spectrum calculating unit 51 to the distance and speed information outputting unit 53.

As described above, by using the average value FN of the signal strength of the data in the interference determination processing range in the distance information spectrum, the signal strength ratio P/FN based on the peak value P in the detection target frequency range in the distance information spectrum, and the signal strength ratio P2/FN based on the second peak value P2 in the detection target frequency range in the distance information spectrum, and determining that the interference countermeasure is necessary when the number of chirps C3 representing the number of chirps in which the signal strength ratio P/FN at the same distance D is equal to or more than the fifth determination threshold TH₅ and the number of chirps in which the signal strength ratio P2/FN at the same distance D is equal to or more than the fifth determination threshold TH₅ is within the fourth interference countermeasure threshold M4, it is possible to suppress deterioration in accuracy of the necessity determination of the interference countermeasure even if there are two observation targets, the first observation target exists at a short distance from the radar device, and an interference signal due to a transmission wave is input to the frequency mixing unit 31 via the reception antenna 23 from the other radar device having the same sweep time T and frequency bandwidth BW but different repetition time Tr_i from the repetition time Tr of the transmission signal.

Next, the operation of the radar device according to the seventh embodiment will be described.

The operation is the same as the operation of the radar device according to the third embodiment, that is, the operation of the radar device according to the first embodiment until beat data of K chirps is output from the AD converting unit 4 to the signal processing unit 5, and thus the description thereof will be omitted.

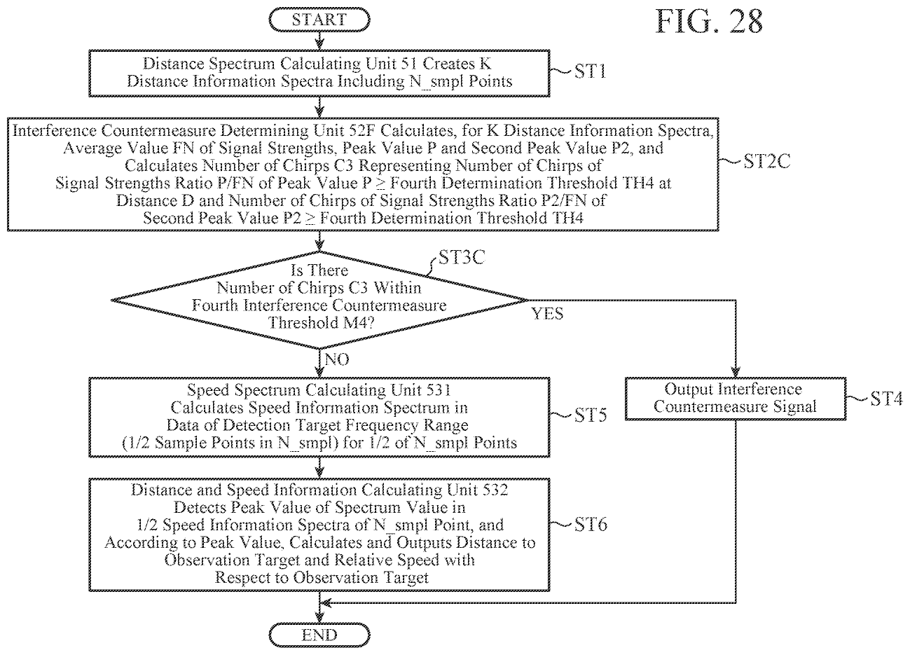

An operation of the signal processing unit 5 to which beat data of K chirps is input will be described with reference to a flowchart illustrated in FIG. 28.

FIG. 28 is a flowchart illustrating calculation processing of the distance to the observation target and the relative speed with respect to the observation target including interference determination in the signal processing unit 5.

Step ST1 of calculating the distance information spectrum is the same as step ST1 of the radar device according to the third embodiment, that is, step ST1 of the radar device according to the first embodiment.

Step ST2C is a step of calculating the number of chirps C3, and is a step corresponding to step ST2B of the radar device according to the third embodiment.

In step ST2C, the interference countermeasure determining unit 52F acquires data in the detection target frequency range of the K distance information spectra obtained in step ST1.

For each of the K distance information spectra, the interference countermeasure determining unit 52F detects the peak value P of the data in the detection target frequency range, calculates the signal strength ratio P/FN, which is one of the state values, and obtains the signal strength ratios P/FN of the K distance information spectra.

For each of the K distance information spectra, the interference countermeasure determining unit 52F detects the second peak value P2 of the data in the detection target frequency range, calculates the signal strength ratio P2/FN to the second peak value P2 that is one of the state values, and obtains the signal strength ratio P2/FN of the K distance information spectra.

The interference countermeasure determining unit 52B associates the signal strength ratio P/FN of the K distance information spectra with the distance D, and associates the signal strength ratio P2/FN of the K distance information spectra with the distance D.

The interference countermeasure determining unit 52F calculates the number of chirps in which the signal strength ratio P/FN associated with the distance D is equal to or more than the fifth determination threshold TH₅, and calculates the number of chirps in which the signal strength ratio P2/FN associated with the distance D is equal to or more than the fifth determination threshold TH₅, thereby calculating the number of chirps C3 representing both the numbers of chirps.

When the interference countermeasure determining unit 52F calculates the number of chirps C3 associated with the distance D, the process proceeds to step ST3C.

Step ST3C is a step of performing the necessity determination of the interference countermeasure, and is a step corresponding to step ST3B of the radar device according to the third embodiment.

In step ST3C, the interference countermeasure determining unit 52F compares the number of chirps C3 associated with the distance D calculated in step ST2C by the interference countermeasure determining unit 52F with the fourth interference countermeasure threshold M4, and performs necessity determination of the interference countermeasure so as to determine that the interference countermeasure is necessary if the number of chirps C3 is within the range of the fourth interference countermeasure threshold M4, and determine that the interference countermeasure is “unnecessary” if there is no chirp C3 within the range of the fourth interference countermeasure threshold M4.

In step ST3C, when the interference countermeasure determining unit 52F determines that the interference countermeasure is necessary, the process proceeds to step ST4, and the signal processing unit 5 outputs an interference countermeasure signal to the control unit 11 of the transmission signal outputting unit 1 and the process ends.

On the other hand, when the interference countermeasure determining unit 52F determines that no interference countermeasure is present, the process proceeds to step ST5.

The operations in and after step ST5 are the same as the operations in and after step ST5 of the radar device according to the third embodiment, that is, the operations in and after step ST5 of the radar device according to the first embodiment, and the distance to the observation target and the relative speed with respect to the observation target calculated by the distance and speed information calculating unit 532 are output to the display unit 6 and the process ends.

As described above, in the radar device according to the seventh embodiment, since the interference countermeasure determining unit 52F determines whether or not an interference countermeasure is necessary depending on whether or not the number of chirps C3 representing the number of chirps in which the signal strength ratio P/FN at the same distance is equal to or more than the fifth determination threshold TH₅ and the number of chirps in which the signal strength ratio P2/FN at the same distance D is equal to or more than the fifth determination threshold TH₅ exists within the range of the fourth interference countermeasure threshold M4, even if there are two observation targets, the first observation target exists at a short distance from the radar device, and an interference signal due to a transmission wave is input to the frequency mixing unit 31 via the reception antenna 23 from the other radar device having the same sweep time T and frequency bandwidth BW but different repetition time Tr_i from the repetition time Tr of the transmission signal, it is possible to determine necessity of an interference countermeasure with high accuracy in the radar device of the fast chirp FMCW system using a plurality of chirps.

### Eighth Embodiment

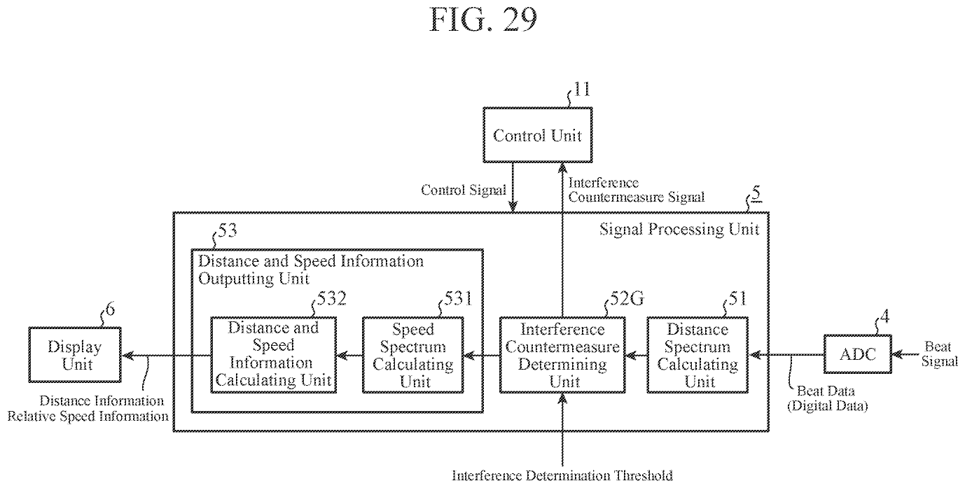

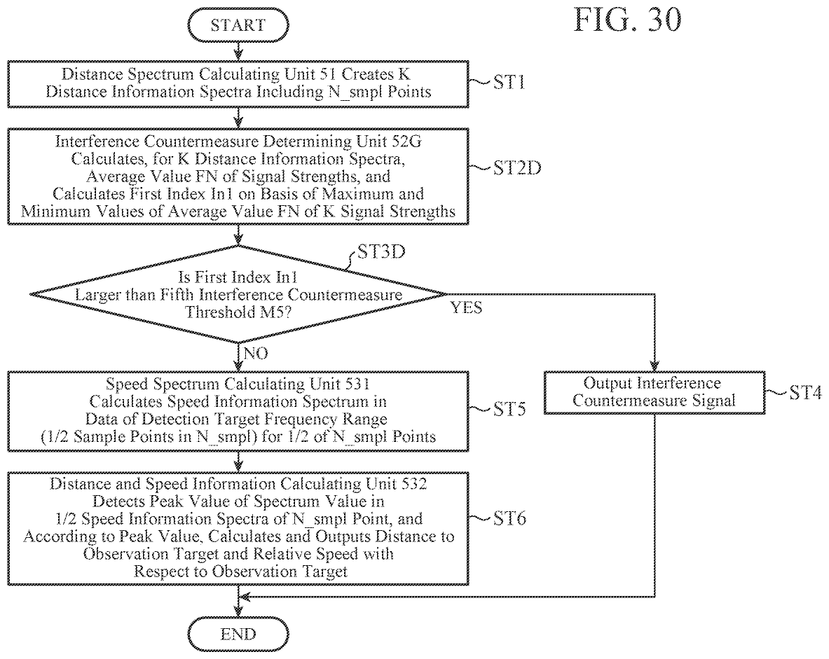

A fast chirp FMCW radar device according to an eighth embodiment will be described with reference to FIGS. 29 and 30.

In the radar device according to the eighth embodiment, only an interference countermeasure determining unit 52G of the signal processing unit 5 is different from the interference countermeasure determining unit 52 of the signal processing unit 5 in the radar device according to the first embodiment, and the other points are the same or similar.

In FIGS. 29 and 30, the same reference numerals as those attached in FIGS. 1 to 7 denote the same or corresponding parts.

The radar device according to the first embodiment sets the state value of the distance information spectrum obtained by the interference countermeasure determining unit 52 as the average value FN of the signal strengths of the data in the interference determination processing range in the distance information spectrum, calculates the number of chirps C1, which is the number of distance information spectra in which the average value FN of the signal strengths is equal to or more than the first determination threshold TH₁, and compares the number of chirps C1 with the first interference countermeasure threshold M1 to determine whether or not an interference countermeasure is necessary.

On the other hand, in the radar device according to the eighth embodiment, the state value of the distance information spectrum obtained by the interference countermeasure determining unit 52G is set as the average value FN of the signal strengths of the data in the interference determination processing range in the distance information spectrum, and the interference countermeasure determining unit 52G calculates the first index In1 on the basis of all chirps of the average value FN of the signal strengths, which are state values of each of the plurality of distance information spectra obtained by the interference countermeasure determining unit 52G, in this example, the maximum value and the minimum value among the K, and determines necessity of the interference countermeasure by comparing the first index In1 with the fifth interference countermeasure threshold M5 that is the interference countermeasure threshold.

The first index In1 is a value obtained by dividing the difference between the maximum value FNmax and the minimum value FNmin in the average value FN of the signal strengths, which are state values of each of the plurality of distance information spectra, by the sum of the maximum value FNmax and the minimum value FNmin, that is, a value calculated by the following equation (3).

In1=(FNmax−FNmin)/(FNmax+FNmin) (3)

Note that, in the above equation (3), FNmax represents the maximum value in all chirps of the calculated average value FN of the signal strength, and FNmin represents the minimum value in all chirps of the calculated average value FN of the signal strength.

Further, the fifth interference countermeasure threshold M5 is a value more than 0 and less than 1, and is set to a value as close to 0 as possible.

That is, the interference countermeasure determining unit 52G of the signal processing unit 5 in the radar device according to the eighth embodiment calculates the average value FN of respective signal strengths of the plurality of distance information spectra from the data in the interference determination processing range in the plurality of distance information spectra calculated by the distance spectrum calculating unit 51.

The interference countermeasure determining unit 52G calculates the first index In1 by the above equation (3) based on the maximum value and the minimum value of the average value FN of respective signal strengths of the plurality of distance information spectra calculated.

The interference countermeasure determining unit 52G compares the first index In1 with the fifth interference countermeasure threshold M5, and performs necessity determination of the interference countermeasure so as to determine that the interference countermeasure is not necessary when the first index In1 is equal to or less than the fifth interference countermeasure threshold M5, and determine that the interference countermeasure is necessary when the first index In1 is larger than the fifth interference countermeasure threshold M5.

As described above, in the radar device according to the eighth embodiment, it is possible to perform the necessity determination of the interference countermeasure by using the average value FN of respective signal strengths of the plurality of distance information spectra and the maximum value and the minimum value of the average value FN of the plurality of signal strengths, and thus it is possible to more easily perform the necessity determination of the interference countermeasure with high accuracy.

Hereinafter, the radar device according to the eighth embodiment will be described focusing on the interference countermeasure determining unit 52G different from the interference countermeasure determining unit 52 in the radar device according to the first embodiment.

Description of the same configuration as that of the radar device according to the first embodiment will be omitted as much as possible.

The interference countermeasure determining unit 52G acquires data in a detection target frequency range of a plurality of, in this example, K distance information spectra output from the distance spectrum calculating unit 51.

The interference countermeasure determining unit 52G calculates the average value FN of respective signal strengths of the plurality of distance information spectra from the data in the interference determination processing range in the plurality of distance information spectra calculated by the distance spectrum calculating unit 51.

The interference determination processing range is the same as the interference determination processing range in the radar device according to the first embodiment, and is the latter half that is a part of the detection target frequency range, which is a range from 3D to a region 4D indicated by solid hatching in FIG. 4.

The interference countermeasure determining unit 52G calculates the first index In1 from the average value FN of the signal strengths by using the above equation (3).

The interference countermeasure determining unit 52G compares the first index In1 with the fifth interference countermeasure threshold M5, and performs necessity determination of the interference countermeasure so as to determine that the interference countermeasure is “unnecessary” when the first index In1 is equal to or less than the fifth interference countermeasure threshold M5, and determine that the interference countermeasure is “necessary” when the first index In1 is larger than the fifth interference countermeasure threshold M5.

When there is no interference due to the transmission wave from another radar device, the first index In1 is close to 0 because the maximum value FNmax and the minimum value FNmin in the average value FN of the signal strengths of the K distance information spectra indicate values close to each other, and when there is interference due to the transmission wave from the other radar device, the first index In1 is close to 1 because the difference between the maximum value FNmax and the minimum value FNmin in the average value FN of the signal strengths is large.

Since the fifth interference countermeasure threshold M5 is a value more than 0 and less than 1, when the first index In1 is equal to or less than the fifth interference countermeasure threshold M5, it can be determined that there is no interference due to transmission waves from other radar devices, and the interference countermeasure determining unit 52G determines that the interference countermeasure is “unnecessary”.

Further, when the first index In1 is larger than the fifth interference countermeasure threshold M5, it can be determined that there is interference due to transmission waves from other radar devices, and the interference countermeasure determining unit 52G determines that the interference countermeasure is “necessary”.

The interference countermeasure determining unit 52G outputs an interference countermeasure signal for the transmission signal to the control unit 11 when it is determined that the interference countermeasure is necessary, that is, needed, and outputs a plurality of distance information spectra calculated by the distance spectrum calculating unit 51 to the distance and speed information outputting unit 53 when it is determined that the interference countermeasure is not necessary, that is, unnecessary.

Next, the operation of the radar device according to the eighth embodiment will be described.

The operation is the same as the operation of the radar device according to the first embodiment until beat data of K chirps is output from the AD converting unit 4 to the signal processing unit 5, and thus the description thereof will be omitted.

An operation of the signal processing unit 5 to which beat data of K chirps is input will be described with reference to a flowchart illustrated in FIG. 30.

FIG. 30 is a flowchart illustrating calculation processing of the distance to the observation target and the relative speed with respect to the observation target including interference determination in the signal processing unit 5.

Step ST1 of calculating the distance information spectrum is the same as step ST1 of the radar device according to the first embodiment.

Step ST2D is a step of calculating the first index In1, and is a step corresponding to step ST2 of the radar device according to the first embodiment.

In step ST2D, the interference countermeasure determining unit 52G acquires data in the detection target frequency range of the K distance information spectra obtained in step ST1.

For each of the K distance information spectra, the interference countermeasure determining unit 52G calculates the average value FN of the signal strengths, which are one of the state values, from the data in the interference determination processing range among the data in the detection target frequency range, and obtains an average value FN of the signal strengths of the K distance information spectra.

The interference countermeasure determining unit 52G calculates the first index In1 from the above equation (3) using the maximum value FNmax and the minimum value FNmin of the average value FN of the signal strengths of the K distance information spectra.

Step ST3D is a step of performing the necessity determination of the interference countermeasure, and is a step corresponding to step ST3 of the radar device according to the first embodiment.

In step ST3D, the interference countermeasure determining unit 52 compares the first index In1 calculated in step ST2D with the fifth interference countermeasure threshold M5, and performs necessity determination of the interference countermeasure so as to determine that the interference countermeasure is “unnecessary” when the first index In1 is equal to or less than the fifth interference countermeasure threshold M5, and determine that the interference countermeasure is “necessary” when the first index In1 is larger than the fifth interference countermeasure threshold M5.

The operations in and after step ST3D are the same as the operations in and after step ST3 of the radar device according to the first embodiment, and when the interference countermeasure determining unit 52G determines that the interference countermeasure is necessary in step ST3D, the process proceeds to step ST4, and the signal processing unit 5 outputs an interference countermeasure signal to the control unit 11 of the transmission signal outputting unit 1 and the process ends.

Further, when the interference countermeasure determining unit 52G determines in step ST3D that the interference countermeasure is unnecessary, the process proceeds to steps ST5 and ST6, and the distance to the observation target and the relative speed with respect to the observation target calculated by the distance and speed information calculating unit 532 are output to the display unit 6, and the process ends.

As described above, the radar device according to the eighth embodiment has an effect similar to that of the radar device according to the first embodiment, and can perform necessity determination of the interference countermeasure by using the average value FN of respective signal strengths of the plurality of distance information spectra and the maximum value and the minimum value of the average value FN of the plurality of signal strengths, and therefore, the radar device of the fast chirp FMCW scheme using the plurality of chirps can more easily determine the necessity of the interference countermeasure with high accuracy.

### Ninth Embodiment

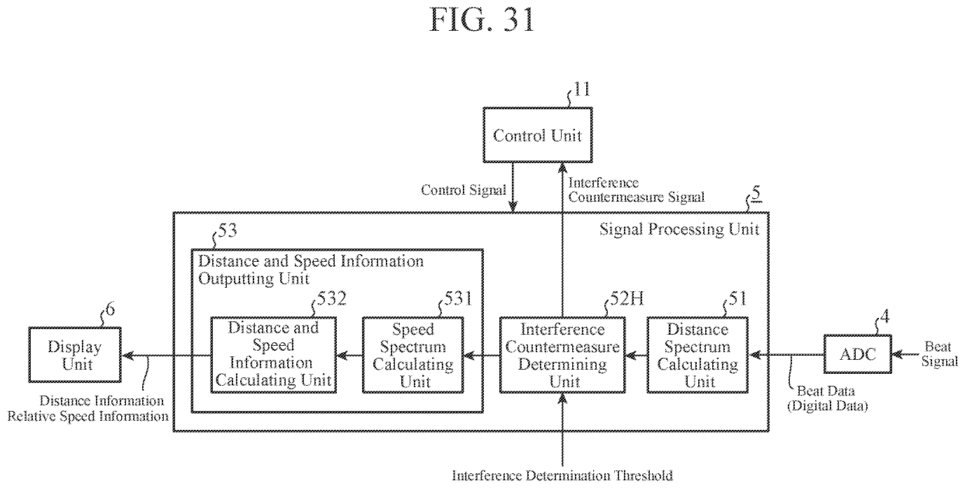

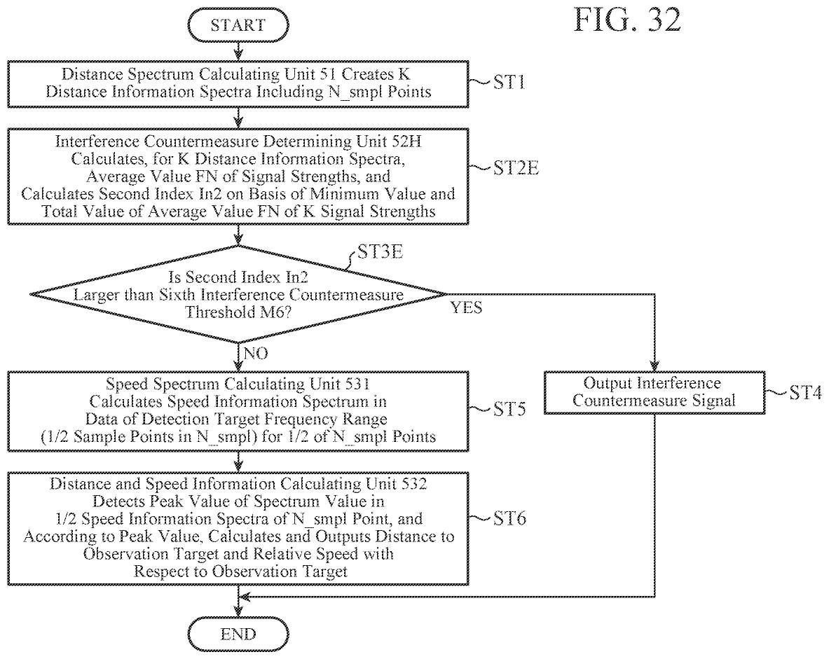

A fast chirp FMCW radar device according to a ninth embodiment will be described with reference to FIGS. 31 and 32.

In the radar device according to the ninth embodiment, only an interference countermeasure determining unit 52H of the signal processing unit 5 is different from the interference countermeasure determining unit 52 of the signal processing unit 5 in the radar device according to the first embodiment, and the other points are the same or similar.

In FIGS. 31 and 32, the same reference numerals as those attached in FIGS. 1 to 7 denote the same or corresponding parts.

The radar device according to the first embodiment sets the state value of the distance information spectrum obtained by the interference countermeasure determining unit 52 as the average value FN of the signal strengths of the data in the interference determination processing range in the distance information spectrum, calculates the number of chirps C1, which is the number of distance information spectra in which the average value FN of the signal strengths is equal to or more than the first determination threshold TH₁, and compares the number of chirps C1 with the first interference countermeasure threshold M1 to determine whether or not an interference countermeasure is necessary.

On the other hand, in the radar device according to the ninth embodiment, the state value of the distance information spectrum obtained by the interference countermeasure determining unit 52H is set as the average value FN of the signal strengths of the data in the interference determination processing range in the distance information spectrum, and the interference countermeasure determining unit 52G calculates the second index In2 on the basis of all chirps of the average value FN of the signal strengths, which are state values of each of the plurality of distance information spectra obtained by the interference countermeasure determining unit 52G, in this example, all chirps of the minimum value among K chirps and the average value FN of the signal strengths, in this example, the sum of the K values (hereinafter referred to as a total value), and compares the second index In2 with the sixth interference countermeasure threshold M6, which is the interference countermeasure threshold, to determine whether or not the interference countermeasure is necessary.

The second index In2 is a value obtained by dividing the total value of the average values FN of the signal strengths, which are state values of the plurality of distance information spectra, by a multiplication value obtained by multiplying the minimum value of the average values FN of the signal strengths, which are state values of the plurality of distance information spectra, by the number of the plurality of distance information spectra, that is, K which is the number of all chirps in this example, that is, a value calculated by the following equation (4).

In2=(FNtotal)/(K×FNmin) (4)

Note that, in the above equation (4), FNmin is a minimum value in all chirps of the calculated average value FN of the signal strength, FNtotal is all chirps of the calculated average value FN of the signal strength, in this example, a total value of K chirps, and K is the number of all chirps, that is, the number of a plurality of distance information spectra, and is the number of chirp signals.

Further, the sixth interference countermeasure threshold M6 is a value larger than 1, and is set to a value slightly larger than 1 in consideration of a multiplication value (K×FNmin) in a case where there is no interference due to a transmission wave from the other radar device.

That is, the interference countermeasure determining unit 52H of the signal processing unit 5 in the radar device according to the ninth embodiment calculates the average value FN of respective signal strengths of the plurality of distance information spectra from the data in the interference determination processing range in the plurality of distance information spectra calculated by the distance spectrum calculating unit 51.

The interference countermeasure determining unit 52H calculates the second index In2 by the above equation (4) on the basis of the minimum value and the total value of the average values FN of respective signal strengths of the plurality of distance information spectra calculated.

The interference countermeasure determining unit 52H compares the second index In2 with the sixth interference countermeasure threshold M6, and performs necessity determination of the interference countermeasure so as to determine that the interference countermeasure is not necessary when the second index In2 is equal to or less than the sixth interference countermeasure threshold M6, and determine that the interference countermeasure is necessary when the second index In2 is larger than the sixth interference countermeasure threshold M6.

As described above, in the radar device according to the ninth embodiment, it is possible to perform the necessity determination of the interference countermeasure by using the average value FN of respective signal strengths of the plurality of distance information spectra and the minimum value and the total value of the average value FN of the plurality of signal strengths, and thus it is possible to more easily perform the necessity determination of the interference countermeasure with high accuracy.

Hereinafter, the radar device according to the ninth embodiment will be described focusing on an interference countermeasure determining unit 52H different from the interference countermeasure determining unit 52 in the radar device according to the first embodiment.

Description of the same configuration as that of the radar device according to the first embodiment will be omitted as much as possible.

The interference countermeasure determining unit 52H acquires data in a detection target frequency range of a plurality of, in this example, K distance information spectra output from the distance spectrum calculating unit 51.

The interference countermeasure determining unit 52H calculates the average value FN of respective signal strengths of the plurality of distance information spectra from the data in the interference determination processing range in the plurality of distance information spectra calculated by the distance spectrum calculating unit 51.

The interference determination processing range is the same as the interference determination processing range in the radar device according to the first embodiment, and is the latter half that is a part of the detection target frequency range, which is a range from 3D to a region 4D indicated by solid hatching in FIG. 4.

The interference countermeasure determining unit 52H calculates the second index In2 from the average value FN of the signal strengths by using the above equation (4).

The interference countermeasure determining unit 52H compares the second index In2 with the sixth interference countermeasure threshold M6, and performs necessity determination of the interference countermeasure so as to determine that the interference countermeasure is “unnecessary” when the second index In2 is equal to or less than the sixth interference countermeasure threshold M6, and determine that the interference countermeasure is “necessary” when the second index In2 is larger than the sixth interference countermeasure threshold M6.

In a case where there is no interference due to a transmission wave from the other radar device, the second index In2 is very close to 1 because the total value FNtotal of the average values FN of the signal strengths of the K distance information spectra is close to a multiplication value obtained by multiplying the minimum value FNmin of the average values FN of the signal strengths of the K distance information spectra by the number K of chirp signals.

Further, when there is interference due to a transmission wave from the other radar device, the second index In2 becomes a value larger than 1 since the total value FNtotal of the average values FN of the signal strengths is larger than the multiplied value of the minimum value FNmin of the average values FN of the signal strengths.

On the basis of the above points, the sixth interference countermeasure threshold M6 is set to a value slightly more than 1 with (FNtotal)/(K×FNmin) when there is no interference due to a transmission wave from the other radar device as a lower limit and (FNtotal)/(K×FNmin) when there is interference due to a transmission wave from the other radar device as an upper limit.

Therefore, when the second index In2 is equal to or less than the sixth interference countermeasure threshold M6, it can be determined that there is no interference due to the transmission wave from the other radar device, and the interference countermeasure determining unit 52H determines that the interference countermeasure is “unnecessary”.

Further, when the second index In2 is larger than the sixth interference countermeasure threshold M6, it can be determined that there is interference due to transmission waves from other radar devices, and the interference countermeasure determining unit 52H determines that interference countermeasures are “necessary”.

The interference countermeasure determining unit 52H outputs an interference countermeasure signal for the transmission signal to the control unit 11 when it is determined that the interference countermeasure is necessary, that is, needed, and outputs a plurality of distance information spectra calculated by the distance spectrum calculating unit 51 to the distance and speed information outputting unit 53 when it is determined that the interference countermeasure is not necessary, that is, unnecessary.

Next, the operation of the radar device according to the ninth embodiment will be described.

The operation is the same as the operation of the radar device according to the first embodiment until beat data of K chirps is output from the AD converting unit 4 to the signal processing unit 5, and thus the description thereof will be omitted.

An operation of the signal processing unit 5 to which beat data of K chirps is input will be described with reference to a flowchart illustrated in FIG. 32.

FIG. 32 is a flowchart illustrating calculation processing of the distance to the observation target and the relative speed with respect to the observation target including interference determination in the signal processing unit 5.

Step ST1 of calculating the distance information spectrum is the same as step ST1 of the radar device according to the first embodiment.

Step ST2E is a step of calculating the second index In2, and is a step corresponding to step ST2 of the radar device according to the first embodiment.

In step ST2E, the interference countermeasure determining unit 52H acquires data in the detection target frequency range of the K distance information spectra obtained in step ST1.

For each of the K distance information spectra, the interference countermeasure determining unit 52H calculates the average value FN of the signal strengths, which are one of the state values, from the data in the interference determination processing range among the data in the detection target frequency range, and obtains an average value FN of the signal strengths of the K distance information spectra.

The interference countermeasure determining unit 52H calculates the second index In2 from the above equation (4) using the minimum value FNmin and the total value FNtotal of the average values FN of the signal strengths of the K distance information spectra.

Step ST3E includes a step of performing necessity determination of an interference countermeasure, and is a step corresponding to step ST3 of the radar device according to the first embodiment.

In step ST3E, the interference countermeasure determining unit 52H compares the second index In2 calculated in step ST2E with the sixth interference countermeasure threshold M6, and performs necessity determination of the interference countermeasure so as to determine that the interference countermeasure is “unnecessary” when the second index In2 is equal to or less than the sixth interference countermeasure threshold M6, and determine that the interference countermeasure is “necessary” when the second index In2 is larger than the sixth interference countermeasure threshold M6.

The operations in and after step ST3E are the same as the operations in and after step ST3 of the radar device according to the first embodiment, and in step ST3E, when the interference countermeasure determining unit 52H determines that the interference countermeasure is necessary, the process proceeds to step ST4, and the signal processing unit 5 outputs an interference countermeasure signal to the control unit 11 of the transmission signal outputting unit 1 and the process ends.

Further, when the interference countermeasure determining unit 52H determines in step ST3E that the interference countermeasure is unnecessary, the process proceeds to steps ST5 and ST6, and the distance to the observation target and the relative speed with respect to the observation target calculated by the distance and speed information calculating unit 532 are output to the display unit 6, and the process ends.

As described above, the radar device according to the ninth embodiment has an effect similar to that of the radar device according to the first embodiment, and can perform necessity determination of the interference countermeasure by using the average value FN of respective signal strengths of the plurality of distance information spectra and the minimum value and the total value of the average value FN of the plurality of signal strengths, and therefore, the radar device of the fast chirp FMCW scheme using the plurality of chirps can more easily determine the necessity of the interference countermeasure with high accuracy.

Note that the first index In1 used in the radar device according to the eighth embodiment and the second index In2 used in the radar device according to the ninth embodiment may be combined to determine the interference countermeasure.

That is, the interference countermeasure determining unit 52G in the radar device according to the eighth embodiment includes a first determining unit and a second determining unit.

The first determining unit compares the first index In1 with the fifth interference countermeasure threshold M5, and performs necessity determination of the interference countermeasure so as to determine that the interference countermeasure is “unnecessary” when the first index In1 is equal to or less than the fifth interference countermeasure threshold M5, and determine that the interference countermeasure is “necessary” when the first index In1 is larger than the fifth interference countermeasure threshold M5.

When the first determining unit determines that the interference countermeasure is “necessary”, the second determining unit compares the second index In2 with the sixth interference countermeasure threshold M6 and performs redetermination, and performs necessity determination of the interference countermeasure so as to determine that the interference countermeasure is “unnecessary” when the second index In2 is equal to or less than the sixth interference countermeasure threshold M6, and determine that the interference countermeasure is “necessary” when the second index In2 is larger than the sixth interference countermeasure threshold M6.

Further, the interference countermeasure determining unit 52H in the radar device according to the ninth embodiment includes a first determining unit and a second determining unit.

The first determining unit compares the second index In2 with the sixth interference countermeasure threshold M6, and performs necessity determination of the interference countermeasure so as to determine that the interference countermeasure is “unnecessary” when the second index In2 is equal to or less than the sixth interference countermeasure threshold M6, and determine that the interference countermeasure is “necessary” when the second index In2 is larger than the sixth interference countermeasure threshold M6.

When the first determining unit determines that the interference countermeasure is “necessary”, the second determining unit compares the first index In1 with the fifth interference countermeasure threshold M5 and makes a redetermination, and performs necessity determination of the interference countermeasure so as to determine that the interference countermeasure is “unnecessary” when the first index In1 is equal to or less than the fifth interference countermeasure threshold M5, and determine that the interference countermeasure is “necessary” when the first index In1 is larger than the fifth interference countermeasure threshold M5.

### Tenth Embodiment

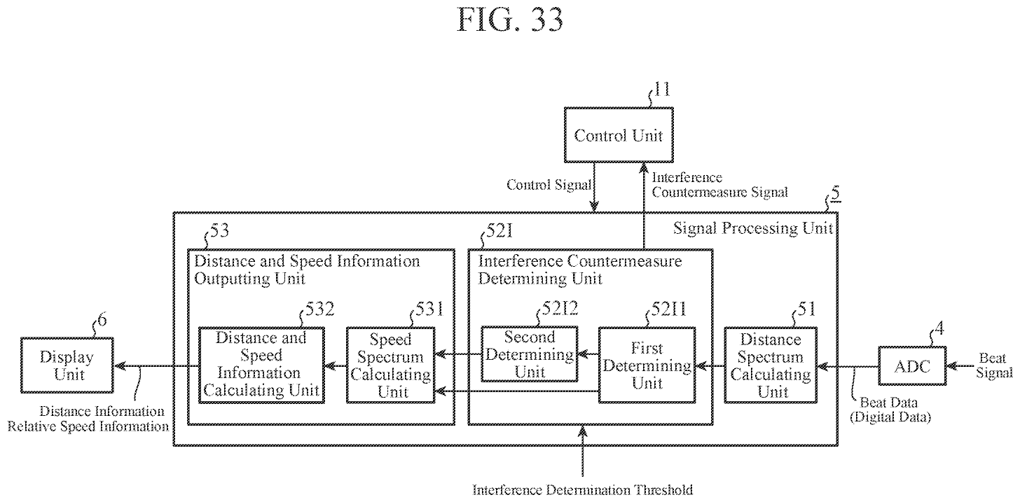

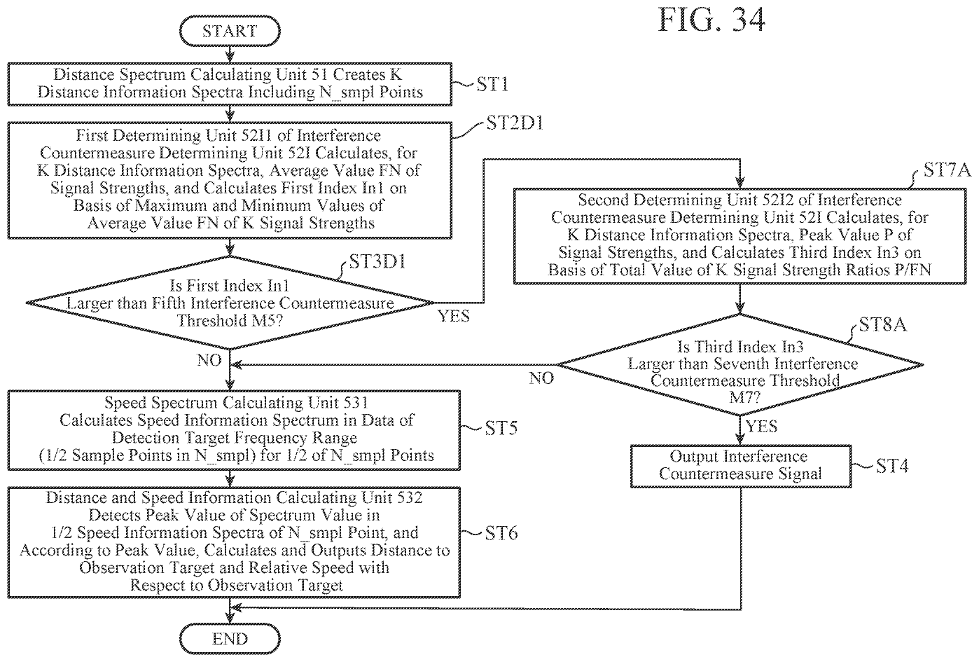

A fast chirp FMCW radar device according to a tenth embodiment will be described with reference to FIGS. 33 and 34.

In the radar device according to the tenth embodiment, only an interference countermeasure determining unit 52I of the signal processing unit 5 is different from the interference countermeasure determining unit 52G of the signal processing unit 5 in the radar device according to the eighth embodiment, and the other points are the same or similar.

In FIGS. 33 and 34, the same reference numerals as those attached in FIGS. 29 and 31 denote the same or corresponding parts.

In the radar device according to the eighth embodiment, the state value of the distance information spectrum obtained by the interference countermeasure determining unit 52G is set as the average value FN of the signal strengths of the data in the interference determination processing range in the distance information spectrum, the interference countermeasure determining unit 52G calculates the first index In1 on the basis of the maximum value and the minimum value of all chirps of the average value FN of the signal strengths, which are state values of each of the plurality of distance information spectra obtained by the interference countermeasure determining unit 52G, and determines necessity of the interference countermeasure by comparing the first index In1 with the fifth interference countermeasure threshold M5 that is the interference countermeasure threshold.

On the other hand, in the radar device according to the tenth embodiment, the state value of the distance information spectrum obtained by the interference countermeasure determining unit 52I is set as the average value FN of the signal strengths of the data in the interference determination processing range in the distance information spectrum and the signal strength ratio P/FN between the peak value P of the signal strength of the data in the detection target frequency range in the distance information spectrum and the average value FN of the signal strengths, the interference countermeasure determining unit 52I calculates the first index In1 on the basis of the maximum value and the minimum value of all chirps of the average value FN of the signal strengths, which are state values of each of the plurality of distance information spectra obtained by the interference countermeasure determining unit 52I, and performs first determination to determine whether or not the interference countermeasure is necessary by comparing the first index In1 with the fifth interference countermeasure threshold M5 that is the interference countermeasure threshold, and the interference countermeasure determining unit 52I calculates the third index In3 on the basis of the total chirp of the signal strength ratio P/FN of the peak value P of the signal strength, which are state values of each of the plurality of distance information spectra obtained by the interference countermeasure determining unit 52I, in this example, the sum of K (hereinafter referred to as a total value), and performs second determination to determine whether or not the interference countermeasure is necessary by comparing the third index In3 with the seventh interference countermeasure threshold M7 that is the interference countermeasure threshold.

The third index In3 is a total value of the signal strength ratio P/FN of the peak value P of the signal strength, which is the state value of each of the plurality of distance information spectra, that is, a total value P/FNtotal expressed by the following equation (5).

In3=P/FNtotal (5)

In the above equation (5), P/FNtotal is the total chirp of the calculated signal strength ratio P/FN, that is, the total value of K in this example.

Further, the seventh interference countermeasure threshold M7 is set to a value sufficiently more than the number of chirps, that is, K in this example.

That is, the interference countermeasure determining unit 52I of the signal processing unit 5 in the radar device according to the tenth embodiment includes the first determining unit 52I1 and the second determining unit 52I2.

The first determining unit 52I1 is a determining unit equivalent to the interference countermeasure determining unit 52G in the radar device according to the eighth embodiment.

The fifth interference countermeasure threshold M5 is the same value as the fifth interference countermeasure threshold M5 used in the radar device according to the eighth embodiment.

The first determining unit 52I1 acquires the data in the detection target frequency range of the plurality of distance information spectra output from the distance spectrum calculating unit 51.

The first determining unit 52I1 calculates the average value FN of respective signal strengths of the plurality of distance information spectra from the data in the interference determination processing range in the plurality of distance information spectra calculated by the distance spectrum calculating unit 51.

The first determining unit 52I1 calculates the first index In1 by the above equation (3) based on the maximum value and the minimum value of the average values FN of respective signal strengths of the plurality of distance information spectra calculated.

The first determining unit 52I1 compares the first index In1 with the fifth interference countermeasure threshold M5, and performs first necessity determination of the interference countermeasure so as to determine that the interference countermeasure is not necessary when the first index In1 is equal to or less than the fifth interference countermeasure threshold M5, and determine that the interference countermeasure is necessary when the first index In1 is larger than the fifth interference countermeasure threshold M5.

When determining that the interference countermeasure is necessary, that is, needed, the first determining unit 52I1 outputs the plurality of distance information spectra calculated by the distance spectrum calculating unit 51 and the average value FN of the calculated signal strengths to the second determining unit 52I2.

When the first determining unit 52I1 determines that the interference countermeasure is not necessary, that is, unnecessary, the first determining unit 52I1 outputs the plurality of distance information spectra calculated by the distance spectrum calculating unit 51 to the distance and speed information outputting unit 53.

When the first determining unit 52I1 determines that the interference countermeasure is necessary by the first necessity determination, the second determining unit 52I2 acquires the plurality of distance information spectra calculated by the distance spectrum calculating unit 51 and the average value FN of the signal strength calculated by the first determining unit 52I1 from the first determining unit 52I1.

The second determining unit 52I2 calculates the peak value P of the signal strength of the data in the detection target frequency range in each of the plurality of distance information spectra acquired from the first determining unit 52I1.

The second determining unit 52I2 calculates the third index In3 from the total value P/FNtotal of the signal strength ratios P/FN in the plurality of distance information spectra calculated by the distance spectrum calculating unit 51. In this example, the third index In3 is a total value P/FNtotal of the peak values P of the K signal strengths.

The second determining unit 52I2 compares the third index In3 with the seventh interference countermeasure threshold M7, and performs necessity determination of the interference countermeasure in which the interference countermeasure is kept necessary when the third index In3 is less than the seventh interference countermeasure threshold M7, and the interference countermeasure is changed from necessary to unnecessary when the third index In3 is equal to or more than the seventh interference countermeasure threshold M7.

The second determining unit 52I2 outputs an interference countermeasure signal for the transmission signal to the control unit 11 when it is determined that the interference countermeasure is necessary, that is, needed, and outputs a plurality of distance information spectra calculated by the distance spectrum calculating unit 51 to the distance and speed information outputting unit 53 when it is determined that the interference countermeasure is not necessary, that is, unnecessary.

As described above, since the interference countermeasure determining unit 52I includes the first determining unit 52I1 and the second determining unit 52I2, and the second determining unit 52I2 redetermines the necessity of the interference countermeasure with respect to the interference countermeasure determined to be necessary by the first determining unit 52I1, it is possible to avoid unnecessary interference countermeasure processing under the conditions where the SNR of the observation target is high and the observation target can be detected by Fourier transform in the relative speed direction by the distance and speed information outputting unit 53.

Hereinafter, the radar device according to the tenth embodiment will be described focusing on an interference countermeasure determining unit 52I different from the interference countermeasure determining unit 52G in the radar device according to the eighth embodiment.

Description of the same configuration as that of the radar device according to the eighth embodiment will be omitted as much as possible.

The first determining unit 52I1 acquires the data in the detection target frequency range of the plurality of distance information spectra output from the distance spectrum calculating unit 51.

As does the interference countermeasure determining unit 52G in the radar device according to the eighth embodiment, the first determining unit 52I1 calculates the average value FN of respective signal strengths of the plurality of distance information spectra from the data in the interference determination processing range in the plurality of distance information spectra calculated by the distance spectrum calculating unit 51, and calculates the first index In1 from the average value FN of the signal strength by using the above equation (3).

The first determining unit 52I1 compares the first index In1 with the fifth interference countermeasure threshold M5, and performs first necessity determination of the interference countermeasure so as to determine the interference countermeasure is “unnecessary” when the first index In1 is equal to or less than the fifth interference countermeasure threshold M5, and determine the interference countermeasure as “necessary” when the first index In1 is larger than the fifth interference countermeasure threshold M5.

The first determining unit 52I1 outputs the plurality of distance information spectra calculated by the distance spectrum calculating unit 51 and the average value FN of the calculated signal strengths to the second determining unit 52I2 when determining that the interference countermeasure is necessary, that is, needed, and outputs the plurality of distance information spectra calculated by the distance spectrum calculating unit 51 to the distance and speed information outputting unit 53 when determining that the interference countermeasure is not necessary, that is, unnecessary.

When the first determining unit 52I1 determines that the interference countermeasure is necessary by the first necessity determination, the second determining unit 52I2 acquires the plurality of distance information spectra calculated by the distance spectrum calculating unit 51 and the average value FN of the signal strength calculated by the first determining unit 52I1 from the first determining unit 52I1.

The second determining unit 52I2 calculates the peak value P of the signal strength of the data in the detection target frequency range in each of the plurality of distance information spectra acquired from the first determining unit 52I1.

The interference determination processing range is the same as the interference determination processing range in the radar device according to the first embodiment, and is the latter half that is a part of the detection target frequency range, which is a range from 3D to a region 4D indicated by solid hatching in FIG. 9 described in the second embodiment. The range from 3D to region 4D indicated by solid diagonal lines in FIG. 9 is the same as the range from 3D to region 4D indicated by solid diagonal lines in FIG. 4 described in the first exemplary embodiment.

Further, as an example, the peak value P of the signal strength is the same as the peak value indicated by the shaded parts in FIG. 9.

The second determining unit 52I2 calculates the signal strength ratio P/FN of the peak value P of the signal strength from the peak value P of the signal strength of the data in the detection target frequency range and the average value FN of the signal strength calculated by the first determining unit 52I1 in each of the plurality of distance information spectra acquired from the calculated first determining unit 52I1, and calculates the third index In3 from the signal strength ratio P/FN of the peak value P of the signal strength using the above equation (5).

The second determining unit 52I2 compares the third index In3 with the seventh interference countermeasure threshold M7, determines that the interference countermeasure is kept necessary when the third index In3 is less than the seventh interference countermeasure threshold M7, and performs redetermination as the second necessity determination of the interference countermeasure so as to determine to change the interference countermeasure from necessary to unnecessary when the third index In3 is equal to or more than the seventh interference countermeasure threshold M7.

In the third index In3, in a case where there is no interference due to a transmission wave from the other radar device, the minimum value P/FNmin of the signal strength ratio P/FN of the peak values P of the signal strengths by the K distance information spectra is larger than 1, and the total value P/FNtotal of the peak values P of the K signal strengths becomes also larger in (K×1), so that K is also larger.

Further, in a case where there is interference due to a transmission wave from the other radar device, the third index In3 is close to K since the minimum value P/FNmin of the signal strength ratio P/FN of the peak values P of the signal strengths by the K distance information spectra becomes a value close to 1 and the total value P/FNtotal of the peak values P of the K signal strengths becomes close to (K×1).

On the basis of the above points, the seventh interference countermeasure threshold M7 is set to a value sufficiently more than (1×the number of chirp signals K) with the upper limit of P/FNtotal in a case where there is no interference due to a transmission wave from the other radar device and the lower limit of P/FNtotal in a case where there is interference due to a transmission wave from the other radar device.

Therefore, when the third index In3 is less than the seventh interference countermeasure threshold M7, it can be determined that there is no interference due to the transmission wave from the other radar device, the second determining unit 52I2 can determine that the interference countermeasure is kept necessary, and when the third index In3 is equal to or more than the seventh interference countermeasure threshold M7, it can be determined that there is interference due to the transmission wave from the other radar device, and the second determining unit 52I2 performs the necessity determination of the interference countermeasure for changing the interference countermeasure from necessary to unnecessary.

The second determining unit 52I2 outputs an interference countermeasure signal for the transmission signal to the control unit 11 when it is determined that the interference countermeasure is necessary, that is, needed, and outputs a plurality of distance information spectra calculated by the distance spectrum calculating unit 51 to the distance and speed information outputting unit 53 when it is determined that the interference countermeasure is not necessary, that is, unnecessary.

Next, the operation of the radar device according to the tenth embodiment will be described.

The operation is the same as the operation of the radar device according to the eighth embodiment, that is, the operation of the radar device according to the first embodiment until beat data of K chirps is output from the AD converting unit 4 to the signal processing unit 5, and thus the description thereof will be omitted.

An operation of the signal processing unit 5 to which beat data of K chirps is input will be described with reference to a flowchart illustrated in FIG. 34.

FIG. 34 is a flowchart illustrating calculation processing of the distance to the observation target and the relative speed with respect to the observation target including interference determination in the signal processing unit 5.

Step ST1 of calculating the distance information spectrum is the same as step ST1 of the radar device according to the eighth embodiment, that is, step ST1 of the radar device according to the first embodiment.

Step ST2D1 is a step of calculating the first index In1, and is a step corresponding to step ST2D of the radar device according to the eighth embodiment.

In step ST2D1, the first determining unit 52I1 of the interference countermeasure determining unit 52I acquires data in the detection target frequency range of the K distance information spectra obtained in step ST1.

For each of the K distance information spectra, the first determining unit 52I1 calculates the average value FN of the signal strengths, which are one of the state values, from the data in the interference determination processing range among the data in the detection target frequency range, and obtains an average value FN of the signal strengths of the K distance information spectra.

The first determining unit 52I1 calculates the first index In1 from the above equation (3) using the maximum value FNmax and the minimum value FNmin of the average value FN of the signal strengths of the K distance information spectra.

Step ST3D1 is a step corresponding to step ST3D of the radar device according to the eighth embodiment.

In step ST3D1, the first determining unit 52I1 compares the first index In1 calculated in step ST2D1 with the fifth interference countermeasure threshold M5, and performs necessity determination of the interference countermeasure so as to determine that the interference countermeasure is “unnecessary” when the first index In1 is equal to or less than the fifth interference countermeasure threshold M5, and determine that the interference countermeasure is “necessary” when the first index In1 is larger than the fifth interference countermeasure threshold M5.

In step ST3D1, when the interference countermeasure determining unit 52G determines that an interference countermeasure is necessary, the process proceeds to step ST7A.

In step ST3D1, when the interference countermeasure determining unit 52G determines that no interference countermeasure is present, the process proceeds to steps ST5 and ST6, and similarly to the operations in steps ST5 and ST6 of the radar device according to the eighth embodiment, that is, steps ST5 and ST6 of the radar device according to the first embodiment, the distance to the observation target and the relative speed to the observation target calculated by the distance and speed information calculating unit 532 are output to the display unit 6, and the process ends.

Step ST7A is a step of calculating the third index In3.

In step ST7A, the second determining unit 52I2 of the interference countermeasure determining unit 52I acquires the K distance information spectra calculated by the distance spectrum calculating unit 51 and the average value FN of the signal strengths calculated by the first determining unit 52I1 from the first determining unit 52I1.

The second determining unit 52I2 calculates the peak value P of the signal strength of the data in the detection target frequency range in each of the K distance information spectra acquired from the first determining unit 52I1.

The second determining unit 52I2 calculates the signal strength ratio P/FN of the peak value P of the signal strength from the peak value P of the signal strength of the data in the detection target frequency range and the average value FN of the signal strength calculated by the first determining unit 52I1 in each of the K distance information spectra acquired from the calculated first determining unit 52I1, and calculates the third index In3 from the signal strength ratio P/FN of the peak value P of the signal strength using the above equation (5).

When the second determining unit 52I2 calculates the third index In3, the process proceeds to step ST8A.

Step ST8A is a step of performing redetermination which is the second necessity determination of the interference countermeasure.

In step ST8A, the second determining unit 52I2 compares the third index In3 calculated in step ST7A with the seventh interference countermeasure threshold M7, and if the third index In3 is less than the seventh interference countermeasure threshold M7, an interference countermeasure remains necessary, and if the third index In3 is equal to or more than the seventh interference countermeasure threshold M7, determines that the interference countermeasure is to be changed from “necessary” to “unnecessary”.

In step STA8, when the second determining unit 52I2 determines that the interference countermeasure is necessary, the process proceeds to step ST4, and the signal processing unit 5 outputs the interference countermeasure signal to the control unit 11 of the transmission signal outputting unit 1 and the process ends.

On the other hand, when the second determining unit 52I2 determines that there is no interference countermeasure, the process proceeds to steps ST5 and ST6, and the distance to the observation target and the relative speed with respect to the observation target calculated by the distance and speed information calculating unit 532 are output to the display unit 6, and the process ends.

As described above, the radar device according to the tenth embodiment has the same effects as those of the radar device according to the first embodiment and the radar device according to the eighth embodiment, and can avoid unnecessary interference countermeasure processing under the conditions where the SNR of the observation target is high and the observation target can be detected by Fourier transform in the relative speed direction.

Note that the first determining unit 52I1 of the interference countermeasure determining unit 52I in the radar device according to the tenth embodiment is a determining unit equivalent to the interference countermeasure determining unit 52G in the radar device according to the eighth embodiment, but the first determining unit 52I1 may be a determining unit equivalent to the interference countermeasure determining unit 52H in the radar device according to the ninth embodiment.

In this case, as does the interference countermeasure determining unit 52H in the radar device according to the ninth embodiment, the first determining unit 52I1 calculates the average value FN of respective signal strengths of the plurality of distance information spectra from the data in the interference determination processing range in the plurality of distance information spectra calculated by the distance spectrum calculating unit 51, and calculates the second index In2 by the above equation (4) on the basis of the minimum value and the total value of the calculated average values FN of the signal strengths of the plurality of distance information spectra.

The first determining unit 52I1 compares the second index In2 with the sixth interference countermeasure threshold M6, and performs the first necessity determination of the interference countermeasure, in which the interference countermeasure is determined as “unnecessary” when the second index In2 is equal to or less than the sixth interference countermeasure threshold M6, and the interference countermeasure is determined as “necessary” when the second index In2 is larger than the sixth interference countermeasure threshold M6.

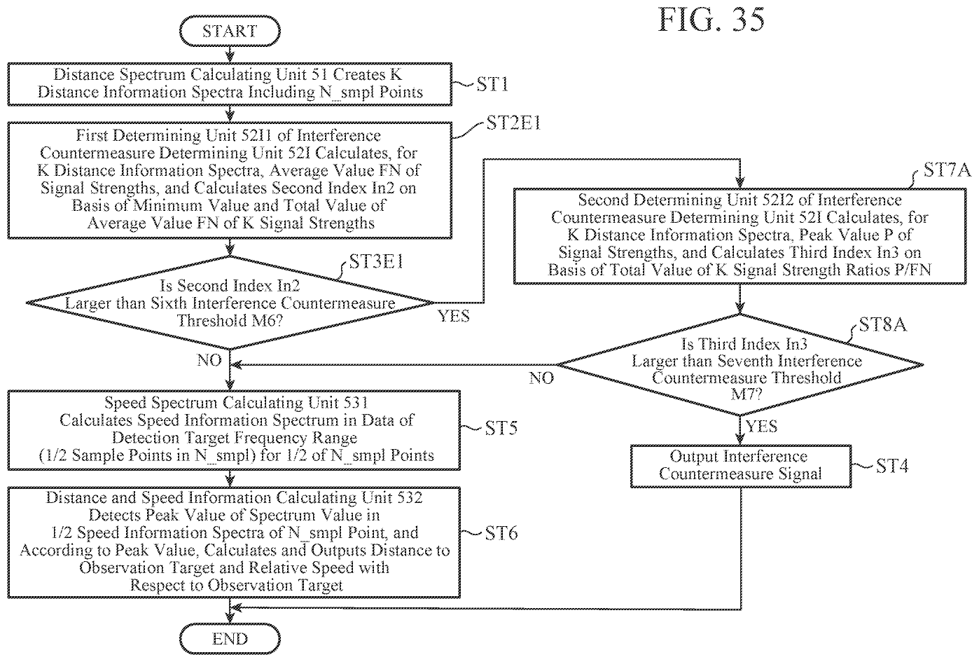

FIG. 35 is a flowchart illustrating calculation processing of the distance to the observation target and the relative speed with respect to the observation target including interference determination in the signal processing unit 5 in this example.

As illustrated in FIG. 35, steps ST2E1 and ST3E1 are different from steps ST2D1 and ST3D1 illustrated in FIG. 34, but the other points are the same.

In step ST2E1, the first determining unit 52I1 calculates the second index In2 using the minimum value FNmin and the total value FNtotal of the average values FN of the signal strengths of the K distance information spectra.

In step ST3E1, the first determining unit 52I1 compares the second index In2 with the sixth interference countermeasure threshold M6, and performs necessity determination of the interference countermeasure so as to determine that the interference countermeasure is “unnecessary” when the second index In2 is equal to or less than the sixth interference countermeasure threshold M6, and determine that the interference countermeasure is “necessary” when the second index In2 is larger than the sixth interference countermeasure threshold M6.

Further, the first determining unit 52I1 of the interference countermeasure determining unit 52I in the radar device according to the tenth embodiment may determine the interference countermeasure by combining the first index In1 used in the radar device according to the eighth embodiment and the second index In2 used in the radar device according to the ninth embodiment as another example in the ninth embodiment.

That is, the first determining unit 52I1 includes two determining units, and one determining unit (functioning as a first determining unit) of the first determining unit 52I1 compares the first index In1 with the fifth interference countermeasure threshold M5, and performs necessity determination of the interference countermeasure so as to determine that the interference countermeasure is “unnecessary” when the first index In1 is equal to or less than the fifth interference countermeasure threshold M5, and determine that the interference countermeasure is “necessary” when the first index In1 is larger than the fifth interference countermeasure threshold M5.

When one determining unit of the first determining unit 52I1 determines that the interference countermeasure is “necessary”, the other determining unit (functioning as a second determining unit) of the first determining unit 52I1 compares the second index In2 with the sixth interference countermeasure threshold M6 and makes a redetermination such that when the second index In2 is equal to or less than the sixth interference countermeasure threshold M6, the other determining unit of the first determining unit 52I1 determines that the interference countermeasure is “unnecessary” and causes the process to proceed to step ST5, and when the second index In2 is larger than the sixth interference countermeasure threshold M6, the other determining unit of the first determining unit 52I1 determines that the interference countermeasure is “necessary” and causes the process to proceed to step ST7A.

In this example, the second determining unit 52I2 functions as a third determining unit.

Alternatively, one determining unit (functioning as a first determining unit) of the first determining unit 52I1 compares the second index In2 with the sixth interference countermeasure threshold M6, and performs necessity determination of the interference countermeasure so as to determine that the interference countermeasure is “unnecessary” when the second index In2 is equal to or less than the sixth interference countermeasure threshold M6, and determine that the interference countermeasure is “necessary” when the second index In2 is larger than the sixth interference countermeasure threshold M6.

When one determining unit of the first determining unit 52I1 determines that the interference countermeasure is “necessary”, the other determining unit (functioning as the second determining unit) of the first determining unit 52I1 compares the first index In1 with the fifth interference countermeasure threshold M5 and makes a redetermination such that when the first index In1 is equal to or less than the fifth interference countermeasure threshold M5, the other determining unit of the first determining unit 52I1 determines that the interference countermeasure is “unnecessary” and causes the process to proceed to step ST5. When the first index In1 is larger than the fifth interference countermeasure threshold M5, the other determining unit of the first determining unit 52I1 determines that the interference countermeasure is “necessary” and causes the process to proceed to step ST7A.

In this example, the second determining unit 52I2 functions as a third determining unit.

Note that free combinations of the respective embodiments, modifications of any components of the respective embodiments, or omissions of any components in the respective embodiments are possible.

### INDUSTRIAL APPLICABILITY

A radar device according to the present disclosure is suitable for a vehicle radar device mounted on a vehicle such as an automobile.

### REFERENCE SIGNS LIST

1: transmission signal outputting unit, 11: control unit, 12: signal source, 2: transmitting and receiving unit, 21: distribution unit, 22: transmission antenna, 23: reception antenna, 3: beat signal generating unit, 31: frequency mixing unit, 32: filter unit, 4: AD converting unit, 5: signal processing unit, 51: distance spectrum calculating unit, 52, 52A to 52I: interference countermeasure determining unit, 53: distance and speed information outputting unit, 531: speed spectrum calculating unit, 532: distance and speed information calculating unit, 6: display unit

1. A radar device, comprising:
a beat signal generator to receive a reception signal that repeats a chirp signal corresponding to a chirp signal of a transmission signal due to a reception wave generated by reflecting, on an observation target, a transmission wave due to the transmission signal that repeats a chirp signal whose frequency changes with a lapse of time, and generate a beat signal having a frequency of a difference between respective frequencies of a chirp signal of the transmission signal and a chirp signal of the reception signal in a correspondence relationship;
an AD converter to output beat data obtained by converting the beat signal generated by the beat signal generator into digital data;
a distance spectrum calculator to calculate a plurality of distance information spectra corresponding to each of a plurality of pieces of beat data from the AD converter received during a signal acquisition period;
an interference countermeasure determiner to obtain a state value of each of the plurality of distance information spectra from data in an interference determination processing range in the plurality of distance information spectra calculated by the distance spectrum calculator, determine necessity of an interference countermeasure from a number of inappropriate distance information spectra in the plurality of distance information spectra by comparing the obtained state value of each of the distance information spectra with an interference determination threshold to obtain appropriateness of each of the plurality of distance information spectra and output an interference countermeasure signal for a chirp signal in a transmission signal when the interference countermeasure is necessary; and
a distance and speed information outputter to calculate and output a distance to the observation target and a relative speed with respect to the observation target from data in a detection target frequency range in the plurality of distance information spectra calculated by the distance spectrum calculator when the interference countermeasure determiner determines that the interference countermeasure is unnecessary.

2. The radar device according to claim 1, wherein the data in the interference determination processing range is a part of the data in the detection target frequency range corresponding to a range of a distance for detecting the observation target.

3. The radar device according to claim 2, wherein the data in the detection target frequency range is data in a frequency range up to a frequency of ½ of a sampling frequency in the AD converter.

4. The radar device according to claim 1, wherein
the state value of the distance information spectrum obtained by the interference countermeasure determiner is an average value of signal strengths of the data in the interference determination processing range in the distance information spectrum,
the interference determination threshold is a first determination threshold with respect to signal strength,
the comparison between the state value and the interference determination threshold in the interference countermeasure determiner is a comparison between the average value of the signal strengths and the first determination threshold, and
the determination of the necessity of the interference countermeasure in the interference countermeasure determiner is made from a number of the distance information spectra in which the average value of the signal strengths is equal to or more than the first determination threshold.

5. The radar device according to claim 4, wherein the first determination threshold is a value obtained by multiplying the average value of the signal strengths of the data in the interference determination processing range of a distance information spectrum obtained in a case where there are no reflected signal and no interference signal from the observation target by a coefficient.

6. The radar device according to claim 4, wherein the first determination threshold is a value obtained by multiplying a state value of one set distance information spectrum among the plurality of distance information spectra by a coefficient.

7. The radar device according to claim 4, wherein the first determination threshold is a value obtained by multiplying an average value of signal strengths of the data in the interference determination processing range of a distance information spectrum obtained in a case where there is no interference with a set observation target by a coefficient.

8. The radar device according to claim 1, wherein
the state value of the distance information spectrum obtained by the interference countermeasure determiner is a signal strength ratio between an average value of signal strengths of the data in the interference determination processing range in the distance information spectrum and a peak value of signal strength of the data in the detection target frequency range in the distance information spectrum with respect to the average value of the signal strength,
the interference determination threshold is a first determination threshold for signal strength and a second determination threshold for the signal strength ratio,
the comparison between the state value and the interference determination threshold in the interference countermeasure determiner is comparison between the average value of the signal strengths and the first determination threshold, and comparison between the signal strength ratio and the second determination threshold, and
the determination of the necessity of the interference countermeasure in the interference countermeasure determiner is made from a number of the distance information spectra in which the average value of the signal strengths is equal to or more than the first determination threshold and the signal strength ratio is equal to or less than the second determination threshold.

9. The radar device according to claim 8, wherein the first determination threshold is a value obtained by multiplying the average value of the signal strengths of the data in the interference determination processing range of a distance information spectrum obtained in a case where there are no reflected signal and no interference signal from the observation target by a coefficient.

10. The radar device according to claim 8, wherein the first determination threshold is a value obtained by multiplying a state value of one set distance information spectrum among the plurality of distance information spectra by a coefficient.

11. The radar device according to claim 8, wherein the first determination threshold is a value obtained by multiplying an average value of signal strengths of the data in the interference determination processing range of a distance information spectrum obtained in a case where there is no interference with a set observation target by a coefficient.

12. The radar device according to claim 1, wherein
the state value of the distance information spectrum obtained by the interference countermeasure determiner is a signal strength ratio of a peak value of signal strength of the data in the detection target frequency range in the distance information spectrum with respect to an average value of signal strengths of the data in the interference determination processing range in the distance information spectrum,
the interference determination threshold is a third determination threshold for the signal strength ratio,
the comparison between the state value and the interference determination threshold in the interference countermeasure determiner is comparison between the signal strength ratio and the third determination threshold, and
the determination of the necessity of the interference countermeasure in the interference countermeasure determiner is made from a number of the distance information spectra in which the signal strength ratio at a same distance is equal to or more than the third determination threshold.

13. The radar device according to claim 1, wherein
the state value of the distance information spectrum obtained by the interference countermeasure determiner is a signal strength ratio between an average value of signal strengths of the data in the interference determination processing range in the distance information spectrum and a peak value of signal strength of the data in the detection target frequency range in the distance information spectrum with respect to the average value of the signal strength,
the interference determination threshold is a first determination threshold for signal strength and a fourth determination threshold for the signal strength ratio,
the comparison between the state value and the interference determination threshold in the interference countermeasure determiner is comparison between the average value of the signal strengths and the first determination threshold, and comparison between the signal strength ratio and the fourth determination threshold, and
the determination of the necessity of the interference countermeasure in the interference countermeasure determiner includes first determination based on a number of the distance information spectra in which the average value of the signal strength is equal to or more than the first determination threshold, and second determination based on a number of the distance information spectra in which the signal strength ratio is equal to or more than the fourth determination threshold when it is determined by the first determination that the interference countermeasure is necessary.

14. The radar device according to claim 1, wherein
the state value of the distance information spectrum obtained by the interference countermeasure determiner is a signal strength ratio between an average value of signal strengths of the data in the interference determination processing range in the distance information spectrum and a peak value of signal strength of the data in the detection target frequency range in the distance information spectrum with respect to the average value of the signal strength,
the interference determination thresholds are a first determination threshold for signal strength, and a second determination threshold and a fourth determination threshold for signal strength ratio,
the comparison between the state value and the interference determination threshold in the interference countermeasure determiner is comparison between the average value of the signal strengths and the first determination threshold, comparison between the signal strength ratio and the second determination threshold, and comparison between the signal strength ratio and the fourth determination threshold, and
the determination of the necessity of the interference countermeasure in the interference countermeasure determiner includes first determination based on a number of the distance information spectra in which the average value of the signal strengths is equal to or more than the first determination threshold and the signal strength ratio is equal to or less than the second determination threshold, and second determination based on a number of the distance information spectra in which the signal strength ratio is equal to or more than the fourth determination threshold when it is determined by the first determination that the interference countermeasure is necessary.

15. The radar device according to claim 1, wherein
the state value of the distance information spectrum obtained by the interference countermeasure determiner is a signal strength ratio between a peak value of signal strength of the data in the detection target frequency range in the distance information spectrum with respect to an average value of signal strengths of the data in the interference determination processing range in the distance information spectrum,
the interference determination threshold is a third determination threshold and a fourth determination threshold for the signal strength ratio,
the comparison between the state value and the interference determination threshold in the interference countermeasure determiner is comparison between the signal strength ratio and the third determination threshold and comparison between the signal strength ratio and the fourth determination threshold, and
the determination of the necessity of the interference countermeasure in the interference countermeasure determiner includes first determination based on a number of the distance information spectra in which the signal strength ratio at a same distance is equal to or more than the third determination threshold, and second determination based on a number of the distance information spectra in which the signal strength ratio is equal to or more than the fourth determination threshold when it is determined by the first determination that the interference countermeasure is necessary.

16. The radar device according to claim 1, wherein
each of the state values of the distance information spectra obtained by the interference countermeasure determiner is a plurality of signal strength ratios between a plurality of peak values of signal strengths of the data in the detection target frequency range in the distance information spectrum with respect to an average value of signal strengths of the data in the interference determination processing range in the distance information spectrum,
the interference determination threshold is a fifth determination threshold for the signal strength ratio,
the comparison between the state value and the interference determination threshold in the interference countermeasure determiner is comparison between each of the plurality of signal strength ratios and the fifth determination threshold, and
the determination of the necessity of the interference countermeasure in the interference countermeasure determiner is made from a number of the distance information spectra in which the plurality of signal strength ratios at a same distance is equal to or more than the fifth determination threshold.

17. A radar device, comprising:
a beat signal generator to receive a reception signal that repeats a chirp signal corresponding to a chirp signal of a transmission signal due to a reception wave generated by reflecting, on an observation target, a transmission wave due to the transmission signal that repeats a chirp signal whose frequency changes with a lapse of time, and generate a beat signal having a frequency of a difference between respective frequencies of a chirp signal of the transmission signal and a chirp signal of the reception signal in a correspondence relationship;
an AD converter to output beat data obtained by converting the beat signal generated by the beat signal generator into digital data;
a distance spectrum calculator to calculate a plurality of distance information spectra corresponding to each of a plurality of pieces of beat data from the AD converter received during a signal acquisition period;
an interference countermeasure determiner to obtain a state value of each of the plurality of distance information spectra, which is a signal strength ratio between an average value of signal strengths of the data in the interference determination processing range in the distance information spectrum and a peak value of signal strength of the data in the detection target frequency range in the distance information spectrum with respect to the average value of the signal strength from data in an interference determination processing range in the plurality of distance information spectra calculated by the distance spectrum calculator, determine necessity of an interference countermeasure using a first determiner to compare a sixth interference countermeasure threshold with a second index that is a value obtained by dividing a sum of all average values of signal strengths, which are state values of each of the plurality of distance information spectra, by a value obtained by multiplying a minimum value in an average value of signal strengths by a number of the plurality of distance information spectra, determine that the interference countermeasure is unnecessary when the second index is equal to or less than the sixth interference countermeasure threshold, and determine that the interference countermeasure is necessary when the second index is larger than the sixth interference countermeasure threshold, a second determiner to, when it is determined by the first determiner that the interference countermeasure is necessary, compare a fifth interference countermeasure threshold with a first index that is a value obtained by dividing a difference between a maximum value and a minimum value in an average value of signal strengths, which are state values of each of the plurality of distance information spectra, by a sum of the maximum value and the minimum value, change the interference countermeasure from necessary to unnecessary when the first index is equal to or less than the fifth interference countermeasure threshold, and keep the interference countermeasure necessary when the first index is larger than the fifth interference countermeasure threshold, and a third determiner to, when it is determined by the second determiner that the interference countermeasure is kept necessary, compare a seventh interference countermeasure threshold with a third index that is a sum of all signal strength ratios of peak values of signal strengths, which are state values of each of the plurality of distance information spectra, change the interference countermeasure from necessary to unnecessary when the third index is equal to or more than the seventh interference countermeasure threshold, and keep the interference countermeasure necessary when the third index is less than the seventh interference countermeasure threshold, and output an interference countermeasure signal for a chirp signal in a transmission signal when the interference countermeasure is necessary; and
a distance and speed information outputter to calculate and output a distance to the observation target and a relative speed with respect to the observation target from data in a detection target frequency range in the plurality of distance information spectra calculated by the distance spectrum calculator when the first determiner through the third determiner in the interference countermeasure determiner determine that the interference countermeasure is unnecessary.

18. The radar device according to claim 17, wherein the data in the interference determination processing range is a part of the data in the detection target frequency range corresponding to a range of a distance for detecting the observation target.

19. The radar device according to claim 18, wherein the data in the detection target frequency range is data in a frequency range up to a frequency of ½ of a sampling frequency in the AD converter.

20. An interference countermeasure detection method of a radar device, the method comprising:
receiving a plurality of chirp signals received during a signal acquisition period in a transmission signal that repeats a chirp signal whose frequency changes with a lapse of time and a plurality of chirp signals received during the signal acquisition period in a reception signal due to a reception wave generated by reflecting, on an observation target, a transmission wave due to the transmission signal, and calculating a plurality of distance information spectra corresponding to beat data obtained by converting a beat signal having a frequency that is a difference between frequencies of a chirp signal of the transmission signal and a chirp signal of the reception signal in a correspondence relationship into digital data; and
obtaining a state value of each of the plurality of distance information spectra from data in an interference determination processing range in the plurality of distance information spectra, obtaining appropriateness in each of the plurality of distance information spectra by comparing the obtained state value with an interference determination threshold, determining necessity of an interference countermeasure from the number of inappropriate distance information spectra in the plurality of distance information spectra, and outputting an interference countermeasure signal for a chirp signal in a transmission signal when the interference countermeasure is necessary.
